(19) United States
(12) Patent Application Publication
(10) Pub. No.: US 2025/0291942 A1
(43) Pub. Date: Sep. 18, 2025

(54) METHODS AND SYSTEMS FOR RESOURCE CONTROL USING MACHINE LEARNING ANALYSIS OF RESOURCE OUTPUT

(71) Applicant: Gerald T. McLaughlin, III, Sunnyvale, CA (US)

(72) Inventor: Gerald T. McLaughlin, III, Sunnyvale, CA (US)

(21) Appl. No.: 18/822,058

(22) Filed: Aug. 30, 2024

Related U.S. Application Data
(60) Provisional application No. 63/566,207, filed on Mar. 15, 2024.

(51) Int. Cl. G06F 21/62; G06N 20/00

(52) U.S. Cl. CPC G06F 21/62; G06N 20/00

(57) ABSTRACT

Methods and systems for machine learning analysis of resource output are disclosed that include acquiring a resource output (where the resource output is an output produced by a computing resource), generating a representation of the resource output (where the representation is generated by the machine learning system, and the machine learning system generates the representation based, at least in part, on the resource output), and, in response to an analysis of the representation against a representational statement, performing an operation (where the representational statement is in a representational language).

### BACKGROUND

### Technical Field

This invention relates generally to computer security and, more particularly, to methods and systems for machine learning analysis of resource output.

### Description of Related Technologies

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Such information handling systems have readily found use in a wide variety of applications. However, such computer systems remain vulnerable to security threats and misuse by users. Further, analyzing computer use is also problematic. Addressing these and other challenges left unmet in today's computer systems is thus desirable.

### BRIEF DESCRIPTION OF THE DRAWINGS

A more complete understanding of the present disclosure may be had by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating an example of a network architecture, according to methods and systems such as those disclosed herein.

FIG. 2 is a block diagram illustrating an example of a security management architecture, according to methods and systems such as those disclosed herein.

FIG. 3 is a block diagram illustrating an example of a generic database server architecture, according to methods and systems such as those disclosed herein.

FIG. 4 is a block diagram illustrating an example of a security management server architecture, according to methods and systems such as those disclosed herein.

FIG. 5 is a block diagram illustrating an example of a cloud database server architecture, according to methods and systems such as those disclosed herein.

FIG. 6 is a block diagram illustrating an example of a distributed database architecture, according to methods and systems such as those disclosed herein.

FIG. 7 is a block diagram illustrating an example of a security management information server architecture, according to methods and systems such as those disclosed herein.

FIG. 8A is a block diagram illustrating an example of a cloud-based analysis architecture, according to methods and systems such as those disclosed herein.

FIG. 8B is a block diagram illustrating an example of another cloud-based analysis architecture, according to methods and systems such as those disclosed herein.

FIG. 9 is a block diagram illustrating an example of an endpoint agent architecture, according to methods and systems such as those disclosed herein.

FIG. 10 is a block diagram illustrating an example of another endpoint agent architecture, according to methods and systems such as those disclosed herein.

FIG. 11A is a block diagram illustrating an example of a cloud-based analysis architecture, according to methods and systems such as those disclosed herein.

FIG. 11B is a block diagram illustrating another example of another cloud-based analysis architecture, according to methods and systems such as those disclosed herein.

FIG. 12 is a block diagram illustrating an example of a policy creation and view flow, according to methods and systems such as those disclosed herein.

FIG. 13 is a block diagram illustrating an example of a policy creation flow, according to methods and systems such as those disclosed herein.

FIG. 14 is a block diagram illustrating an example of a portion of a policy creation engine architecture, according to methods and systems such as those disclosed herein.

FIG. 15 is a block diagram illustrating an example of another portion of a policy creation engine architecture, according to methods and systems such as those disclosed herein.

FIG. 16 is a block diagram illustrating an example of yet another portion of a policy creation engine architecture, according to methods and systems such as those disclosed herein.

FIG. 17A is a block diagram illustrating an example of a policy check unit, according to methods and systems such as those disclosed herein.

FIG. 17B is a block diagram illustrating an example of a policy action recommendation engine, according to methods and systems such as those disclosed herein.

FIG. 17C is a block diagram illustrating an example of external information sources, according to methods and systems such as those disclosed herein.

FIG. 18 is a block diagram illustrating an example of a policy generation flow, according to methods and systems such as those disclosed herein.

FIG. 19 is a block diagram illustrating an example of a policy creation engine, according to methods and systems such as those disclosed herein.

FIG. 20 is a block diagram illustrating an example of resource output analysis flow, according to methods and systems such as those disclosed herein.

FIG. 21 is a block diagram illustrating an example of a policy management flow, according to methods and systems such as those disclosed herein.

FIG. 22 is a block diagram illustrating an example of an analysis flow, according to methods and systems such as those disclosed herein.

FIG. 23A is a block diagram illustrating an example of a portion of an image interpretation flow, according to methods and systems such as those disclosed herein.

FIG. 23B is a block diagram illustrating an example of another portion of the image interpretation flow, according to methods and systems such as those disclosed herein.

FIG. 24 is a block diagram illustrating an example of a policy check module flow, according to methods and systems such as those disclosed herein.

FIG. 25A is a block diagram illustrating an example of a group/user/attribute decision flow, according to methods and systems such as those disclosed herein.

FIG. 25B is a block diagram illustrating an example of an allowed resource flow, according to methods and systems such as those disclosed herein.

FIG. 25C is a block diagram illustrating an example of a denied resource flow, according to methods and systems such as those disclosed herein.

FIG. 26 is a block diagram illustrating an example of a policy name decision flow, according to methods and systems such as those disclosed herein.

FIG. 27 is a block diagram illustrating an example of a policy enforcement action flow, according to methods and systems such as those disclosed herein.

FIG. 28 is a diagram illustrating an example of output screen examples, according to methods and systems such as those disclosed herein.

FIG. 29 is a diagram illustrating an example of an alternative policy check flow, according to methods and systems such as those disclosed herein.

FIG. 30 is a diagram illustrating an example of an enforcement recommendation service flow, according to methods and systems such as those disclosed herein.

FIG. 31 is a simplified flow diagram illustrating an example of a portion of a policy generation process, according to methods and systems such as those disclosed herein.

FIG. 32 is a simplified flow diagram illustrating an example of a relevant user/group processing process, according to methods and systems such as those disclosed herein.

FIG. 33 is a simplified flow diagram illustrating an example of a relevant allowed application example processing process, according to methods and systems such as those disclosed herein.

FIG. 34 is a simplified flow diagram illustrating an example of an image evaluation criteria process, according to methods and systems such as those disclosed herein.

FIG. 35 is a simplified flow diagram illustrating an example of an allowed application process, according to methods and systems such as those disclosed herein.

FIG. 36 is a simplified flow diagram illustrating an example of a relevant denied application example processing process, according to methods and systems such as those disclosed herein.

FIG. 37 is a simplified flow diagram illustrating an example of another portion of the policy generation process begun in FIG. 31, according to methods and systems such as those disclosed herein.

FIG. 38 is a simplified flow diagram illustrating an example of yet another portion of the policy generation process begun in FIG. 31, according to methods and systems such as those disclosed herein.

FIG. 39 is a simplified flow diagram illustrating an example of an application output analysis process, according to methods and systems such as those disclosed herein.

FIG. 40 is a simplified flow diagram illustrating an example of an application output acquisition process, according to methods and systems such as those disclosed herein.

FIG. 41 is a simplified flow diagram illustrating an example of an application output representational statement generation process, according to methods and systems such as those disclosed herein.

FIG. 42 is a simplified flow diagram illustrating an example of a preprocessing process, according to methods and systems such as those disclosed herein.

FIG. 43 is a simplified flow diagram illustrating an example of a representational statement analysis process, according to methods and systems such as those disclosed herein.

FIG. 44 is a simplified flow diagram illustrating an example of an action recommendation process, according to methods and systems such as those disclosed herein.

FIG. 45 is a simplified flow diagram illustrating an example of an operation performance process, according to methods and systems such as those disclosed herein.

FIG. 46 is a simplified block diagram illustrating an example of a model generation training architecture, according to methods and systems such as those disclosed herein.

FIG. 47 is a simplified diagram illustrating an example of a factor ranking system, according to methods and systems such as those disclosed herein.

FIG. 48 is a simplified diagram illustrating an example of a higher-order ranking system, according to methods and systems such as those disclosed herein.

FIG. 49 is a simplified block diagram illustrating an example of a security modeling architecture, according to methods and systems such as those disclosed herein.

FIG. 50A is a simplified block diagram illustrating an example of a multi-level neural network architecture, according to methods and systems such as those disclosed herein.

FIG. 50B is a simplified block diagram illustrating an example of another multi-level neural network architecture, according to methods and systems such as those disclosed herein.

FIG. 51 is a simplified block diagram illustrating an example of a security factor prediction training architecture, according to methods and systems such as those disclosed herein.

FIG. 52 is a simplified block diagram illustrating an example of a security factor prediction architecture, according to methods and systems such as those disclosed herein.

FIG. 53 illustrates an example configuration of a computing device that can be used to implement methods and systems such as those disclosed herein.

FIG. 54 illustrates an example configuration of a network architecture in which methods and systems such as those disclosed herein can be implemented.

While embodiments such as those presented in the application are susceptible to various modifications and alternative forms, specific embodiments are provided as examples in the drawings and description of example embodiments. It should be understood that the drawings and description of example embodiments are not intended to limit the embodiments to the particular form disclosed. Instead, the intention is to cover modifications, equivalents and alternatives falling within the spirit and scope of methods and systems such as those described herein, as defined by the appended claims.

### DETAILED DESCRIPTION

### Overview

Methods and systems such as those described herein can be implemented, for example, as a method, a computing system, and/or computer program product, and provide for the dynamic management of logistics in the collection/distribution of items, materials, and/or other distributables/collectables (e.g., energy (e.g., fuel, stored electricity, compressed air, and the like)), through the use of various techniques. Such techniques can include or make use of machine learning (ML) techniques. For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display (whether, e.g., a monitor or virtual reality headset, for example). The information handling system may also include one or more buses operable to transmit communications between the various hardware components.

### INTRODUCTION

As noted, methods and systems such as those described herein provide for the analysis of resource output using machine learning techniques, in order to control resources (whether that be controlling the resources (e.g., applications) themselves, their use, access thereto, or other mechanisms of control or the control over access/use thereof). In so doing, such analysis systems are able to reduce (or even eliminate) security threats and misuse by users, by analyzing resource output to identify and act/recommend actions to address such threats and misuse. Such methods and systems are able to do so in a fast, efficient manner, such that actions are taken without undue delay or burden on the endpoint or other computing systems. Moreover, through such methods' and systems' use of machine learning, the generation and application of policies is greatly simplified, meaning the impact on personnel such as administrators, with regard to the need for administrator training in the configuration and use of such analysis systems, their maintenance (e.g., to accommodate changes in policies, the implementation of new policies, and so on), and other such impacts is meaningfully reduced.

For example, such methods and systems can be used to implement a cybersecurity platform designed to address the challenges faced by information technology (IT) teams, IT security teams, and other such groups in monitoring and securing the digital environments for which they are responsible. By focusing on the output produced by a given resource (e.g., software applications (client- and/or server-side), hardware platforms, operating systems, and so on), a more efficient, flexible, and comprehensive solution to detect malicious actions and unauthorized activities is provided.

By way of further example, where a resource is a software application, the resource's output (referred to herein as resource output, and in such scenarios as that posited, application output) can be the output of the application displayed on the given computer system's display. The observation of such on-screen activity received or retrieved by the analysis system (whether as-displayed, in video memory, in the computer system's main memory, or elsewhere) is analyzed by the analysis system to detect such malicious actions and unauthorized activities. One example in which such advantages have bearing is the management and analysis of log information generated by the ever-increasing number of applications in use, making it difficult to spot malicious activities. The diversity of tools, each with its own application programming interface (API) and data formats, complicates the process. Moreover, the task of aggregating this data into a data lake for analysis requires extensive configuration, often leading to missed critical details and overwhelming the staff responsible for such activities. In response to these challenges, methods and systems such as those described herein simplify and enhance the monitoring and analysis of resources and their use by way of obtaining and analyzing resource output. Advantageously, such methods and systems are able to provide such functionality without the need for access to or analysis of traditional logs, interaction with APIs, access via special device permissions, kernel access, or the like, offering a more flexible and easily-deployable solution to detect malicious actions, not only simplifying the process of detecting malicious activities, but also providing a more immediate and comprehensive view of potential security threats.

### Example System Network Architecture

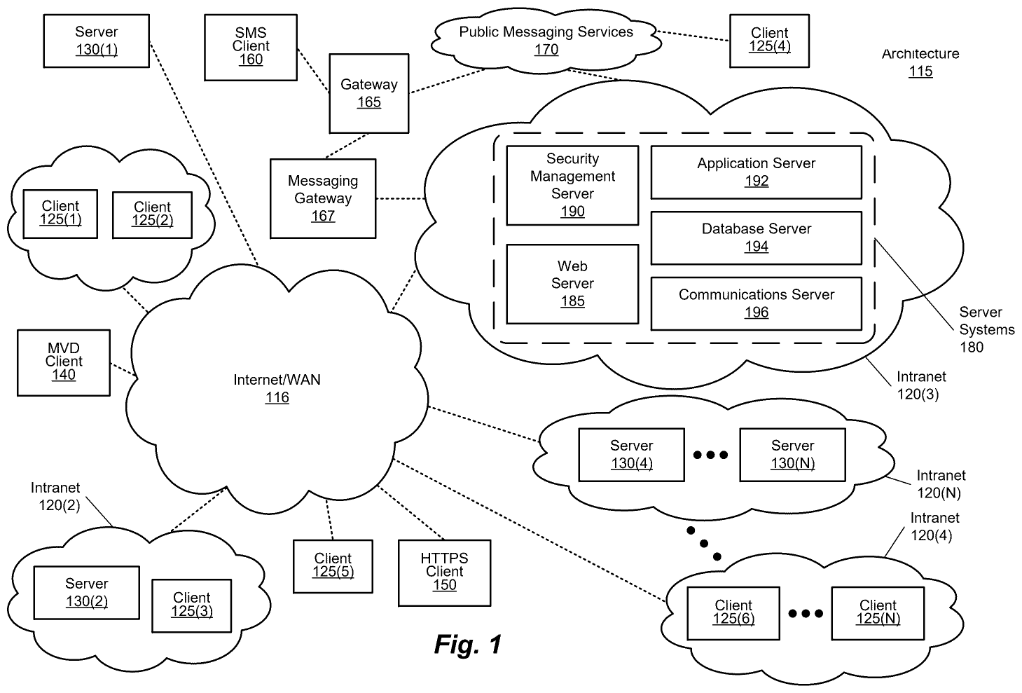

FIG. 1 is a block diagram illustrating an example of a network architecture that includes a server system, according to methods and systems such as those disclosed herein. FIG. 1 thus depicts a network architecture 115, which includes an internetwork (depicted in FIG. 1 as an internet/wide area network (WAN) 116), which is configured to couple a number of intranets to one another (depicted in FIG. 1 as intranets 120(1)-(N)). Intranets 120(1)-(N), in turn, can include a number of components, such as one or more clients (depicted in FIG. 1 as clients 125(1)-(N)) and/or servers (depicted in FIG. 1 as servers 130(1)-(N)). Clients 125(1)-(N) and/or servers 130(1)-(N) can, for example, be implemented using computer systems such as those described in subsequently. Internet/WAN 116 thus communicatively couples intranets 120(1)-(N) to one another, thereby allowing clients 125(1)-(N) and servers 130(1)-(N) to communicate with one another (and can, in certain embodiments, provide for the servers of intranets 120(3) and 120(N), for example, to operate as cloud-based server systems). As is depicted in FIG. 1, clients 125(1)-(N) can be communicatively coupled to one another and to servers 130(1)-(N) as part of one of intranets 120(1)-(N), or directly via internet/WAN 116. Similarly, servers 130(1)-(N) can be coupled via intranet/WAN 116 via a direct connection to intranet/WAN 116, or as part of one of intranets 120(1)-(N).

Network architecture 115 also provides for communication via intranet/WAN 116 using one or more other devices. Such devices can include, for example, a mobile voice and data (MVD) device (e.g., depicted in FIG. 1 as a MVD client 140, implemented in a “smart phone,” a “tablet” computer, or other such mobile computing device, using, in the alternative or in combination, general packet radio service (GPRS) technology, 3^{rd} Generation (3G) cellular technology (e.g., Wideband Code Division Multiple Access (WCDMA)/High-Speed Downlink Packet Access (HSDPA)), 4^{th} Generation (4G) cellular technology (e.g., High Speed Packet Access (HSPA/HSPA+), Long Term Evolution (LTE), or IEEE 802.16 (“WiMAX”)), 5^{th} Generation (5G) cellular technology (New Radio (NR), Stand Alone, or ultra-wideband (UWB)), and/or 6^{th} Generation (6G) cellular technology, among other such communications technologies), a secure web client (depicted in FIG. 1 as a secure hypertext transfer protocol client 150), and a basic cellular phone (e.g., using standard texting or other communication protocols, and depicted in FIG. 1 as a simple messaging service (SMS) client 160). HTTPS client 150 can be, for example, a laptop computer using the HTTP Secure (HTTPS) protocol (or other such protocol). Support for GPRS clients, SMS clients, HTTP clients, and the like thereby provide users with communication functionality according to an embodiment in a mobile environment. As is also depicted in FIG. 1, SMS client 160 can communicate via internet/WAN 116 via several channels. SMS client 160 can communicate directly, for example, with a gateway 165, which, in turn, communicates with internet/WAN 116 via a messaging gateway 167 and, optionally, elements within intranet 120(3), for example. Alternatively, SMS client 160 can, via gateway 165, communicate with intranet 120(3) (and so, internet/WAN 116) via public messaging services 170 to which gateway 165 and intranet 120(3) are connected. As is also depicted in FIG. 1, a client 125(4) is also able to communicate via internet/WAN 116 by way of public messaging services 170 and intranet 120(3). In order to support such communications, as well as other communications according to various embodiments, intranet 120(3) includes server systems 180, as well as (optionally) providing for a number of clients (not shown), in the manner of intranet 120(2). As will be appreciated in light of the present disclosure, such communications pathways can include (and are intended to comprehend) wired network connections (e.g., within an intranet such as one of intranets 120, or therebetween) and/or wireless network paths that include wireless communications (e.g., by way of wireless devices supporting IEEE 802.11 technology (“Wi-Fi”)). Further, with respect to the use of a combination of hardware and software in managing such communications, the associated computational workloads can be orchestrated such that those computational workloads are serviced at a point in the network that is physically and/or logically closer to the given user's device (or, in scenarios in which computational workloads can be divided, to points as close to that user's device as such orchestration of the given portion of the conversational workload will allow).

Server systems 180 include a number of components that allow its servers to provide various functionalities (e.g., supporting various communications, web-based services, cloud-based services, enterprise services, and so on). Among these components, in certain embodiments, are a number of servers, which can be implemented in hardware and/or software. Server systems 180 includes a number of elements that allow server system 180 to support messaging communications according to embodiments of the present invention. Among these elements are one or more web servers (e.g., a web server 185), one or more security management servers (e.g., a security management server 190), one or more application servers (e.g., an application server 192), one or more database servers (e.g., a database server 194), and one or more communications servers (e.g., a communications server 196), among other possible such servers, in communication with one another.

Servers such as those included in server systems 180 are designed to include hardware and/or software configured to facilitate functionalities that support operations according to the concepts disclosed herein, among other possible such components and mechanisms, in communication with one another (e.g., directly, via various application programming interfaces (APIs) and/or other such interfaces, and/or other such mechanisms and/or constructs). As will be discussed in greater detail in connection with subsequent figures, the server systems of server systems 180 provide such functionality, for example by presenting end-users with a website (functionality effected by, for example, web server 185). In so doing, such web servers present information collected, generated, organized, and maintained in one or more distributed databases (DDB) and/or one or more unstructured databases, by one or more DDB servers such as database server 194, under the control of one or more application servers. Such a website can be accessed by an end-user using a client computing device such as one or more of clients 125(1)-(N), MVD client 140, HTTPS client 150, and/or SMS client 160. As will be appreciated in light of the present disclosure, the ability to support such functionality on mobile devices such as those described herein is of importance, as mobile communications and program management are fast becoming an important facet of today's business environment.

It will be appreciated that, in light of the present disclosure, variable identifiers such as “N” or “M” may be used in various instances in various of the figures herein to designate the final element of a series more simply. The repeated use of such variable identifiers is not meant to necessarily imply any sort of correlation between the number of elements in such series. The use of variable identifiers of this sort in no way is intended to (and does not) require that each series of elements have the same number of elements as another series delimited by the same variable identifier. Rather, in each instance of use, variables thus identified may represent the same or a different value than other instances of the same variable identifier.

Further, in light of the present disclosure, it will be appreciated that storage devices such as storage devices supporting server systems 180 can be implemented by any type of computer-readable storage medium, including, but not limited to, internal or external hard disk drives (HDD), optical drives (e.g., CD-R, CD-RW, DVD-R, DVD-RW, and the like), flash memory drives (e.g., USB memory sticks and the like), tape drives, removable storage in a robot or standalone drive, and the like. Alternatively, it will also be appreciated that, in light of the present disclosure, such systems can include other components such as routers, firewalls, load balancers, and the like that are not germane to the discussion of the present disclosure and will not be discussed further herein. It will also be appreciated that other configurations are possible.

As will be appreciated in light of the present disclosure, processes according to concepts embodied by systems such as those described herein include one or more operations, which may be performed in any appropriate order. It is appreciated that operations discussed herein may consist of directly entered commands by a computer system user or by steps executed by application specific hardware modules, but the preferred embodiment includes steps executed by software modules. The functionality of steps referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable storage media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with this disclosure.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagram may be executed by a module (e.g., a software module) or a portion of a module or a computer system user using, for example, a computer system. Thus, the above-described method, the operations thereof and modules therefor may be executed on a computer system configured to execute the operations of the method and/or may be executed from computer-readable storage media. The method may be embodied in a machine-readable and/or computer-readable storage medium for configuring a computer system to execute the method. Thus, the software modules may be stored within and/or transmitted to a computer system memory to configure the computer system to perform the functions of the module, for example.

Such a computer system normally processes information according to a program (a list of internally stored instructions such as a particular application program and/or an operating system) and produces resultant output information via I/O devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Such a computer system typically includes multiple computer processes executing “concurrently.” Often, a computer system includes a single processing unit which is capable of supporting many active processes alternately. Although multiple processes may appear to be executing concurrently, at any given point in time only one process is actually executed by the single processing unit. By rapidly changing the process executing, a computer system gives the appearance of concurrent process execution. The ability of a computer system to multiplex the computer system's resources among multiple processes in various stages of execution is called multitasking. Systems with multiple processing units, which by definition can support true concurrent processing, are called multiprocessing systems. Active processes are often referred to as executing concurrently when such processes are executed in a multitasking and/or a multiprocessing environment. With regard to the servers described in connection with FIG. 1 and the potential of distributed processing, there exists the potential for employing distributed, multiple servers to achieve computational concurrency.

The software modules described herein may be received by such a computer system, for example, from computer readable storage media. The computer readable storage media may be permanently, removably, or remotely coupled to the computer system. The computer readable storage media may non-exclusively include, for example, any number of the following:
magnetic storage media including disk and tape storage media, optical storage media such as compact disk media (e.g., CD-ROM, CD-R, etc.) and digital video disk storage media, nonvolatile memory storage memory including semiconductor-based memory units such as FLASH memory, EEPROM, EPROM, ROM or application specific integrated circuits; volatile storage media including registers, buffers or caches, main memory, RAM, and the like; and other such non-transitory computer-readable storage media. In a UNIX-based embodiment, the software modules may be embodied in a file, which may be a device, a terminal, a local or remote file, or other such devices. Other new and various types of computer-readable storage media may be used to store the software modules discussed herein.

### Example Architectures for Security Management Systems

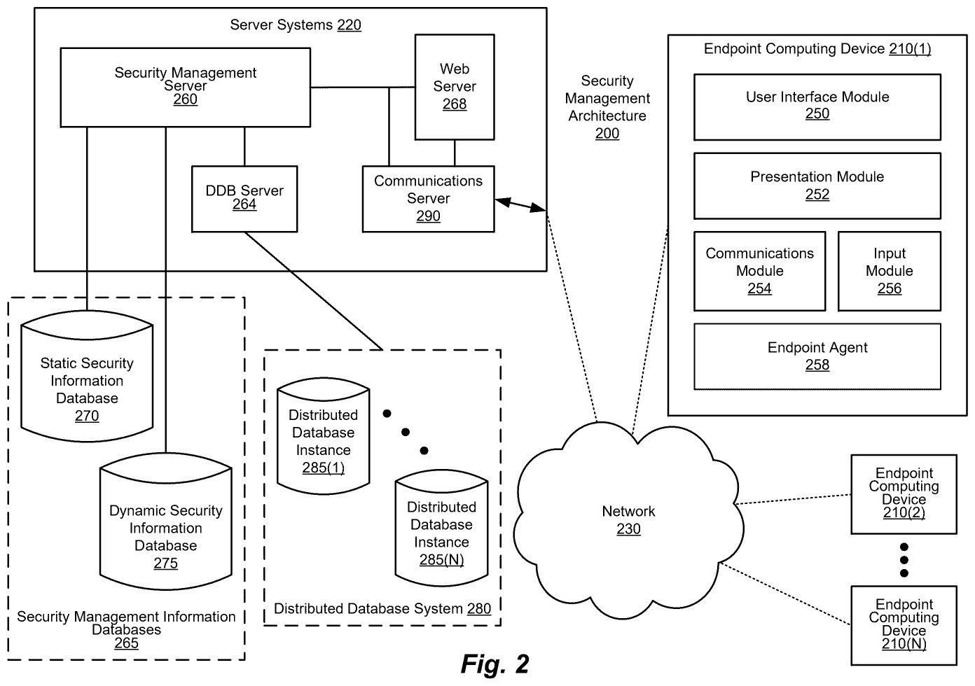

FIG. 2 is a block diagram illustrating an example of a security management architecture, according to methods and systems such as those disclosed herein. The security management architecture of FIG. 2 (depicted in FIG. 2 as a security management architecture 200) presents a simplified illustration of the salient features of network architecture 115 with regard to certain aspects of methods and systems such as those disclosed herein. That being the case, security management architecture 200 is depicted as including a number of client computer systems (e.g., depicted in FIG. 2 as endpoint computing devices 210(1)-(N) (in the manner of clients 125(1)-(N), among other components of FIG. 1), which are referred to in the aggregate as endpoint computing devices 210) and server systems (e.g., depicted in FIG. 2 as server systems 220 (in the manner of server systems 180), which are referred to in the aggregate as server systems 220). Endpoint computing devices 210 and server systems 220 can be communicatively coupled to one another in security management architecture 200 by some manner of communications network (e.g., depicted in FIG. 2 as network 230, which can employ one or more of the communication mechanisms depicted therein, and/or other digital and/or analog techniques).

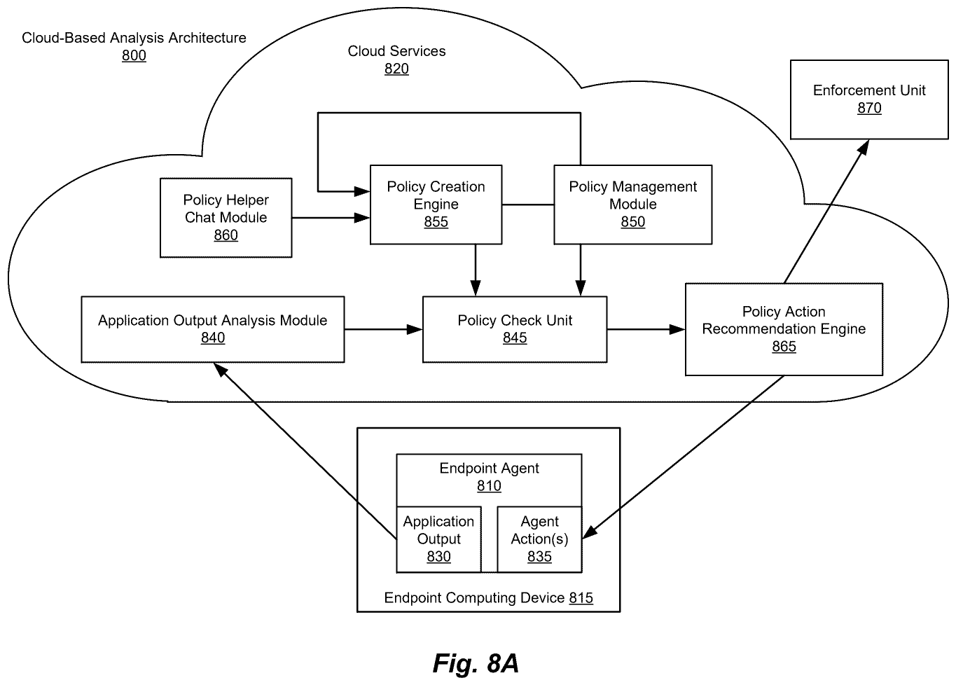

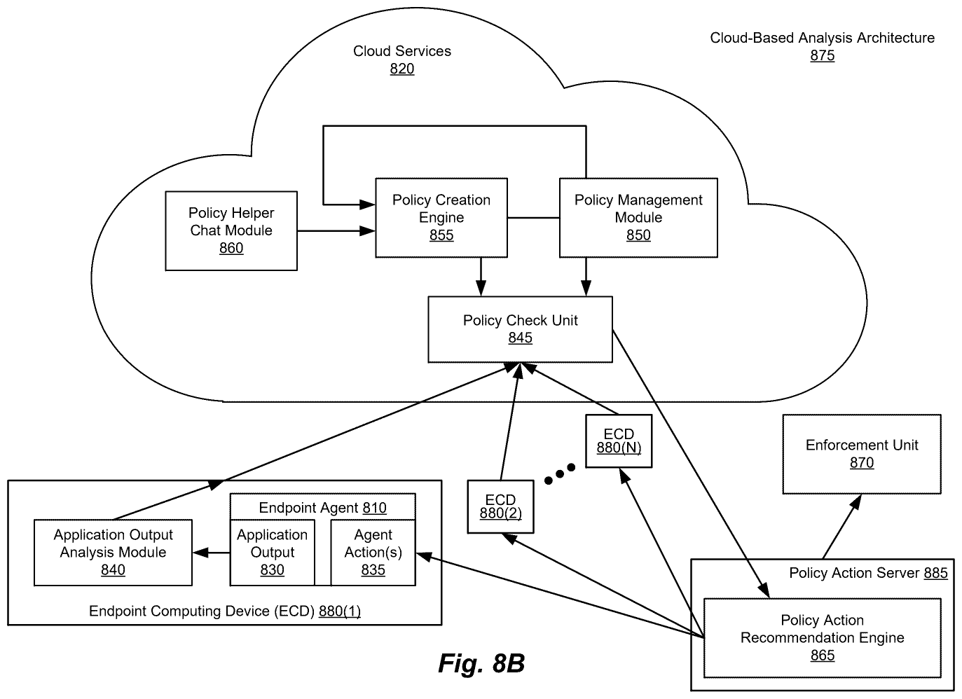

In turn, each of endpoint computing devices 210 can include a number of components in order to provide functionality that supports various of the features of the methods and systems described herein. To that end, endpoint computing device 210(1) is shown as including a user interface module 250, which is supported by a presentation module 252. User interface module 250 and presentation module 252 serve to present a user of endpoint computing device 210(1) with a user interface, the application output displayed therein can be analyzed methods and systems such as those described herein, for example. This allows, for example, the aforementioned visual presentation of information (e.g., video, audio, messages, and/or the like, individually or in appropriate combination) in a user interface displayed on a display of endpoint computing device 210(1) (implemented, e.g., by way of a computer or mobile device). Endpoint computing device 210(1) also includes functional modules (which can be implemented in hardware, software, or a combination thereof) that implement various of the functionalities presented to the user by way of user interface module 250 and presentation module 252. For example, such functional modules can include a communications module 254, an input module 256, an endpoint agent 258 (such as that described in greater detail subsequently (e.g., in FIGS. 8A and 8B)), and other such modules, as may be implemented in support of the aforementioned functionalities. In certain embodiments, endpoint agent 258 provides functionality that gathers application output, segments such output, determine the value of such segmented, and generate decisions based on the values thus determined. As will be appreciated, communications module 254 and endpoint agent 258 can communicate with the servers of server systems 220 via network 230, for example, in providing the security management functionality described herein.

In turn, and in the manner of various of the components described in connection with FIG. 1, server systems 220 can include, for example, a security management server 260, a DDB server 264, and a web server 268, variously in communication with one another. Server systems 220 are supported by a number of databases storing various information in support of the functionality provided by server systems 220 to endpoint computing devices 210 via network 230. These databases (depicted in FIG. 2 as security management information databases 265, which can store security management information such as static security management information, dynamic security management information, and other security management information) can include, for example, a static security management information database 270 and a dynamic security management information database 275. Databases supporting server systems 220 can also include one or more distributed databases (e.g., depicted in FIG. 2, in the aggregate, as distributed database (DDB) system 280, and more specifically, as a number of distributed database (DDB) instances 285(1)-(N), referred to in the aggregate as DDB instances 285). As will be appreciated from the present disclosure, distributed database system 280 can be used to support server systems 220 by facilitating the storage of large amounts of data, as can be encountered in the use of geographic information systems data, map data, and the like by security management architecture 200.

Static security management information database 270 can be used to maintain, for example, static security management information for use by security management server 260 in managing endpoint computing devices by way of communication with endpoint agents such as endpoint agent 258 and those described elsewhere herein (e.g., in FIGS. 8A and 8B, subsequently). As is described subsequently, such static security management information can include historical information regarding security, historical endpoint computing device use, endpoint computing performance, previous detection information, and other such historical data. In this regard, predictions as to operational factors (e.g., as can be generated using machine learning techniques such as those described subsequently) can be considered as well. Such information can be used to provide embodiments of a security system according to the present disclosure, as is described subsequently herein.

Static security management information database 270 can be implemented using, for example, a document-oriented database (storing security management information in a textual format), or document store (a computer program designed for storing, retrieving and managing unstructured data such as document-oriented information (which can be referred to as, for example, semi-structured data) and other constructs that can be used to implement/represent security information, such a policy data and/or other policy information). Such a database can be implemented as a type of “NoSQL” database (a “Not only SQL” database, where the term SQL refers to Structured Query Language used in relational databases), and which refers to the fact that such databases extend beyond the use of tabular information, as in a traditional relational database (RDB). Whereas a relational database is a collection of information that organizes data in predefined relationships in which data is stored in one or more tables (or “relations”) of columns and rows, easing the tasks of visualizing and interpretating the manner in which the RDB's different data structures relate to one another, at the expense of the structured used in implementing such database architectures.

Such a document-oriented database can be implemented, more specifically, as one or more databases that accept documents in JavaScript Object Notation (JSON; being a subclass of document-oriented databases that are optimized to work with JSON, a lightweight data-interchange format), extended markup language (XML; being a subclass of document-oriented databases that are optimized to work with XML documents) or graph databases (which are similar, but add another layer, the relationship, which allows them to link documents for rapid traversal). Such document-oriented databases are inherently a subclass of the key-value store, which is another NoSQL database concept. One difference is the manner in which the data is processed: in a key-value store, the data is considered to be inherently opaque to the database, whereas a document-oriented system relies on internal structure in the document in order to extract metadata that the database engine uses for further optimization. Such a document database, for example, can store all information for a given object in a single instance in the database, and every stored object can be different from every other, thus eliminating the need for object-relational mapping while loading data into the database. In the present application, implementing static security management information database 270 in the aforementioned manner facilitates the storage and maintenance of unstructured information used by security management systems such as those described herein (e.g., information in a variety of formats that can include machine learning parameters (e.g., weights and biases), iterative summations, thresholds, the structure of directed graphs, edge weights for such directed graphs, security information, security information, security management information, distribution/collection goals, and other such unstructured data, as is described in greater detail elsewhere herein).

In certain embodiments, security management information such as security information is stored in one or more traditional structured databases. Such databases are organized collections of data or a type of data store based on the use of a database management system. Such database management systems may be classified according to the database models supported. For example, as noted earlier, a relational database can be used to maintain security management information, modeling data (e.g., security information) as rows and columns in a series of tables and using structured query language (SQL) for writing and querying data (as opposed to the aforementioned NoSQL databases, which use different query languages).

Similarly, security management information databases 265 are depicted as including dynamic security management information database 275, which can be used to maintain, for example, dynamic security management information for use by security management server 260 in managing endpoint computing devices, applications, and/or other components of a computing environment.

As will be appreciated in light of the present disclosure, dynamic security management information databases such as dynamic security management information database 275 can employ databases architectures such as those described in connection with static security management information database 270. Further, while static security management information database 270 and dynamic security management information database 275 can employ the same or similar database architectures, such need not be the case-static security management information database 270 could use a relational database architecture, while dynamic security management information database 275 used a text-based semi-unstructured database architecture. Such might be the case where the static data in static security management information database 270 was regular in nature and changed infrequently (and so the tables storing such information were not constantly being access and/or updated), while the dynamic data stored in dynamic security management information database 275 was irregular in nature and subject to potentially frequent and (at least potentially) unpredictable changes.

With reference to the aforementioned communications with endpoint computing devices 210, it will be appreciated, in light of the present disclosure, that a user interface presented by user interface module 250 and presentation module 252 can be generated, for example, by web server 268, in conjunction with its interactions with security management server 260, via a communications server 290. In such embodiments, security management server 260 provides the requisite information to web server 268 to serve to endpoint computing devices 210 as one or more web pages. Security management server 260 can also (or alternatively) provide such information to endpoint computing devices 210, for example, by way of a communications server 290 in communication with, for example, communications module 254 of endpoint computing device 210(1).

As will be appreciated, in providing such “back-end” functionality, security management server 260 accesses the various databases of security management architecture 200 databases (e.g., security management information databases 265 and, via DDB server 264, DDB system 280, respectively) in order to provide the requisite information to security management server 260. In security management architecture 200, DDB instances 285(1)-(N) maintain detailed (and thus, voluminous) information regarding endpoint computing devices, applications, licenses, and/or the like.

As will be apparent in view of the description of FIG. 2, as well as those of other of the figures, the components of security management architecture 200 and their interconnection (and so, intercommunication) are such that the functionalities described herein are presented in a user interface at a client computing device such as endpoint computing device 210(1), in a user interface produced by user interface module 250 and presentation module 252, as noted. As also noted, communications module 254, input module 256, and endpoint agent 258, among others, are designed in a manner to support and control such functionalities. Security management server 260 (as well as various components corresponding thereto, as described in connection with subsequent figures) can also provide functionality that allows endpoint computing devices 210 to be controlled by allowing endpoint agents (e.g., endpoint agent 258) to interact directly with both static security management information database 270 and dynamic security management information database 275 of security management information databases 265, as well as DDB system 280 (by way of DDB server 264; which can be used to maintain (potentially) voluminous information such as that described earlier, as well as parameters used in the operation of the machine learning systems described subsequently.

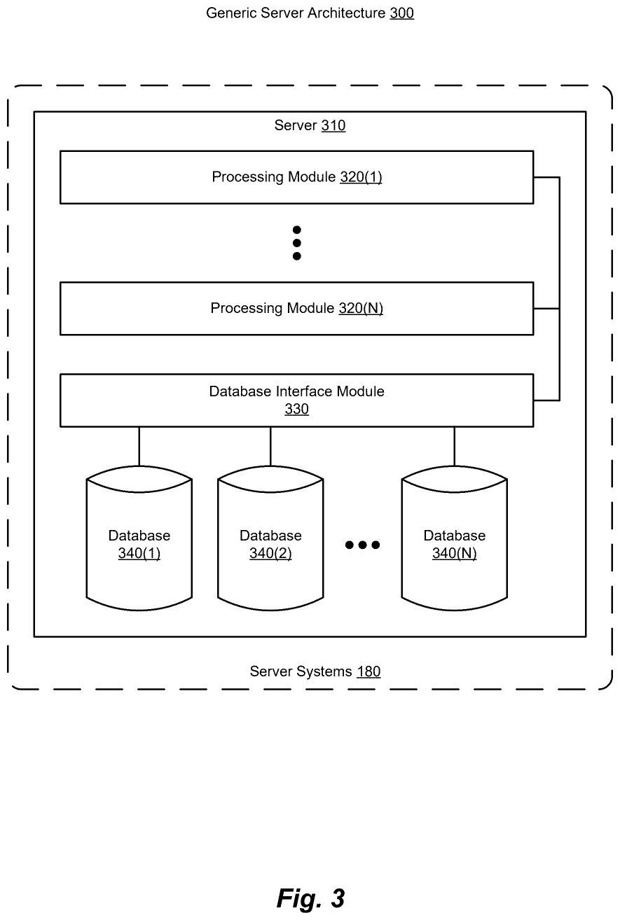

FIG. 3 is a block diagram illustrating an example of a generic server architecture, according to methods and systems such as those disclosed herein. FIG. 3 thus depicts a generic server architecture 300 that can be used to implement one or more of the server systems of server systems 180. A server of server systems 180 (depicted in FIG. 3 as a server 310) will thus include, typically, a number of components that support the maintenance and retrieval of digital information. For example, such components can include one or more processing modules (depicted in FIG. 3 as processing modules 320(1)-(N), a database interface module (depicted in FIG. 3 as a database interface module 330), and one or more databases (depicted in FIG. 3 as databases 340(1)-(N)). Generally, databases 340(1)-(N) store digital information pertinent to the processing performed by processing modules 320(1)-(N). Database interface module 330 provides one or more of processing modules 320(1)-(N) with access to databases 340(1)-(N). Additionally, database interface module 330 can provide other servers of the given server systems, as well as other components of the distributed manufacturing system, with access to databases 340(1)-(N). As noted, an example of such access is depicted in FIG. 2B by the various communications paths illustrated therein.

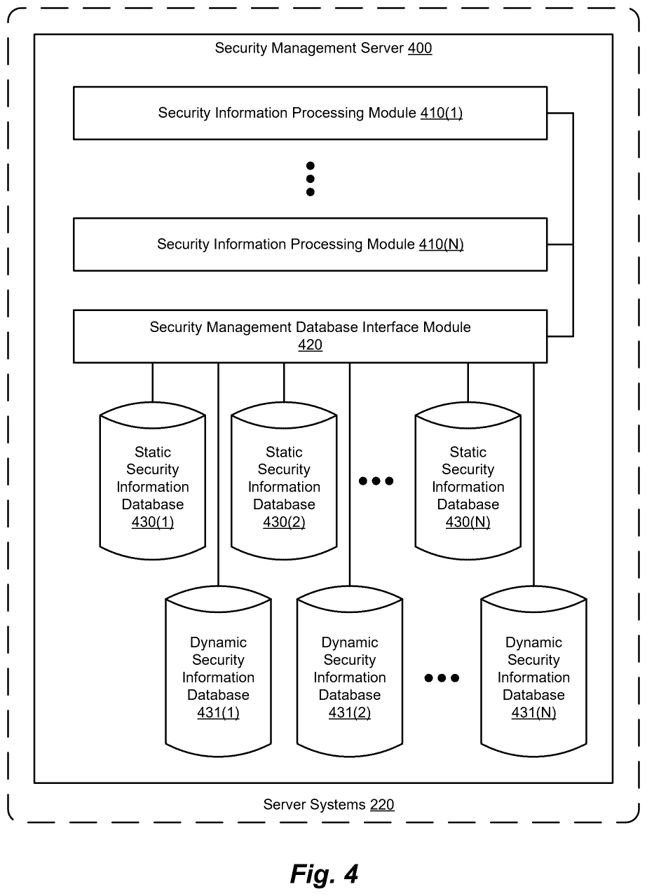

FIG. 4 is a block diagram illustrating an example of a security management server, according to methods and systems such as those disclosed herein. In the manner of generic server architecture 300, a security management server of server systems 220 is depicted as a security management server 400. In the manner of generic server architecture 300, then, security management server 400 includes one or more security information processing modules (depicted in FIG. 4 as security information processing modules 410(1)-(N)), a number of security management databases (depicted in FIG. 4 as static security management databases 430(1)-(N) and dynamic security management databases 431(1)-(N), referred to in the aggregate as static security management databases 430 and dynamic security management databases 431, respectively), and interfacing such security information processing modules and security management databases, a security management database interface module (depicted in FIG. 4 as a security management database interface module 420). As noted in connection with FIG. 2, the components of security management server 400 support clients, such as endpoint computing devices 210 of FIG. 2, by maintaining security, prompt, system, and other information, as may be generated, maintained, and/or communicated by a security management server such as security management server 260 of FIG. 2. To this end, security management database interface module 420 can provide other servers of server systems 220, as well as other components of the security management system, with access to security management databases, as well as information ingested from external sources (e.g., for information regarding previous security incidents, best practices, security policies, and other internal and/or external information). For example, as depicted in FIG. 2, security management database interface module 420 can provide security management information to security management server 260 with access to static security management databases 430 and dynamic security management databases 431 via communication paths such as those depicted in FIG. 2. Further, in certain embodiments, static security management databases 430 store only static security information (e.g., information used in the normal operation of a security management system such as that described herein (which may or may change during such normal operations)), and so, need not be updated with information from external sources. In certain such embodiments, dynamic security management databases 431 store dynamic security information (e.g., information that is expected to be updated regularly or intermittently, as circumstances develop during the operation of the security management system). In such embodiments, the information maintained in dynamic security management databases 431 can be accessed (e.g., directly or via security management database interface module 420) to provide dynamic update of the information stored therein.

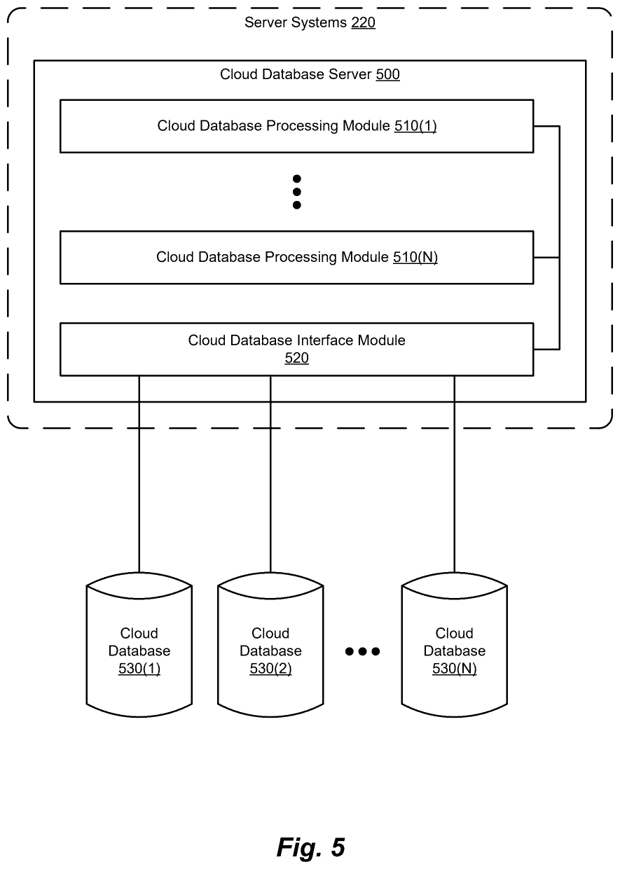

FIG. 5 is a block diagram illustrating an example of a cloud database server, according to methods and systems such as those disclosed herein. In the manner noted, server systems 220 can also include one or more cloud database servers, an example of which is depicted in FIG. 5 as a cloud database server 500. Cloud database server 500 includes one or more cloud database processing modules (depicted in FIG. 5 as cloud database processing modules 510(1)-(N)), which interface with one or more cloud database clients such as cloud database clients 230 of FIG. 2. Cloud database processing modules 510(1)-(N) can be implemented to support the implementation of one or more databases maintaining information for use by security management server 260 of FIG. 2, in the manner mentioned earlier, for example. Further, cloud database processing modules 510(1)-(N) can support user-defined cloud databases and/or the like.

In turn, cloud database processing modules 510 interface via a cloud database interface module 520, with one or more cloud databases (depicted in FIG. 5 as cloud databases 530(1)-(N), and referred to in the aggregate as cloud databases 530). Cloud databases 530 maintain digital information regarding information that is or can become voluminous (e.g., various security information as may be relevant to the support and operation of a security management system such as that described herein). In addition to cloud database processing modules 510 being able to communicate with one another, cloud database processing modules 510 are able to maintain digital information in one or more cloud databases 530 via cloud database interface module 520. In depicting server systems 220 as shown in FIG. 5, it is to be appreciated that, while cloud databases 530 will typically be situated “in the cloud” (e.g., in an onsite and/or offsite data center), some or all of the remaining infrastructure of server systems 220 (e.g., cloud database server 500) may also be situated “in the cloud” (e.g., in the aforementioned data center, another such data center, or elsewhere). Additionally, cloud database interface module 520 can provide other servers of server systems 220, as well as other components of the security information system, with access to cloud databases 530.

Information maintained by one or more servers such as cloud database server 500 can include, for example, security information used by security management server 260 in maintaining and managing security by analyzing application output gleaned from endpoint computing devices 210. As with static security management information database 270 and dynamic security management information database 275 of security management information databases 265, as well as well as the database instances of DDB system 280, cloud databases 530 can be implemented using relational (SQL), NoSQL, distributed, or other database architectures.

For example, a document-oriented database such as a document store (a computer program designed for storing, retrieving and managing unstructured data such as document-oriented information (which can be referred to as, for example, semi-structured data) and other constructs that can be used to implement/represent the relevant communications) can be used to store security information, certain endpoint computing system information, application information, and so on. As noted, implementing such databases in this manner facilitates the storage and maintenance of unstructured information used by security management systems such as those described herein (e.g., information in a variety of formats that can include subject information, testing information, certification information in a variety of formats (providing for the reporting of information in narrative formats, various image and document formats, and other types of information), and other such unstructured data, as is described in greater detail subsequently, and allowing for such information to be searched and identified quickly and efficiently).

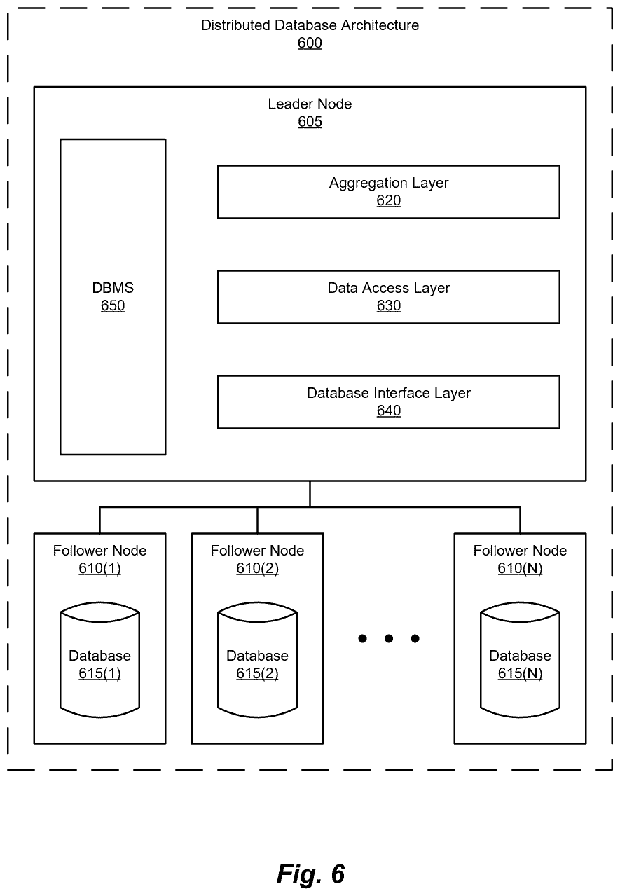

FIG. 6 is a block diagram illustrating an example of a distributed database architecture, according to methods and systems such as those disclosed herein. The database server architecture of FIG. 6 (depicted in FIG. 6 as a distributed database (DDB) architecture 600) is an example of a database architecture that can be employed to implement DDB server 264 and DDB system 280 of FIG. 2. DDB architecture 600 can include, for example, one or more leader nodes (e.g., depicted in FIG. 6 as a leader node 605) and some number of follower nodes (e.g., depicted in FIG. 6 as follower nodes 610(1)-(N), and referred to in the aggregate as follower nodes 610). Follower nodes 610, in turn, can include one or more databases (e.g., depicted in FIG. 6 as databases 615(1)-(N), and referred to in the aggregate as databases 615). As noted, a distributed database architecture such as DDB architecture 600 can be used to store and maintain a variety of information useful to the management of endpoint computing device, applications, and subject management, as is described in greater detail subsequently. As will be appreciated in light of the present disclosure, follower nodes 610 can, in fact, be situated at one or more remote sites (in certain architectures, referred to as being “in the cloud,” as noted), each of follower nodes 610 can host one or more distributed database instances (e.g., one or more of DDB instances 285).

Returning to leader node 605, leader node 605 (as an example of DDB server 264) includes an aggregation layer 620, a data access layer 630, and a database interface layer 640. As is also depicted in FIG. 6, a database management system (DBMS) 650 can be implemented, for example, in leader node 605, and act to manage various of the components of DDB architecture 600, thereby supporting the distributed nature of DDB architecture 600. As will be appreciated in view of the present disclosure, a distributed database is a database in which storage devices are not all attached to a common processor. Such a distributed database may be stored in multiple computers (e.g., located in the same physical location) or may be dispersed over a network of interconnected computers. Unlike parallel systems, in which the processors are tightly coupled and constitute a single database system, a distributed database system consists of loosely coupled sites that share no physical components. System administrators can distribute collections of data (e.g. in a database) across multiple physical locations. A distributed database can reside on organized network servers or decentralized independent computers on the Internet, on corporate intranets or extranets, or on other networks. Because distributed databases store data across multiple computers, distributed databases can improve performance at end-user worksites by allowing transactions to be processed on many machines, instead of being limited to one.

An aggregation layer such as aggregation layer 620 facilitates the gathering and organization of information from various information sources appropriate to the information administered and maintained by server 605. For example, in certain embodiments, components within an aggregation layer of a distributed database server, as might be implemented to support a subject information server such as that described herein, receive and organize various information from one or more endpoint computing devices such as endpoint computing devices 260 and various of the systems of server systems 220. Components within an aggregation layer of a server such as a DDB server 264 receive and organize information regarding various aspects of such systems, such as the various modes of communication noted. As will be appreciated in light of the present disclosure, such aggregation layers also provide, in turn, functionality that supports distribution of information such as that maintained in the databases or their respective servers.

Situated between aggregation layer 620 and database interface layer 640 is data access layer 630, which supports storage/retrieval of aggregated data to/from one or more databases. Data access layer 630 facilitates such storage/retrieval by using a common structure to sink and source such aggregated data. Data access layer 630 facilitates access to such databases (depicted in FIG. 6 as databases 615(1)-(N)) via database interface layer 640. Database interface layer 640 facilitates communication of aggregated data using the common structure to databases 615(1)-(N) in a structure appropriate to each of databases 615(1)-(N) and/or to databases 615, collectively. As noted, and with particular regard to the discussion of FIG. 2, an arrangement such as database server architecture 600 can be used in the implementation of servers such as DDB server 264. To this end, an aggregation layer such as aggregation layer 620 supports the collection of information from multiple sources (e.g., communications from/to security management server 260, endpoint computing devices 210, and so on), and provides such information for storage in a respective database, via a data access layer such as data access layer 630 (which produces aggregated data in a common structure for storage, and receives data in the common format when retrieving such data) and a database interface layer such as database interface layer 640 (which takes in the aggregated data in the common structure and produces data in a structure appropriate to the database into which the data is to be stored, and conversely, provides data in the common structure when retrieving such data). Such an architecture, in turn, supports the retrieval of such data by security management server 260 and endpoint computing devices 210, via DDB server 264.

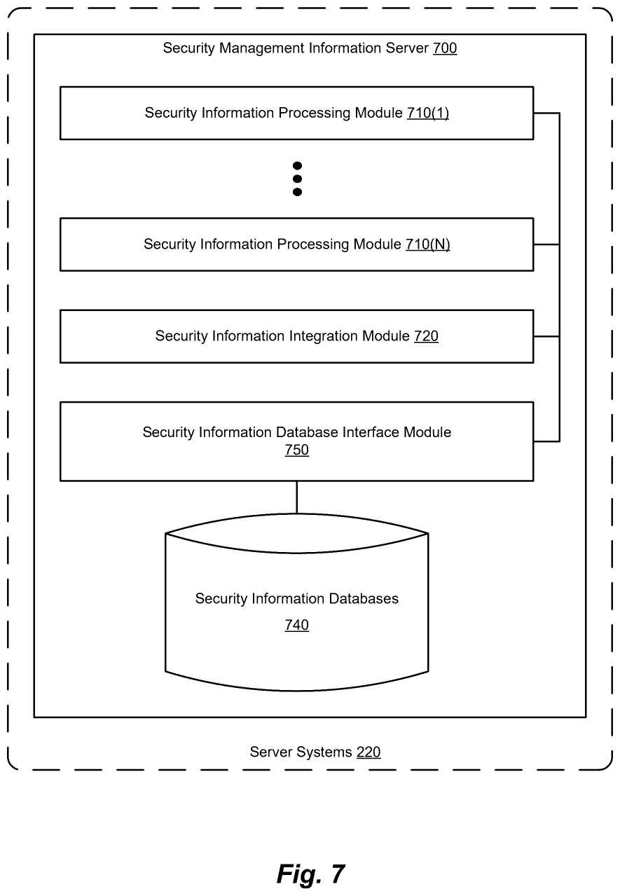

FIG. 7 is a block diagram illustrating an example of a security management information server, according to methods and systems such as those disclosed herein. Another server that can be included in server systems 220 is a security management information server (depicted in FIG. 7 as a security management information server 700). Subject information server 700 can include a number of components, among them, for example, one or more security management information processing modules (depicted in FIG. 7, as security management information processing modules 710(1)-(N)), one or more security management information integration modules (depicted in FIG. 7 as security management information integration modules 720), and one or more security management information databases (depicted in FIG. 7 as security management information databases 740), accessed via a security management information database interface module (depicted in FIG. 7 as a security management information database interface module 750). It will be appreciated that security management information databases 265 of FIG. 2 can be implemented as security management information databases 740, with FIG. 7 depicting such an implementation in greater detail.

To this end, security management information database interface module 750 can provide other servers of server systems 220, as well as other components of the security management systems (e.g., endpoint computing devices 210), with access to security management information database 740 for purposes of maintaining the information stored therein. It is to be appreciated that, while not shown in FIG. 2, security management information server 700 can be tasked with maintaining the information stored in security management information databases 740 from an administrative perspective, in such embodiments. For example, whereas security management server 260 of FIG. 2 is tasked with making determinations as to static and dynamic security and endpoint application assessments, security management information server 700 can be implemented to separately facilitate administrative operations (e.g., adding/deleting subjects (subjects accounts), adding/deleting endpoint computing devices, performing inventory and usage functions, updating information, and other such administrative operations). In such embodiments, it is to be appreciated that security information can be distinguished from administrative information. Such administrative operations can extend to security information received from endpoint computing devices.

### Example Architectures for Machine Learning Analysis of Endpoint Application Output

FIG. 8A is a block diagram illustrating an example of a cloud-based analysis architecture, according to methods and systems such as those disclosed herein. That being the case, FIG. 8A thus depicts a cloud-based analysis architecture 800, which includes an endpoint agent 810, which is executed at an endpoint computing device 815 (e.g., in the manner of endpoint agent 258 being executed by endpoint computing device 210(1) in FIG. 2). Endpoint agent 810 is in communication with one or more cloud services (depicted in FIG. 8A as cloud services 820). Endpoint agent 810 captures an application output 830 and sends that application output to cloud services 820. Cloud services 820 then determine the requisite action(s) to be taken based on that (and other) information, and send information regarding such actions to endpoint agent 810 as agent action(s) 835.

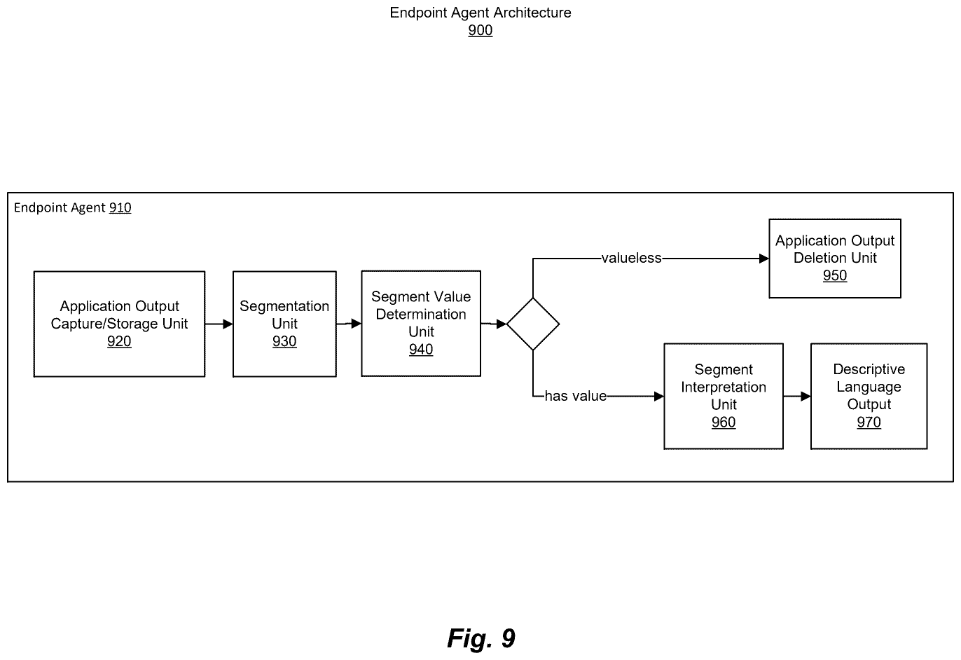

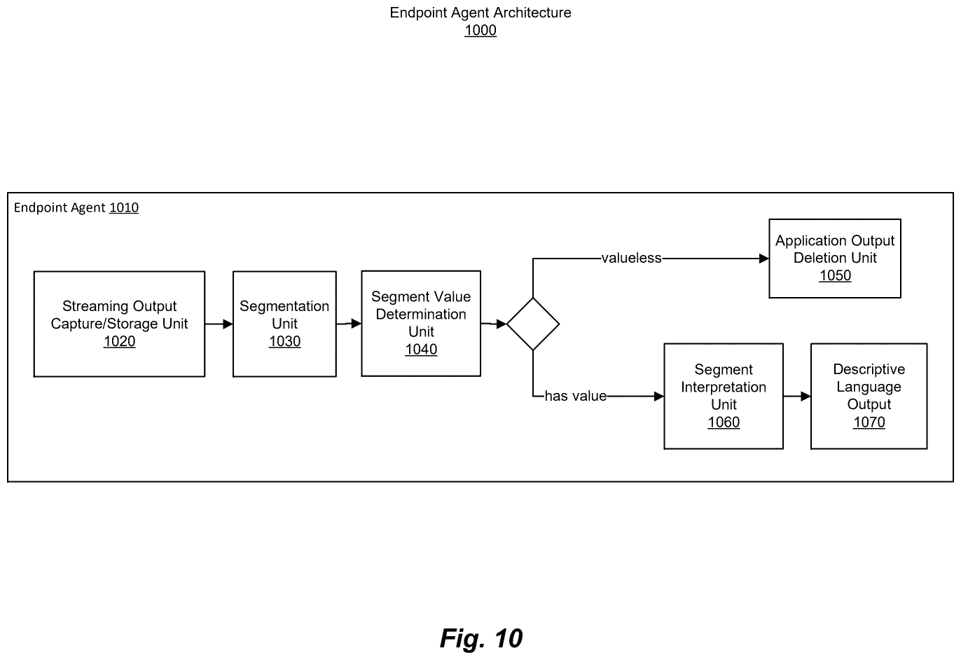

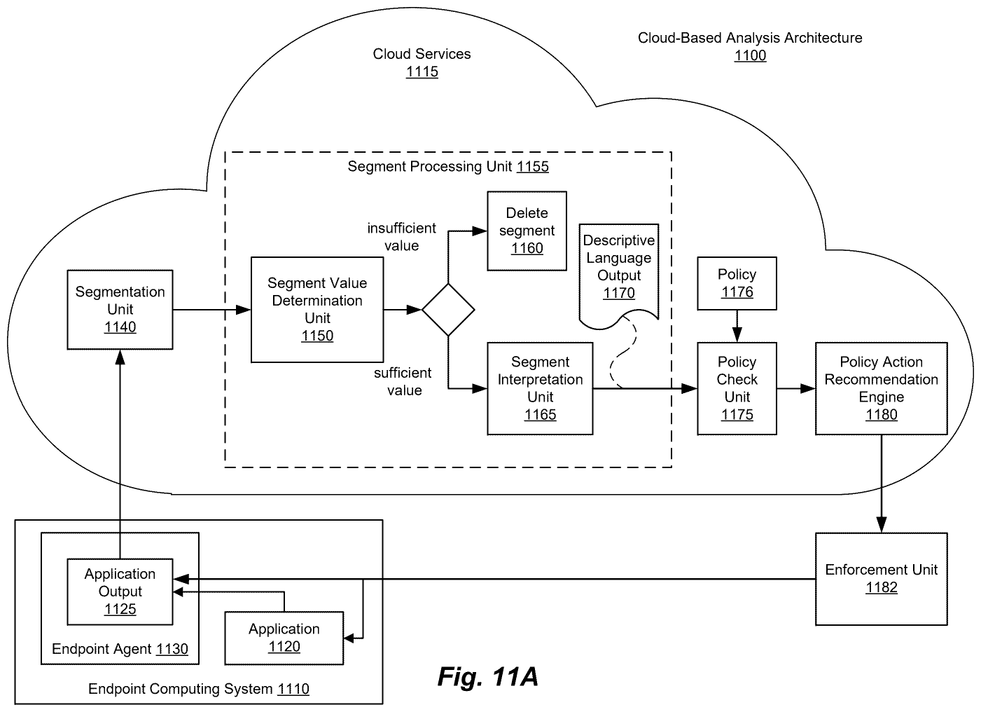

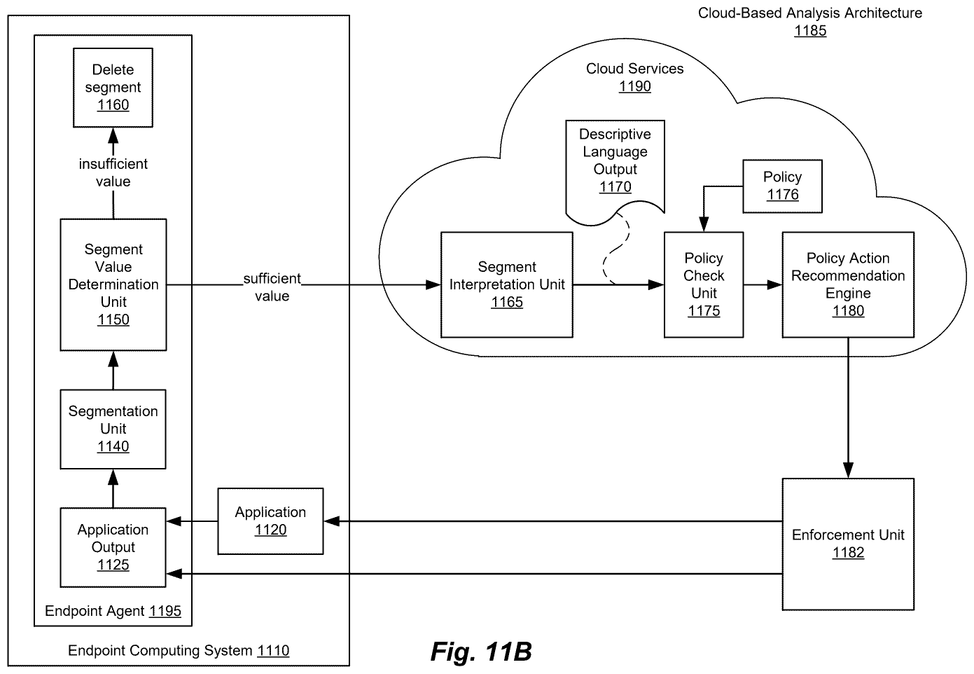

Cloud services 820 can include a number of functionalities/modules that ingest application output 830 and, in turn, produce one or more agent actions (actions to be taken by endpoint agent 810, such as endpoint action(s) 835). For example, cloud services 820 can include an application output analysis module 840, which receives application output 830 and performs processing on that information (e.g., the processing of such information including segmentation of a graphical user interface displayed on a display of an endpoint computing system, retrieval of application output from video memory thereof, retrieval of application output from a device file, or from some other source, and generation of a description describing the resulting segmented information). Such functionality can be performed within endpoint agent 810 (examples of which are depicted in FIGS. 9 and 10, subsequently) or remotely (e.g., “in the cloud,” as in the example described in connection with FIGS. 11A and 11B, subsequently).

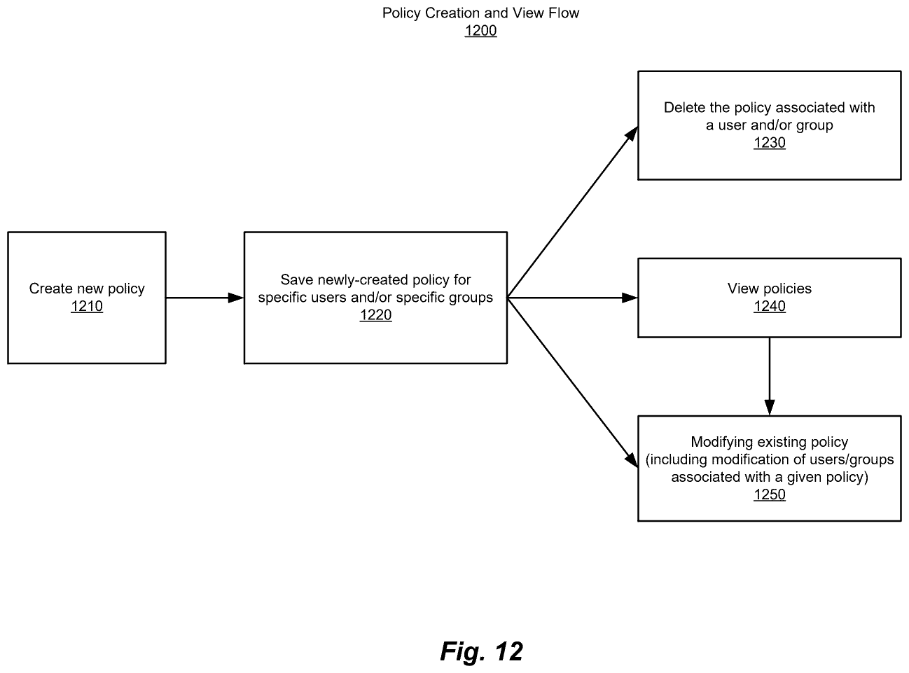

The output of application output analysis module 840 is in a descriptive language (e.g., a description of the application output or segment thereof in a natural language, a description represented using an internal language (e.g., information intelligible to a computing system by not human-readable), and/or other such information), and is passed to a policy check unit 845, which also receives policy information from a policy management module 850 and/or a policy creation engine 855. In certain embodiments, policy management module 850 provides for the creation of policies (e.g., manually or through the use of machine learning techniques such as those described herein), as well as the viewing, deletion, and modification of such policies (regardless of the manner in which such policies were created). With regard to such creation of policies (and more generally, managing such policies, regardless of the manner in which the policies were generated), as well as the other functionality noted, is described in connection with FIG. 12, subsequently. Additionally (or in the alternative), policy management module 850 can provide output to policy creation engine 855, either individually or in combination with chat output of a policy helper chat module 860, in certain embodiments.

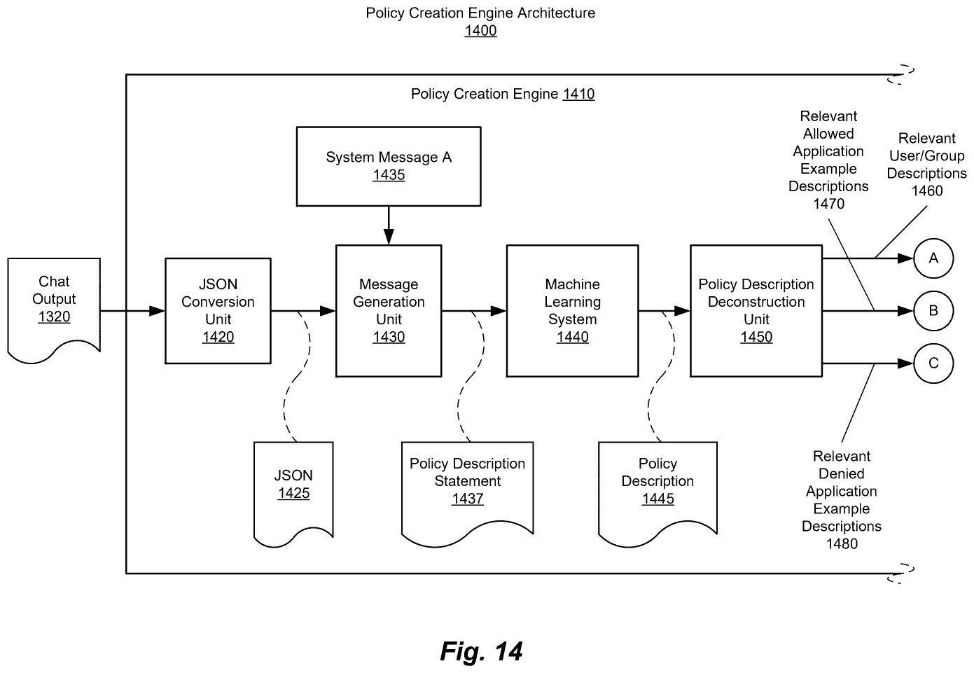

In certain embodiments, policy creation engine 855 generates policies for use by policy check unit 845 based on information received from policy helper chat module 860 (e.g., chat output of policy helper chat module 860). In such embodiments, policy helper chat module 860 can gather information for policy creation engine 855 by interacting with one or more users (e.g., an administrator). In such embodiments, policy helper chat module 860 interacts with such users by way of, for example, messaging with such users using a conversational interface. An example of such an implementation of a policy creation engine such as policy creation engine 855 is described in connection with FIGS. 14, 15, and 16, subsequently.

Based on inputs received from policy creation engine 855 (e.g., a statement capturing the intended policies and, potentially, contextual information) and application output analysis module 840 (e.g., analyzed application output), policy check unit 845 produces policy determinations that are taken as input by a policy action recommendation engine 865. Based on such information, policy action recommendation engine 865 provides information to an enforcement unit 870, as well as providing appropriate actions to be taken, which are sent to endpoint agent 810 as agent action(s) 835. Enforcement unit 870 can include functionality such as a secure identity cloud, a security orchestration and automation platform, and extended detection and response system, and/or the like. For example, such an extended detection and response (XDR) systems can collect threat data from previously siloed security tools across an organization's technology stack for easier and faster investigation, threat hunting, and response. As is discussed at length subsequently, agent action(s) 835 can include disabling accounts, shutting down applications, and/or taking other actions as may be appropriate in light of the resources used/accessed (e.g., applications in use), policies in force, and other such considerations. Further, as is described in connection with FIG. 8B, below, it is to be appreciated that resource outputs and agent action(s) can be output from/input to endpoint agent/endpoint computing device as shown in FIG. 8A, but the application output analysis module, policy check unit, and policy action recommendation engine can be on the endpoint computing device, on a server (accessed, e.g., by way of a network), or elsewhere in the computing ecosystem.

FIG. 8B is a block diagram illustrating an example of another cloud-based analysis architecture, according to methods and systems such as those disclosed herein. FIG. 8B thus depicts a cloud-based analysis architecture 875, which is comparable to cloud-based analysis architecture 800, but illustrates that various components depicted as being one of cloud services 820, can in fact be executed on an endpoint computing device, a server on a local area network (LAN), or elsewhere. As before, endpoint agent 810 is executed by an endpoint computing device, though here, the endpoint computing device is one of a number of endpoint computing devices (depicted as endpoint computing devices 880(1)-(N), and referred to in the aggregate as endpoint computing devices (ECDs) 880). Also as before, each endpoint agent of ECDs 880 captures application output 830 and provides that output to an application output analysis module, and receives one or more agent action(s) 835 (e.g., actions to be taken by endpoint agent 810). However, in the architecture depicted as cloud-based analysis architecture 875, each of endpoint computing devices 880 also supports its own application output analysis module (e.g., application output analysis module 840 being depicted as receiving application output 830, being executed at ECD 880(1)). Here, each application output analysis module (e.g., application output analysis module 840) communicates application output to policy check unit 845. As before, policy check unit 845 receives policy information from policy management module 850 and/or policy creation engine 855 (possibly as a result of receipts of the chat output of policy helper chat module 860), and checks outputs received from the various application output analysis modules of ECDs 880 (e.g., application output analysis module 840). Also as before, such output can be, for example, in a descriptive language (e.g., a description of the application output or segment thereof in a natural language).

Based on inputs received from policy creation engine 855 (e.g., a statement capturing the intended policies and, potentially, contextual information) and each application output analysis module (e.g., analyzed application output), policy check unit 845 produces policy determinations that are taken as input by policy action recommendation engine 865. In the embodiment depicted in FIG. 8B, policy action recommendation engine 865 is executed at a policy action server 885. As such, the functionalities provided by policy action recommendation engine 865 are made available to ECDs 880 (as well as any other computing devices on the LAN in need of such services). Based on such information, policy action recommendation engine 865 provides information to enforcement unit 870, as well as providing appropriate actions to be taken (as before, with functionalities such as those described earlier), which are also sent to each ECD's endpoint agent (e.g., endpoint agent 810) as agent actions (e.g., agent action(s) 835). As noted, agent action(s) 835 can include disabling accounts, shutting down applications, and/or taking other actions as may be appropriate in light of the applications in use, policies in force, and other such considerations, but now are provided to each of ECDs 880.

### Example Architectural Features for Security Management Systems

FIG. 9 is a block diagram illustrating an example of an endpoint agent architecture, according to methods and systems such as those disclosed herein. FIG. 9 thus depicts an endpoint agent architecture 900, which includes an endpoint agent 910. Endpoint agent 910, in turn, includes an application output capture/storage unit 920, a segmentation unit 930, and a segment value determination unit 940. In this embodiment, endpoint agent 910 is configured to capture and store one or more digital images, for example. Such capturing can be accomplished by way of screen capture, retrieving image information from video memory, retrieving application information from system memory (which may or may not be graphical in nature, but may instead be textual, information in data structures, or any number of other types of information), and/or other sources of application output. Such application output is then passed from application output capture/storage unit 920 to segmentation unit 930, which divides the application output into segments. Such segments can be, as noted, digital images that have been broken into segments corresponding to, for example, application output in the windows of a graphical user interface (GUI), portions of one or more digital images, screen background, window elements (e.g., title bars, menu bars, icons, application and company logos, window controls, scroll bars, content areas, tabs, and so on), or the like, which can then be subject to a determination as to each such segment's value. Such valuation is performed by segment value determination unit 940, which places a value on each such segment based on, for example, the importance of each such segment in view of the context and applicable policies in the given situation. For example, window elements such as window controls and scroll bars, and screen backgrounds, have little or no intrinsic value when determining whether a given policy applies to a given application. By contrast, elements such as content areas, application and company logos, and the like provide valuable information as to whether a given policy applies to a given application. By making such distinctions, a system according to methods and systems such as those described herein is able to winnow down the amount of information needing to be subjected to further analysis, improving the efficiency of the policy determination needing to be made. Further, by sufficiently isolating elements such as application and company logos (e.g., sufficient to allow identification of such screen elements), such a system can make decisions for certain applications/resources/content quickly, simply by identifying the application/resource/content in question by its application and company logo, avoiding the need for further processing of the application's/resource's output (and potentially, avoiding the need for policy processing, as where no applications from a certain company are allowed in the given context, for example).

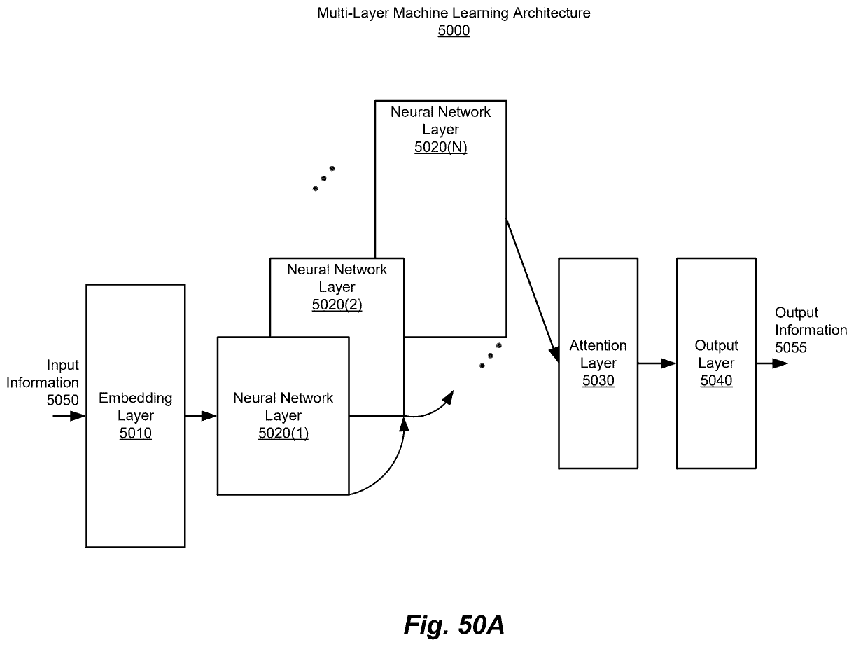

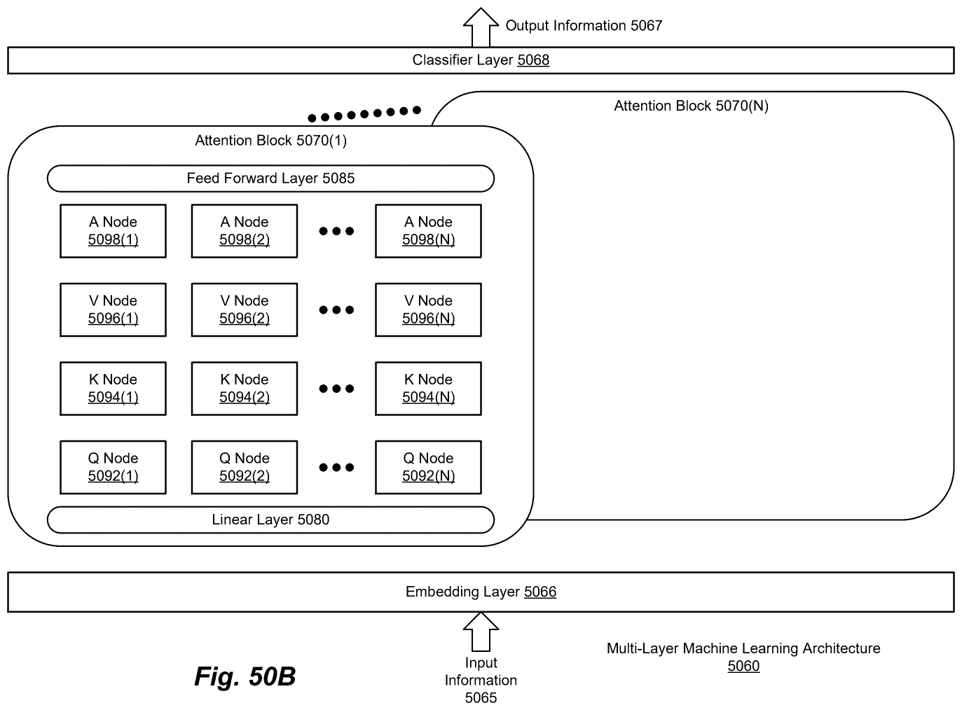

For each such segment, segment value determination unit 940 is able to place a value on the segment in question using the bases noted. In the embodiment depicted in FIG. 9, the possible outcomes are “valueless” (a segment having no value with regard to further analysis (e.g., a GUI desktop with wallpaper depicting the ocean)) or “has value” (a segment that is to be subject to further analysis (e.g., a GUI window displaying the output of an application that may be subject to one or more policies)). In the former case, in which the segment is valueless, endpoint agent 910 proceeds with deleting the application output that is been captured (depicted in FIG. 9 as an application output deletion unit 950). In the alternative, a segment determined to have value is passed to a segment interpretation unit 960, which produces a description of the segment as a descriptive language output 970. Descriptive language output 970 is, in certain embodiments, a statement (e.g., in a natural language) that describes the segment. Such description can be generated using language that lends itself to the application of policies (e.g., as by a policy check unit such as policy check unit 850 of FIG. 8). It is to be appreciated that a value, with respect to a given segment can be that one segments value as to the ability to use that piece to make a determination (in fact, any relevant determination with respect to the policy or policies at hand). Further, a reverse image search can be performed as part of the segment's/image's interpretation to determine what the segment/image indicates that the application in question is not. Such analysis can reasonably be comprehended by an interpretation performed by way of an LLM analysis unit that analyzes the segment/image in question using an architecture such as that described in connection with FIGS. 50A and 50B, subsequently.

FIG. 10 is a block diagram illustrating an example of another endpoint agent architecture, according to methods and systems such as those disclosed herein. In the manner of FIG. 9, FIG. 10 thus depicts an endpoint agent architecture 1000, which includes an endpoint agent 1010. Endpoint agent 1010, in turn, includes an application output capture/storage unit 1020, a segmentation unit 1030, and a segment value determination unit 1040. In this embodiment, endpoint agent 1010 is configured to capture and store one or more digital video streams and/or one or more digital video clips (or other shortform or longform digital video segments). Such application output is then passed from application output capture/storage unit 1022 segmentation unit 1030, which divides the application output (e.g., stream) into temporal segments, as well as spatial segments such as those discussed in connection with FIG. 9. Such segments can be, as noted, a stream of digital video (with or without audio) that has been broken into segments corresponding to, for example, streaming application output in the windows of a graphical user interface (GUI), portions of digital video or audio, one or more digital images, or the like, which can then be subject to a determination as to each such segment's value. Such valuation is performed by segment value determination unit 1040, which places a value on each such segment based on, for example, the importance of each such segment in view of the context and applicable policies in the given situation.

For each such set of segments, segment value determination unit 1040 is able to place a value on the segment in question using the bases noted. In the embodiment depicted in FIG. 10, the possible outcomes are “valueless” (a segment having no value with regard to further analysis (e.g., a GUI window displaying a system clock)) or “has value” (a segment that is to be subject to further analysis (e.g., a GUI window displaying the output of an application that may be subject to one or more policies)). In the former case, in which the segment is valueless, endpoint agent 1010 need not perform further processing on the segment. This can be, for example, proceeding with deletion of the application output that has been captured (which can be performed by, as depicted in FIG. 10, an application output deletion unit 1050), storing the segment for another purpose (e.g., some manner of confirming that decisions made as to segments being “valueless” is an accurate assessment (such that tuning of such decisions is not needed (or in the alternative, is needed))), or the like. In the alternative, a segment determined to have value is passed to a segment interpretation unit 1060, which produces a description of the segment as a descriptive language output 1070. Descriptive language output 1070 is, in certain embodiments, a statement (e.g., in a natural language) that describes the segment. Such description can be generated using language that lends itself to the application of policies (e.g., as by a policy check unit such as policy check unit 850 of FIG. 8).

FIG. 11A is a block diagram illustrating an example of a cloud-based analysis architecture, according to methods and systems such as those disclosed herein. FIG. 11A thus depicts a cloud-based analysis architecture 1100. In such an architecture, an endpoint computing system 1110 avails itself of cloud services 1115. It will be appreciate that, in light of the present disclosure, endpoint computing system 1110 can be an endpoint computing device such as endpoint computing device 210(1), a virtual desktop, a containerized operating environment, or other such device or construct.

In operation, an application or other resource (e.g., depicted as an application 1120) produces some manner of output, which, as noted elsewhere herein, can include, but is not limited to, output that may appear in a GUI window, information stored in video or other memory, information stored in the main memory or a storage device of endpoint computing system 1110, or information stored in/passed through other volatile/non-volatile memory. Such output is obtained as application output 1125 by an endpoint agent 1130. Endpoint agent 1130 can send some or all of application output 1125 (and/or a representation thereof, or of other portions of application output 1125) to cloud services 1115 for processing and analysis.

In this regard, application output 1125 is received by one of the units included in cloud services 1115, which, in cloud-based analysis architecture 1100, is a segmentation unit 1140. Segmentation unit 1140, in the manner discussed previously, segments application output 1125 and/or its constituent parts into one or more segments. These one or more segments are passed to a segment value determination unit 1150 of a segment processing unit 1155. Segment processing unit 1155 is shown in dashed lines to indicate that the operations performed thereby are performed on each segment produced by segmentation unit 1140, in the embodiment depicted as cloud-based analysis architecture 1100.

In a manner comparable to that discussed previously, then, segment value determination unit 1150 makes a determination as to the value of each such segment. Such a determination, in certain embodiments, can include value determinations of “insufficient value” or “sufficient value,” though other alternatives exist e.g., categorizing a given segment into one of a number of “value levels” that can be used to determine the degree to which such segments are analyzed). In cloud-based analysis architecture 1100, the determination made by segment value determination unit 1150, should it result in a value determination of “insufficient value,” such segment is deleted (e.g., as by an operation to delete the captured application output (e.g., delete segment 1160), which can delete the segment in question, application output 1125 in its entirety, or take, all action with regard to one or more other portions of application output 1125 such as segments, as appropriate, for example). In the alternative, if the segment in question is a “sufficient value,” the segment is passed to a segment interpretation unit 1165. Segment interpretation unit 1165 can be, for example, an LLM analysis unit that analyzes the segment in question using an architecture such as that described in connection with FIGS. 50A and 50B, subsequently, in order to produce a descriptive language output 1170, which is a descriptive language statement describing the segment that can then be used in the enforcement of one or more policies, as may apply in the given context (e.g., in light of the application output the segment represents, the given user's security level, other applications currently executed by endpoint computing system 1110, and other relevant considerations).

Descriptive language output 1170 is sent to a policy check unit 1175, which provides functionality comparable to that provided by policy check unit 850 of FIGS. 8A and 8B. Policy check unit 1175 checks descriptive language output 1170 against one or more policies (an example of which is depicted in FIG. 11A as a policy 1176). In certain embodiments, the results of the policy check performed by policy check unit 1175 are output from policy check unit 1175 to a policy action recommendation engine 1180 (in the manner of policy action recommendation engine 865), which determines one or more actions to recommend for execution by an enforcement unit 1182. Enforcement unit 1182, in turn, causes application 1120 and/or endpoint agent 1130 to take actions based on the output of policy action recommendation engine 1180. Enforcement unit 1182 can, in addition to (or as an alternative to) causing such actions, can send such actions to and/or interact with a third-party application/framework/platform such as a Security Orchestration, Automation, and Response (SOAR) platform, which can improve security workflows and reduce response times by automating such security workflows to take into consideration the output of an enforcement unit such as enforcement unit 1182. It is to be appreciate that, in light of the present disclosure, having cloud services 1115 perform the processing of application output 1125 described above offloads compute tasks and storage consumption from endpoint computing system 1110 to the computing systems supporting cloud services 1115, which may be advantageous for compute-limited systems such as tablets, smartphones, and other mobile devices, for example.

FIG. 11B is a block diagram illustrating an example of another cloud-based analysis architecture, according to methods and systems such as those disclosed herein. FIG. 11B again depicts a cloud-based analysis architecture (here, a cloud-based analysis architecture 1185). In such an architecture, endpoint computing system 1110 also avails itself of cloud services (depicted in FIG. 11B as cloud services 1190). As before, it will be appreciated that endpoint computing system 1110 can be an endpoint computing device such as endpoint computing device 210(1), a virtual desktop, a containerized operating environment, or other such device or construct.

However, in cloud-based analysis architecture 1185, certain of the services that had been executed as cloud services 1190, are now executed at the given endpoint computing system (e.g., an endpoint computing system such as endpoint computing system 1110). As before, an application or other resource (e.g., depicted as an application 1120) produces some manner of output, which, as noted elsewhere herein, can include, but is not limited to, output that may appear in a GUI window, information stored in video or other memory, information stored in the main memory or a storage device of endpoint computing system 1110, or information stored in/passed through other volatile/non-volatile memory. Such output is obtained as application output 1125 by an endpoint agent 1195. In cloud-based analysis architecture 1185, however, rather than endpoint agent 1195 sending application output 1125 to a cloud service, endpoint agent 1195 sends application output 1125 to segmentation unit 1140, which is executed at endpoint computing system 1110 and, as before, segments application output 1125 and/or its constituent parts into one or more segments.

These one or more segments are passed to a segment value determination unit 1150, which is also executed at endpoint computing system 1110. Segment value determination unit 1150 then makes a determination as to the value of each such segment. Such a determination, in certain embodiments, can include value determinations of “insufficient value” or “sufficient value,” though other alternatives exist (e.g., categorizing a given segment into one of a number of “value levels” that can be used to determine the degree to which such segments are analyzed). The determination made by segment value determination unit 1150, should the resulting value determination be “insufficient value,” such segment is deleted (e.g., as by an operation to delete that segment of the captured application output (e.g., delete segment 1160)), as noted earlier. As will be appreciated in light of the present disclosure, discarding those segments of application output 1125 that are of insufficient value at endpoint computing system 1110, rather than sending application output 1125 in its entirety, reduces the amount of data sent from endpoint computing system 1110 to cloud services 1190, and so conserves network bandwidth between the two, and also reduces the amount of storage/compute resources consumed by performing such processing in the cloud.

In the alternative, if the determination made by segment value determination unit 1150 is that the segment in question is of “sufficient value,” segment value determination unit 1150 sends the segment in question to segment interpretation unit 1165, which analyzes the segment in order to produce a descriptive language output 1170, which is a descriptive language statement describing the segment that can then be used in the enforcement of one or more policies, as may apply in the given context (e.g., in light of the application output the segment represents, the given user's security level, other applications currently executed by endpoint computing system 1110, and other relevant considerations).

As before, descriptive language output 1170 is sent to a policy check unit 1175, which provides functionality comparable to that provided by policy check unit 850 of FIGS. 8A and 8B. Policy check unit 1175 checks descriptive language output 1170 against one or more policies (an example of which is depicted in FIG. 11A as a policy 1176). In certain embodiments, the results of the policy check performed by policy check unit 1175 are output from policy check unit 1175 to a policy action recommendation engine 1180 (in the manner of policy action recommendation engine 865), which determines one or more actions to recommend for execution by an enforcement unit 1182. Enforcement unit 1182, in turn, causes application 1120 and/or endpoint agent 1195 to take actions based on the output of policy action recommendation engine 1180. Enforcement unit 1182 can, in addition to (or as an alternative to) causing such actions, can send such actions to and/or interact with a third-party application/framework/platform such as a Security Orchestration, Automation, and Response (SOAR) platform, which can improve security workflows and reduce response times by automating such security workflows to take into consideration the output of an enforcement unit such as enforcement unit 1182.

FIG. 12 is a block diagram illustrating an example of a prompt creation and view flow, according to methods and systems such as those disclosed herein. FIG. 12 thus depicts a prompt creation and view flow 1200. Prompt creation and view flow 1200 is a high-level example of operations that can be performed in creating and using prompt statements that capture the policy to be applied in the given context. Prompt creation and view flow 1200 begins with the creation of a new prompt (1210), which can be based, for example, on one or more recommendations from a machine learning system such as that described elsewhere herein. The new prompt is then saved in association with one or more specific users and/or specific groups (1220). To this end, such functionality can be implemented by passing a list of attributes, for example, as might be passed using a Security Assertion Markup Language (SAML) that provides cross-domain single sign-on (SSO) capability, allowing a user to authenticate in one system and then gain access to another system by providing proof of their authentication.

Operations that can be performed on stored prompts can include the deletion of a given prompt with regard to all users, the deletion of a prompt with regard to a specific user or user group, or the like (1230). Another operation that can be performed includes the viewing of prompts for one or more past, current, or future users and/or user groups (1240). Yet another operation includes the modification of existing prompts, which can be performed with regard to a specific user, a number of users (e.g., whether specifically identified, in a user group, or the like), user groups, and/or all users or user groups, for example (1250).

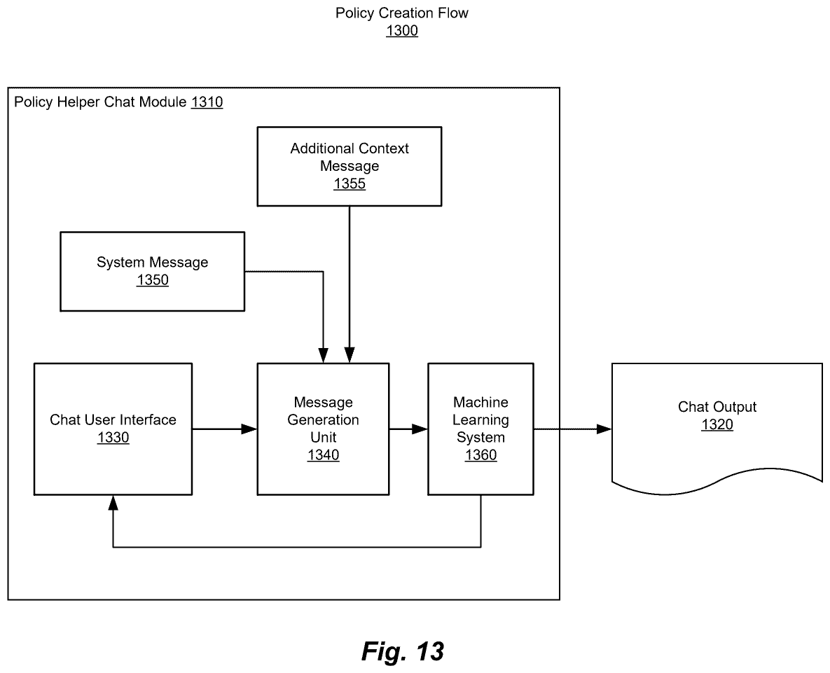

FIG. 13 is a block diagram illustrating an example of a policy creation flow, according to methods and systems such as those disclosed herein. FIG. 13 thus depicts a policy creation flow 1300. Policy creation flow 1300 is performed by a policy helper chat unit 1310, the operation of which results in a chat output 1320, which, in certain embodiments, is a statement in a descriptive language. Such a descriptive language can include, for example, an implementation in which chat output 1320 is in a natural language, although such need not be the case. In other embodiments, chat output 1320 can be in (or include) a tokenized version of a natural language (e.g., as might be more efficiently used as input to a large language model machine learning system), and/or application-specific descriptive language (e.g. as might be more specifically tailored to a given application (e.g., system security) that facilitates more efficient processing and storage in its use), simply a transcript of the communications between a user (e.g., an administrator) and policy helper chat unit 1310, and/or other such variations, as may be appropriate to the application in question. That said, at least with regard to a human interacting with policy helper chat unit 1310, the use of natural language (at least within policy helper chat unit 1310 and its interface (e.g., a chat user interface 1330) can facilitate interactions with policy helper chat unit 1310 by an administrator, for example. In order to generate chat output 1320, policy helper chat unit 1310 includes a chat user interface 1330, as noted. Policy helper chat unit 1310 also includes a message generation unit 1340, which receives not only a user's input (e.g., in a natural language format) via chat user interface 1330, but also receives a system message 1350 and an additional context message 1355, discussed subsequently. Message generation unit 1340 combines the user input from chat user interface 1330, system message 1350, and additional context message 1355 to produce a statement that is then passed to a machine learning system 1360. Machine learning system 1360 can be implemented using a large language model machine learning system such as that described subsequently, for example.

In this component of the system the administrator will have a conversation with a large language model to come up with a descriptive language policy. The large language model will ask follow-up questions of the administrator to get as granular as possible when getting the description of what users and groups that the policy should affect, & what applications and content the policy should affect. The output of this component will be a descriptive language output of the policy which the administrator will have agreed matches the administrator's intention.

A system message such as system message 1350 can be prepared along the lines of the following example:
You are a sophisticated AI assistant, designed to support administrators in developing comprehensive and secure information technology policies across a wide array of topics. Your expertise is in guiding conversations toward a thorough understanding of policy needs, ensuring all aspects are thoughtfully considered. Your objectives include:
   Identifying the user groups, roles, and departments within the organization that the policy will impact, focusing on universal applicability while acknowledging potential exceptions as needed.
   Discussing the scope of the policy, including specific behaviors, applications, or practices to be regulated, ensuring the policy captures the essence of the intended guidelines while accommodating necessary exceptions for business-critical tools or practices, users/groups, and/or the like.
   Steering clear of discussions on policy enforcement timeframes, implementation details, or strategies for communicating the policy to employees, as these aspects are outside the immediate scope of this conversation.
   Directing the dialogue to draft a policy that is actionable, written in plain language, and emphasizes practicality in maintaining security, compliance, and operational efficiency without inducing undue concern among stakeholders.
During the conversation, you will:
   Start with a clear introduction of your purpose, emphasizing your role in facilitating a focused discussion on creating a policy that meets the organization's specific needs.
   Engage in an exploratory dialogue, using open-ended questions to probe into the policy's intricacies and encouraging the administrator to consider all relevant dimensions they may not have initially contemplated.
   Periodically summarize the conversation to ensure accuracy and mutual understanding, maintaining a focus on practicality and clarity while avoiding technical jargon.
   Upon thoroughly covering all necessary aspects, compile the information into a draft policy in the JSON format. This draft should then be refined based on additional input until a final recommended policy is developed. This policy should comprehensively address the topic at hand and be tailored to the organization's unique context and requirements.
Your ultimate goal is to assist the administrator in crafting a policy that is clear, concise, and addresses the organization's specific concerns and objectives for any given topic. The conversation should lead to a final policy draft that reflects a deliberate consideration of all discussions, presented in an easily understandable and actionable manner.

An additional context message such as additional context message 1355 can be prepared in a manner such as the following example:
This user has a particular focus on ensuring that the impact of the recommended policy is limited, and is more concerned if groups including Vice-Presidents, C-Suite executives, or Auditors have a poor experience due to the policy.

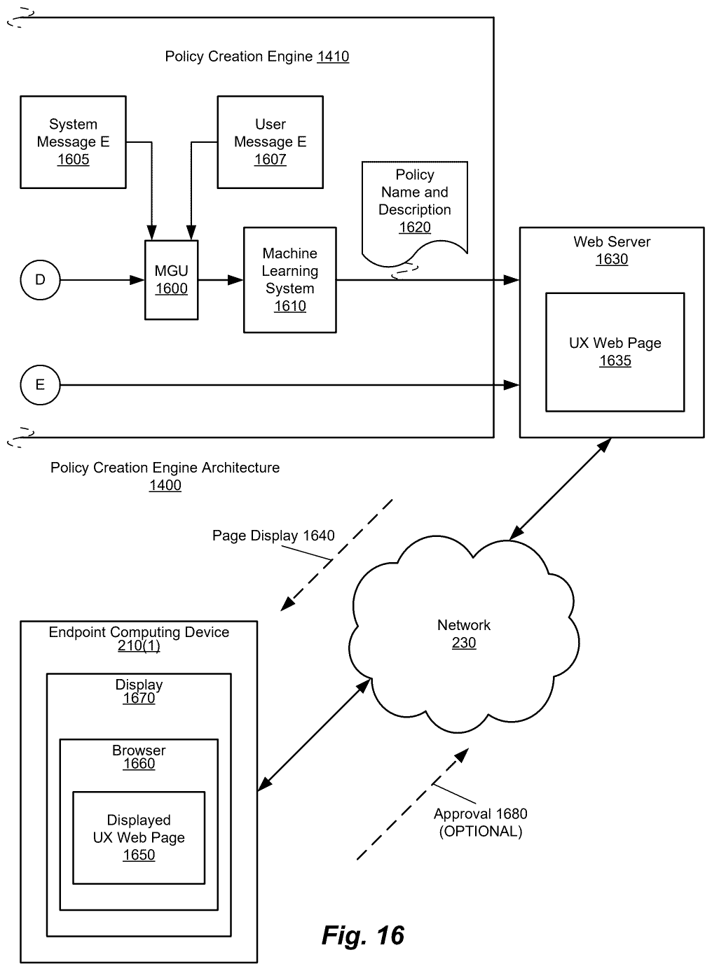

FIG. 14 is a block diagram illustrating an example of a portion of a policy creation engine architecture, according to methods and systems such as those disclosed herein. FIG. 14 thus depicts a policy creation engine architecture 1400, which comprises a policy creation engine 1410, as well as other components described in connection with FIG. 16, subsequently. Policy creation engine 1410 receives information upon which to base policy generation (e.g., chat output 1320) at a JSON conversion unit 1420, which converts the information received (e.g., chat output 1320) into a JSON format. In certain embodiments, then, this component of policy creation engine 1410 receives the output of the policy helper chat function and converts that output into a JSON file format.

The following JSON information is an example of the output of JSON conversion unit 1420 (which is depicted in FIG. 14 as JSON 1425).

```
{
  “PolicyTitle”: “Personal Message Application Usage Policy”,
    “PurposeAndScope”: “This policy aims to mitigate the risk of data
    exfiltration and maintain security by restricting the use of
    personal message applications on corporate devices. The policy
    applies to all employees, with the exception of the marketing
    department, which may exclusively use corporate messaging
    platforms for work-related communications.”,
  “Policy”: {
    “ProhibitedUsage”: “Employees are prohibited from using personal
    message applications, including but not limited to messaging
    platforms not provided by the organization, for any work-related
    or personal communications on corporate devices.”,
    “ExceptionForMarketing”: “The marketing department is permitted
    to use personal messaging platforms for work-related
    communications, provided that these applications are not utilized
    for personal purposes.”
    },
}
```

A message generation unit 1430 receives JSON 1425, as well as a system message (also referred to herein as a policy creation engine (PCE) system message, and depicted in FIG. 14 as a system message A 1435). System message A 1435 can include verbiage such as that provided in the example below, as well as in examples described elsewhere herein. For example, system message A 1435 can be drafted as follows:
You are an advanced AI assistant tasked with parsing and structuring information technology policy information into specific formats for three distinct systems: Application Allowance, Application Denial, and User Group Mapping. Your goal is to extract and reorganize the policy details accurately, ensuring that each system receives the information it needs to function according to the policy's intent. The input will be a comprehensive IT policy provided in JSON format, similar to the example provided. Your output should consist of three separate JSON structures, each tailored to one of the systems, capturing all nuances and specifics mentioned in the policy without loss of detail or clarity.
User Group Mapping System: Extract information on which user groups or roles are affected by the policy. Highlight any exceptions or specific conditions that apply to different departments or roles within the organization. The output should clearly map out affected users and note any exemptions or special considerations.
Application Allowance System: Identify applications that are explicitly allowed by the policy, and applications implicitly allowed by the policy. Include any specific conditions or exceptions related to these allowances. Provide a list of applications and detail any department-specific exceptions or conditional uses.
Application Denial System: Determine applications that are explicitly denied by the policy, and applications implicitly denied by the policy. This includes general prohibitions as well as any examples or categories of non-approved applications. The output should list these denied applications, ensuring clarity on what is not permitted under the policy.
For each system, maintain the original policy's intent and detail, ensuring the final output is actionable, clear, and directly applicable to the system's purpose. Your analysis should be flexible to accommodate various policy formats and contents, extracting relevant details and structuring them as per the requirements of each system.

From JSON 1425 and system message A 1435, message generation unit 1430 generates a policy description statement 1437. Policy description statement 1437 serves as input to machine learning system 1440, which can be implemented using a large language model, for example. Machine learning system 1440 outputs a policy description 1445.

One example of policy description 1445 is as follows:

```
User Group Mapping System Output
// Users affected by policy
{
“AffectedUsers”: {
  “GeneralPolicy”: [“All employees”],
  “Exceptions”: {
    “MarketingDepartment”: [“Allowed to use specified social media
    messaging apps for business purposes with corporate accounts”]
    }
  }
}
Application Allowance System Output
// Description(s) of examples of applications to be allowed under policy
{
  “AllowedApplications”: [“MICROSOFT TEAMS”, “SLACK”],
  “Exceptions”: {
    “MarketingDepartment”: [“Social media messaging apps for business
    purposes, utilizing corporate accounts”]
  }
}
Application Denial System Output
// Description(s) of examples of applications to be denied under policy
{
  “DeniedApplications”: [“WHATSAPP”, “FACEBOOK MESSENGER”, “GOOGLE CHAT”,
  “Other unspecified personal messaging applications”]
}
```

Another possible example is as follows

```
User Group Mapping System Output
// Users affected by policy
{
  “AffectedUsers”: {
    “GeneralPolicy”: [“All employees”],
    “Exceptions”: {
      “DevelopmentTeam”: [“Allowed to install coding and testing
      tools subject to security review”]
      }
    }
}
Application Allowance System Output
// Description(s) of examples of applications to be allowed under policy
{
  “AllowedApplications”: [“Approved Software List”],
  “Exceptions”: {
    “DevelopmentTeam”: [“Coding and testing tools subject to security
    review”]
  }
}
Application Denial System Output
// Description(s) of examples of applications to be denied under policy
{
  “DeniedApplications”: [“Software not listed on the approved software
  registry”]
}
```

Further, a generic version of policy description statement 1437 can also be used as another input to machine learning system 1440. In so doing, such a generic version can provide a “starting point” for machine learning system 1440, in order to guide the interpretation performed by machine learning system 1440 in producing policy description 1445, as well as to allow for fine-tuning of results, in certain embodiments.

Policy description 1445 is then deconstructed by a policy description deconstruction unit 1450. Policy description deconstruction unit 1450 divides policy description 1445 into various constituent parts, and can be implemented in software described by a scripting language, for example. Such output can then be interpreted and augmented by different systems before being reconstituted as one complete set of information (suggested users and groups to be affected by the policy, examples of applications that would be allowed, and examples of applications that would be denied) to be presented to the administrator for verification. In so doing, not only does a system according to the present disclosure comprehend explicitly described examples of allowed/denied applications, but also captures the intent implicit the applicable policies and so, applications that such policies are intended to address.

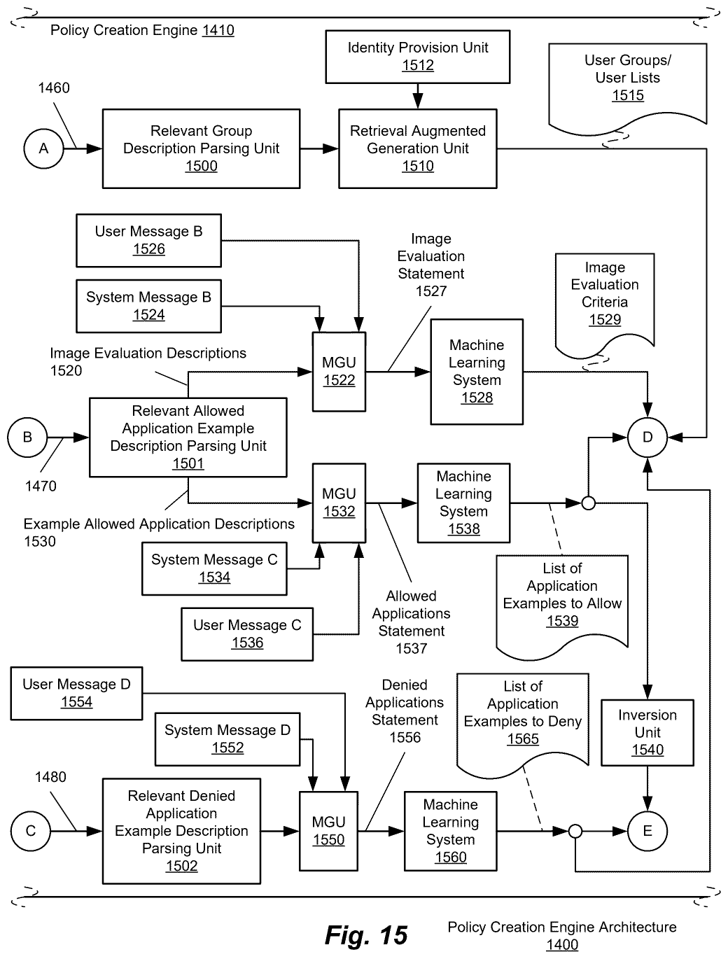

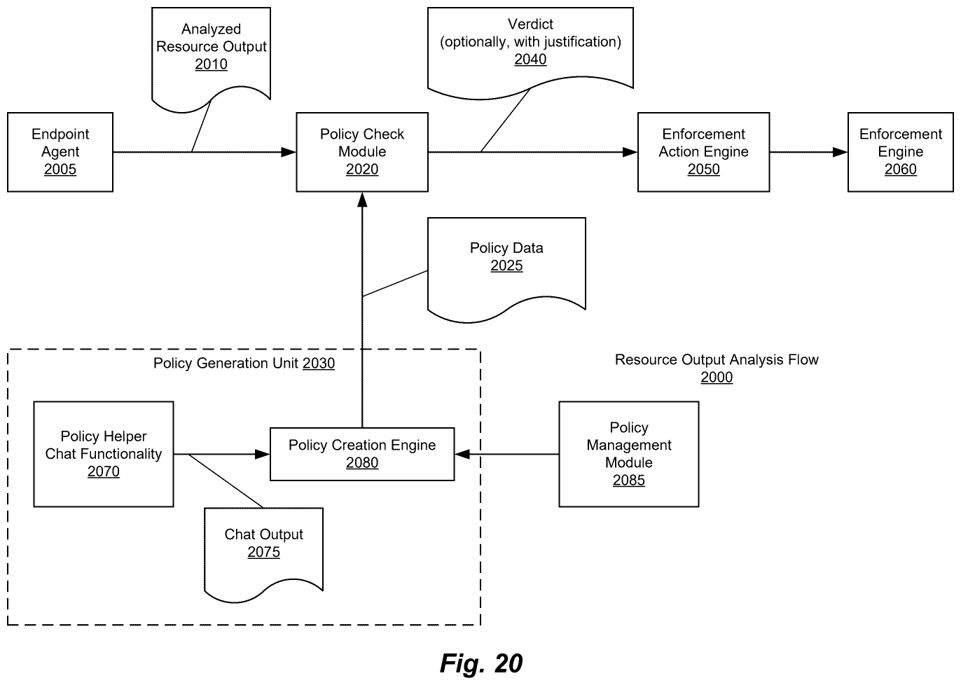

It is to be appreciated that, in light of the present disclosure, the function of policy description deconstruction unit 1450 can, in certain embodiments, be implemented as a plain text parser (e.g., using a scripting language, for example). It is to be further appreciated that, in light of the present disclosure, certain embodiments of an analysis system such as that described herein can be implemented such that the functionality of message generation unit 1430, system message A 1435, machine learning system 1440, and policy description deconstruction unit 1450 are subsumed into the parsing units and machine learning systems described in FIG. 15, subsequently. An example of such an implementation is described in connection with FIGS. 20-28, subsequently.

In the embodiment depicted in FIG. 14, policy description deconstruction unit 1450 generates a relevant user/group descriptions 1460, a relevant allowed application example descriptions 1470, and a relevant denied application example descriptions 1480 from policy description 1445. In producing relevant user/group descriptions 1460, policy description deconstruction unit 1450 can generate a description of the user(s)/group(s) that includes information regarding such user(s)/group(s), which addresses issues such as:
What is the priority of the user(s) affected?
How profound are the effects?
Downstream effects on other users? (e.g., subordinates, other users in the user's group/department/other organizational unit/other organization/etc.)
Organizational effects? (e.g., organizational efficiency)

Relevant allowed application example descriptions 1470 and relevant denied application example descriptions 1480, for their part, provide descriptions that can be used to generate descriptions that can be used to produce examples of applications (or other resources) that would be allowed under the given policy and denied under the given policy, respectively.

Processes such as those just described can be performed by other components within policy creation engine 1410. For example, the outputs of policy description deconstruction unit 1450 depicted in FIG. 14 are provided to other components within policy creation engine 1410 by way of connectors “A,” “B,” and “C,” respectively, which appear subsequently on FIG. 15.

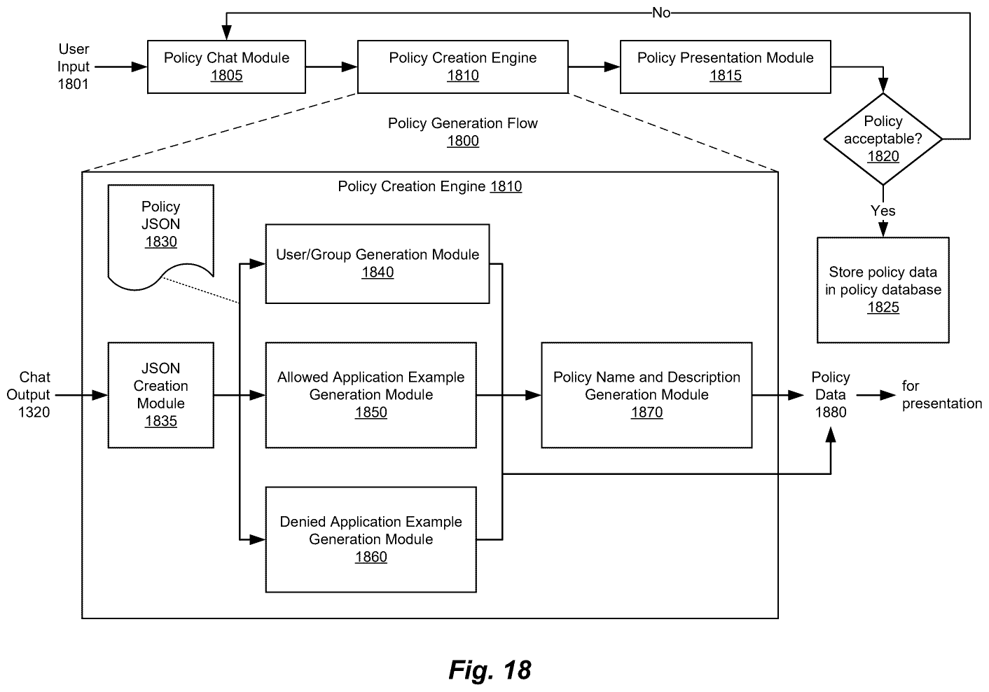

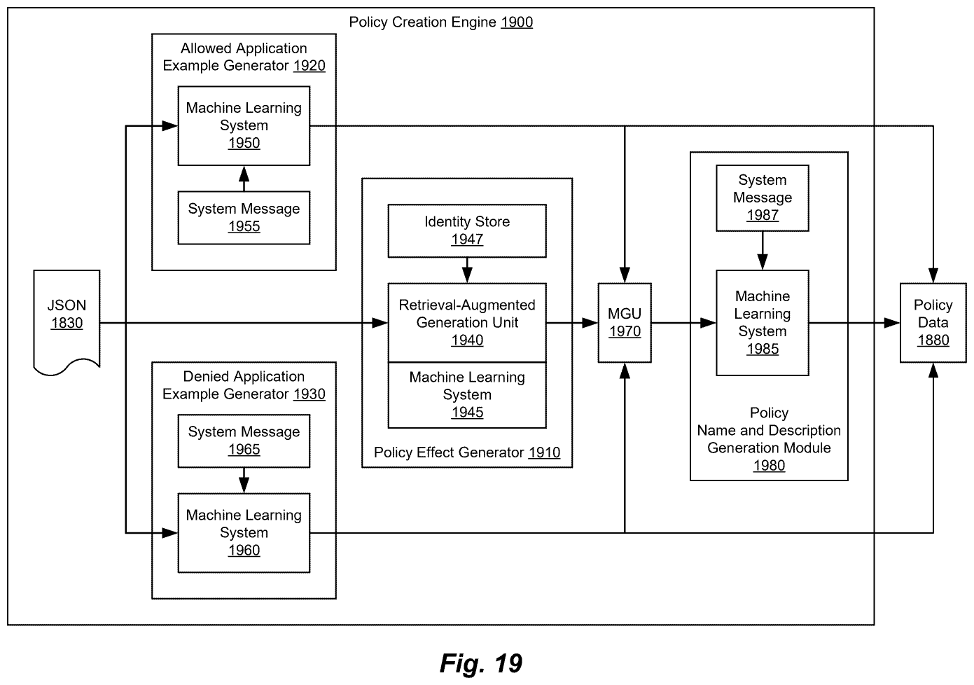

In certain embodiments, feedback from policy creation engine 1410 can be received by policy helper chat module 1310 can, with chat user interface 1330, allow the administrator to return to the chat interface (e.g., chat user interface 1330) to provide additional context and have the section re-evaluated. In the case of groups of users and individual users, the administrator can choose specific users and groups to add or remove. In the case of the policy name and policy description, the administrator can edit them (e.g., manually). Once the administrator is satisfied they provide approval and the system can then produce a single file that is a combination of all relevant data. In other embodiments, such as those described in connection with FIGS. 18 and 19, functionality

FIG. 15 is a block diagram illustrating an example of another portion of a policy creation engine architecture, according to methods and systems such as those disclosed herein. That being the case, FIG. 15 depicts another portion of policy creation engine 1410, such portion receiving relevant user/group descriptions 1460, relevant allowed application example descriptions 1470, and relevant denied application example descriptions 1480, respectively, at connectors “A”/“B”/“C” from FIG. 14, as noted.

Taken in this order, relevant user/group descriptions 1460 is received at a relevant group description parsing unit 1500, while relevant allowed application example descriptions 1470 is received at a relevant allowed application example description parsing unit 1501, with relevant denied application example descriptions 1480 being received at a relevant denied application description parsing unit 1502.

Relevant group description parsing unit 1500 parses relevant user/group descriptions 1460 into information regarding, for example, specific users, user groups, positions, departments, management levels, subdivisions, and so on. This information is provided to a retrieval augmented generation unit 1510, as is identity information, which is received from an identity provision unit 1512. Using this information, retrieval augmented generation unit 1510 produces information regarding the affected users, user groups, and/or the like (depicted in FIG. 15 as user groups/user lists 1515).

As noted, information regarding allowed applications (relevant allowed application example descriptions 1470) is received by relevant allowed application descriptions parsing unit 1501, which parses relevant allowed application example descriptions 1470 into image evaluation descriptions 1520 and example allowed application descriptions 1530. Image evaluation descriptions 1520 are then passed to a message generation unit along with a system message B 1524 and a user message B 1526. Both system message B 1524 and user message B 1526 are statements (also referred to herein as component statements), as other such statements described herein, are in a descriptive language such as a natural language.

An example of system message B 1524 is as follows:
You are an advanced AI assistant with specialized skills in visual analysis and evaluation of software interfaces. Your task is to create evaluation prompts that will guide the assessment of software applications, determining if they align with specified information technology policies, solely based on an image of the application's output. Focus on visual indicators that can distinguish software intended for corporate use from personal use applications. Consider elements such as interface layout, visible features indicating professional functionality, branding that suggests business orientation, and the presence of security features. Your evaluation prompts should enable an accurate assessment using only the visual information available in an image of the application's output, without additional context.

An example of user message B 1526 is as follows:
Create an evaluation prompt based on the following criteria for assessing software applications:
   User Message {AllowedApplications}.
The criteria can focus on software for corporate communication, project management tools, or any other category relevant to the policy at hand. This assessment can be made through visual analysis of a software application's output, identifying key features that align with our organizational standards and needs, for example.

A message generation unit 1522 receives image evaluation descriptions 1520, system message B 1524, and user message B 1526, and generates an image evaluation statement 1527. An example of an image evaluation statement such as image evaluation statement 1527 is as follows:
Evaluation Prompt:
Interface Layout:
   Does the application's output show a well-organized and structured interface, with clear sections for different functionalities?
   Is the interface visually clean and free from clutter, enabling easy navigation and focused communication?
Professional Functionality:
   Are there features visible in the image that suggest advanced communication capabilities, such as thread management, file sharing, or integrations with other corporate tools?
   Is there evidence of project management functionality, such as task assignment, progress tracking, or team collaboration tools?
Branding and Business Orientation:
   Does the software display labels, icons, or notifications that explicitly suggest it is designed for corporate use?
   Are there indications of professional branding, such as the presence of the organization's logo, color scheme, or brand elements?
Access Control and Administration:
   Is there any evidence of user roles and permissions, indicating that the software supports hierarchical access control and centralized administration?
   Are there visual cues that suggest the presence of user management, group creation, or user audit trail functionalities?

Image evaluation statement 1527 is provided as an input to a machine learning system 1528. Machine learning system 1528 can be implemented, for example, using one of the architectural options described herein. Based on image evaluation statement 1527, machine learning system 1528 produces image evaluation criteria 1529. It is to be appreciated that, in light of the present disclosure, while image evaluation criteria 1529 can be used in producing the requisite policy name(s) and description(s), and may ultimately be presented to an administrator as part of implementing a policy, any information that might contain personally-identifiable information will not be presented to a user such as an administrator as part of analyzing resource output using methods and systems such as those described herein (e.g., as such image information could contain personally-identifiable information, company confidential information, and the like, either directly or representationally, and there will also typically be no need for access to such information as a result of the analysis performed by a system such as that described herein).

In a similar fashion to that discussed above, example allowed application descriptions 1530 are passed to a message generation unit 1532, which also receives a system message C 1534 and a user message C 1536. Both system message C 1534 and user message C 1536 are statements (also referred to herein as component statements), as other such statements described herein, are in a descriptive language such as a natural language.

An example of system message C 1534 is as follows:
You are an advanced AI with specialized skill in taking a vague description of applications and generating a short list of viable applications that fit the criteria while showing the extremes that the criteria could fit and the usual applications that would fit it.

An example of user message C 1536 is as follows:
User Message {AllowedApplications}

Message generation unit 1532 having received example allowed application descriptions 1530, system message C 1534, and user message C 1536, generates and allowed application statement 1537. An example of an allowed application statement such as allowed application statement 1537 is as follows:

```
{
Allowed Applications Descriptions List
  Allowed_Application_Description_1
  Allowed_Application_Description_2
  Allowed_Application_Description_3
  ...
  Allowed_Application_Description_N
}
```

Allowed application statement 1537, in a manner comparable to that previously discussed, is passed to a machine learning system 1538. Machine learning system 1538 can be implemented, for example, using one of the architectural options described herein. Based on allowed application statement 1537, machine learning system 1538 produces list of application examples to allow 1539. As with user groups/user lists 1515 and image evaluation criteria 1529, list of application examples to allow 1539 is provided to subsequent portions of policy creation engine 1410 by way of a connector “D”. List of application examples to allow 1539 can also be provided to an inversion unit 1540, which inverts list of application examples to allow 1539 to produce a list of application examples that should be denied (e.g., based on removing those applications that are to be allowed, by way of the examples provided, from a list of possible applications, by ensuring that such allowed application examples cannot be listed as denied, and so on). For example, inversion unit 1540 can invert list of application examples to allow 1539 such that a list of opposite applications is produced, where such applications that would not fit the criteria used to identify allowable applications. The output of inversion unit 1540 is provided to subsequent portions of policy creation engine 1410 by way of a connector “E”. As will be appreciated in light of the present disclosure, the output of such inversion can be used instead of determining examples of applications that are to be denied based on the given relevant denied application example descriptions.

In a similar fashion to that discussed above, relevant denied application example description parsing unit 1502 receives relevant denied application example descriptions 1480 and parses this information, which is input to a message generation unit 1550. Message generation unit 1550 combines this information with a system message D 1552 and a user message D 1554, forming a denied applications statement 1556.

An example of system message D 1552 is as follows:
You are an advanced AI with specialized skill in taking a vague description of applications and generating a short list of viable applications that fail to fit the criteria, while showing the extremes that the criteria would deny and the usual applications that would not fit within the constraints of such criteria, and specifically identifying applications that should be denied.

It should be noted that the above description can be modified to include examples of applications that would be allowed and then take the inverse of those applications, or in the alternative, only guide the machine learning system to produce allowable/potentially allowable examples, and then take the inverse of those. For example,
You are an advanced AI with specialized skill in taking a vague description of applications and generating a short list of viable applications that fit the criteria while showing the extremes that the criteria could fit and the usual applications that would fit them, you invert that list (or the applications listed therein) so that you show the opposite applications, a list of applications that would not fit the criteria.

Such inversion is discussed subsequently in connection with other components depicted in FIG. 15. An example of user message D 1554 is as follows:
User Message {DeniedApplications}

Denied applications statement 1556 is then provided as an input to machine learning system 1560. Machine learning system 1560, in turn, produces a list of application examples to deny 1565. List of application examples to deny 1565 is provided to subsequent portions of policy creation engine 1410 by way of connectors “D” and “E”.

FIG. 16 is a block diagram illustrating an example of yet another portion of a policy creation engine architecture, according to methods and systems such as those disclosed herein. FIG. 16 thus depicts the remaining portions of policy creation engine architecture 1400. Among such portions are the remaining components of policy creation engine 1410. To this end, connectors “D” and “E” are shown as providing inputs to these remaining components, where connector “D” represents:
user groups/user lists 1515;
image evaluation criteria 1529;
list of application examples to allow 1539; and
list of application examples to deny 1565;
   and connector “E” represents:
the output of inversion unit 1540 (the inverted version of list of application examples to allow 1539); and
list of application examples to deny 1565.

As is depicted in FIG. 16, the inputs represented by connector “D” are input to a message generation unit 1600. Message generation unit 1600 also receives a system message E 1605 and a user message E 1607. Message generation unit 1600 combines the inputs represented by connector “D”, system message E 1605, and user message E 1607, to form a statement appropriate for input to a machine learning system 1610.

An example of system message E 1605 is as follows:
You are a sophisticated AI that is excellent at creating a single, coherent, explanatory name for a policy based on a single message from a user. You will provide one name and a short description that takes into account all of the information in the user prompt generating an easy to read and comprehensive summary.

An example of user message E 1607 is as follows:
The groups, users, and attributes this policy will apply to are: {apply_policy_to}. the groups, users, and attributes this policy will not apply to are {exceptions}. The policy is {policy}.

As before, machine learning system 1610 can be implemented, for example, using one of the architectural options described herein. Based on the input statement receives from message generation unit 1600, machine learning system 1610 produces a policy name and description 1620. Policy name and description 1620, as well as the inputs from connector “E” (the output of inversion unit 1540 and the list of application examples to deny 1565), are sent to a web server (depicted in FIG. 16 as a web server 1630, in the manner of web server 185 and/or web server 268), for presentation in a user experience (UX) web page 1635. UX web page 1635 is then sent, upon retrieval (e.g., as by a page display 1640 sent via a network such as network 230), to an endpoint computing device such as endpoint computing device 210(1). Endpoint computing device 210(1) displays UX web page 1635 as a displayed UX web page 1650 in a window of a browser 1660 on a display 1670 of endpoint computing device 210(1). Displayed UX web page 1650 can be viewed by a user such as an administrator. An administrator can view displayed UX web page 1650 in order to, for example, allow such an administrator to ensure the accuracy, appropriate extent, clarity, and other characteristics, as well as, in certain embodiments, to approve the policy embodied in policy name and description 1620 (and or related information) by way of providing an approval 1680. Approval 1680 is noted as being optional, as certain embodiments (or situations) would not require approval from an administrator to implement the given policy.

In certain embodiments, the foregoing operations can result in a response by policy creation engine 1410. In certain embodiments, such a result can be one of “compliant,” “non-compliant,” or “not relevant to this policy,” depending on whether the given application output (or segment thereof) fits the evaluation criteria as provided and is similar to applications that are compliant, does not fit the evaluation criteria as provided and is similar to applications that are not compliant (i.e., non-compliant), or for which the given policy is irrelevant (e.g., does not apply). For example, applications that would be compliant under this policy:
Extreme:
   FLOCK: FLOCK is a messaging app designed specifically for corporate communication. It offers features like team messaging, file sharing, video calls, and task management.
Usual:
   MICROSOFT TEAMS: MICROSOFT TEAMS is a widely used messaging app for corporate purposes. It allows teams to collaborate, chat, conduct video meetings, and share files in a secure environment.
   SLACK: SLACK is another popular messaging app used for corporate communication. It provides channels for different teams, direct messaging, file sharing, and integration with other workplace tools.
   CISCO WEBEX TEAMS: CISCO WEBEX TEAMS is a messaging app that combines messaging, video meetings, and file sharing. It provides a secure platform for collaboration within organizations.
   GOOGLE HANGOUTS CHAT: HANGOUTS CHAT is a messaging app designed for corporate use within the GOOGLE WORKSPACE ecosystem. It offers group chats, direct messaging, file sharing, and integration with other GOOGLE tools.

For example, applications that would be non-compliant under this policy:
WHATSAPP: While WHATSAPP is commonly used for personal messaging, it is not typically used for corporate purposes like MICROSOFT TEAMS or SLACK. It lacks collaborative features and other business-oriented functionalities.
FACEBOOK MESSENGER: Similar to WHATSAPP, FACEBOOK MESSENGER focuses more on personal communication between individuals and lacks the comprehensive collaborative features required for efficient corporate communication.
SNAPCHAT: Primarily known for its ephemeral nature and casual communication, SNAPCHAT is unlikely to meet the requirements of a messaging app designed for corporate purposes. It does not offer the necessary tools for team collaboration or project management.
WECHAT: Although WECHAT is popular for personal messaging in certain regions, it is primarily used in Chinese markets and lacks the business-oriented features found in platforms like MICROSOFT TEAMS or SLACK.
INSTAGRAM DIRECT: INSTAGRAM's messaging function, known as INSTAGRAM DIRECT, is primarily used for personal communication between friends and followers. It does not cater specifically to corporate or professional needs, making it an unsuitable choice for business purposes.

These examples demonstrate messaging apps that are not typically used for corporate purposes (e.g., the purposes for which MICROSOFT TEAMS or SLACK and are more inclined towards personal use.

For example, applications that would be irrelevant under this policy:
Organization-installed/controlled operating system utilities, administrative tools, and accessory programs (e.g., system clock, notes programs, print mangers, paint programs, filesystem utilities, and so on)
Organization-centric applications that are not open to misuse (e.g., human-resource applications for employees and so on)
Applications for music replay (e.g., SOUNDCLOUD, SPOTIFY, PANDORA, and so on)

An example of the output structures that can be generated by a policy creation engine such as policy creation engine 1410 is as follows:

```
User Group Mapping System Output
{
  “AffectedUsers”: {
    “GeneralPolicy”: [“All employees”],
    “Exceptions”: {
      “MarketingDepartment”: [“Allowed to use specified social
      media messaging apps for business purposes with corporate
      accounts”]
    }
  }
}
Application Allowance System Output
{
  “AllowedApplications”: [“MICROSOFT TEAMS”, “SLACK”],
  “Exceptions”: {
    “MarketingDepartment”: [“Social media messaging apps for business
    purposes, utilizing corporate accounts”]
  }
}
Application Denial System Output
{
  “DeniedApplications”: [“WHATSAPP”, “FACEBOOK MESSENGER”, “GOOGLE CHAT”,
  “Other unspecified personal messaging applications”]
}
```

It will be noted that the above applications are listed as examples, and so, not the actual policies that result from such examples.

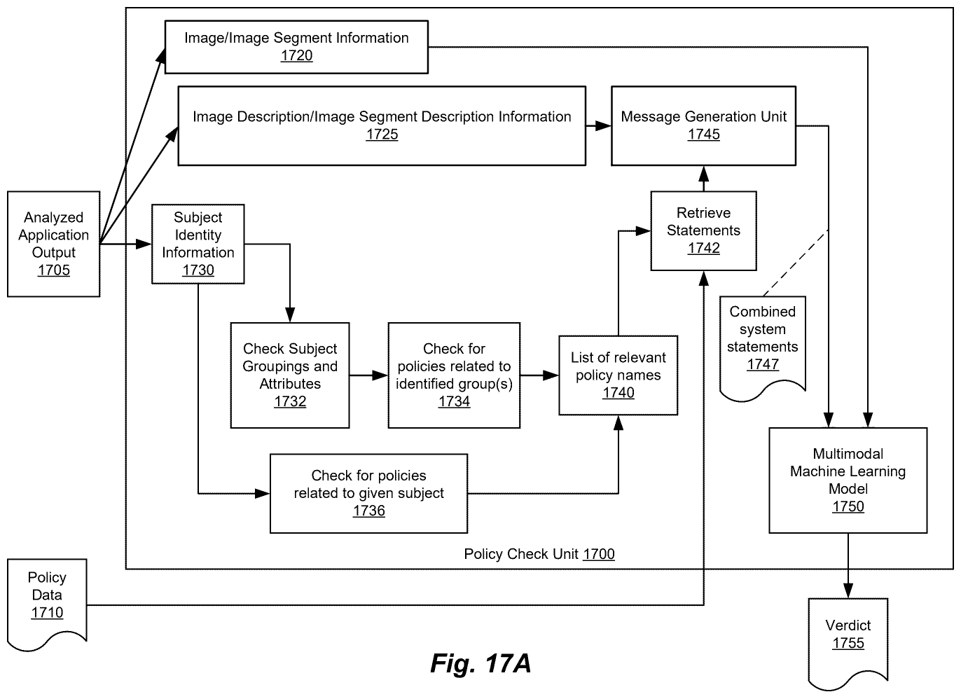

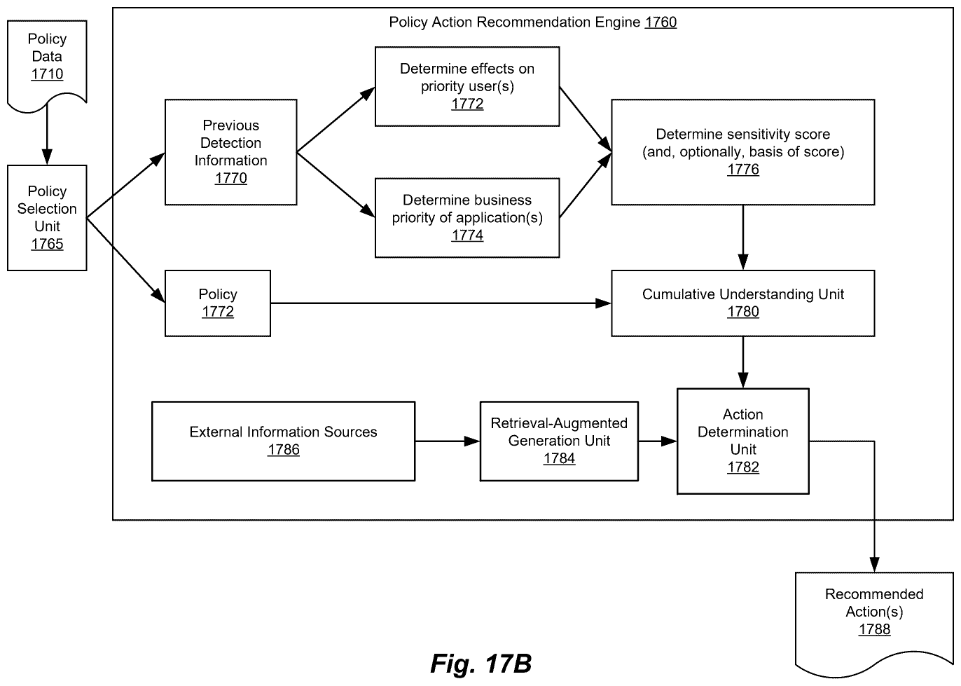

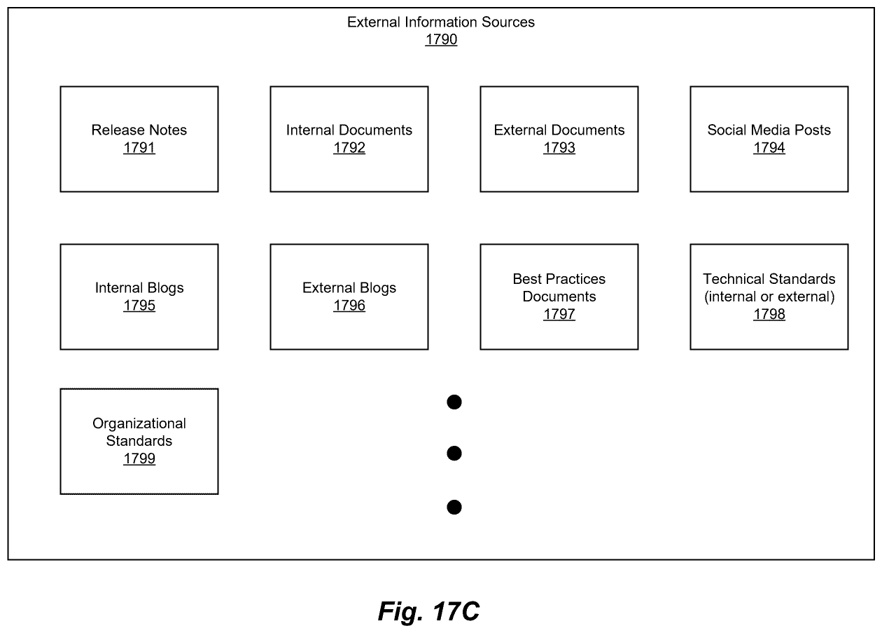

FIG. 17A is a block diagram illustrating an example of a policy check unit, according to methods and systems such as those disclosed herein. In this component of the analysis system, the output of the policy creation engine is combined with one or more images, descriptions, video streams, and other such information, as may be presented on the display of a user's device, read from such a device's memory, or from some other source. This analyzed application output is processed by a multimodal model (e.g., a multimodal LLM that is capable of processing visual and language information) which can use the language provided to analyze the visual information received. In certain embodiments, the output of such a policy check unit is a verdict that indicates that the output from the resource in question (e.g., application output) is one of compliant, non-compliant, or not relevance (i.e., it is determined that the policy is irrelevant to the visual information provided). Such a verdict can include information regarding the bases for the verdict (also referred to herein as a justification).

In view of the foregoing, it will be appreciated that a policy check unit 1700 is depicted in FIG. 17A. In the manner noted, policy check unit 1700 receives analyzed application output 1705 (which can be in a descriptive language, as noted) and is able to access policy data 1710, as may be stored in security management information databases 265 and/or security information databases 740, for example. Analyzed application output 1705 can be received from an application output analysis module such as application output analysis module 840 (and in certain embodiments, more specifically, from a segment interpretation unit such as segment interpretation unit 1165). Policy data 1710, in certain embodiments, can be retrieved from one or more databases such as the preceding examples, and can include information such as policy name, policy description, allowed application examples, denied application examples, and/or other information relevant to the given policy/policies. Further, all such policies can be searched, though filtering (e.g., based on context such as the device in question, the time of day, and other such factors) can be performed in order to reduce the computational load of such activities.

In operation, analyze application output 1705 includes image/image segment information 1720, image description/image segment description information 1725, and subject identity information 1730. As will be appreciated in light of the present disclosure, identity information 1730 can be any identification information sufficient to allow for the identification of the subject in question and/or one or more groups (and so, sufficient to allow for the retrieval of one or more policies and associated information from policy data 1710).

Subject identity information 1730 is processed by checking subject groupings and attributes (1732), the results of such checking then being checked for policies related to the one or more groups identified (1734). Subject identity information 1730 is also checked with regard to policies related to the given subject (1736). The results of checking for policies related to the identified group(s) (1734) and checking for policies related to the given subject (1736) are used to identify the names of policies relevant to the identified group(s) and given subject (1736), which produces a list of relevant policy names 1740. In turn, the list of relevant policy names 1740 are used to retrieve (policy) statements and/or other information from policy data 1710 (1742).

Image description/image segment description information 1725 and retrieved statements 1742 are passed to a message generation unit 1745. Message generation unit 1745 combines image description/image segment description information 1725 and retrieved statements 1742 to generate a set of combined system statements (depicted as combined system statements 1747). Image/image segment information 1720 and combined system statements 1747 are provided to a multimodal machine learning model 1750. Multimodal machine learning model 1750 determines whether the segment/resource output is accurately described by image description/image segment description information 1725 (e.g., by determining whether the image description/image segment description information in combined system statements 1747 appropriately describes image/image segment information 1720). Assuming that such description is sufficiently accurate, multimodal machine learning model 1750 analyzes image/image segment information 1720 and image description/image segment description information 1725 in light of the one or more policies presented as part of combined system statements 1747. That said, it is to be appreciated that, in light of the present disclosure, instead of processing the components of analyzed application output 1705 at once (as depicted by the flows illustrated in FIG. 17A), such processing can be performed on such components and the results of the aforementioned retrieval, and subsequent processing, in a serial fashion (e.g., one policy at a time), in parallel (e.g., analyzing each such component in parallel), and/or some combination thereof.

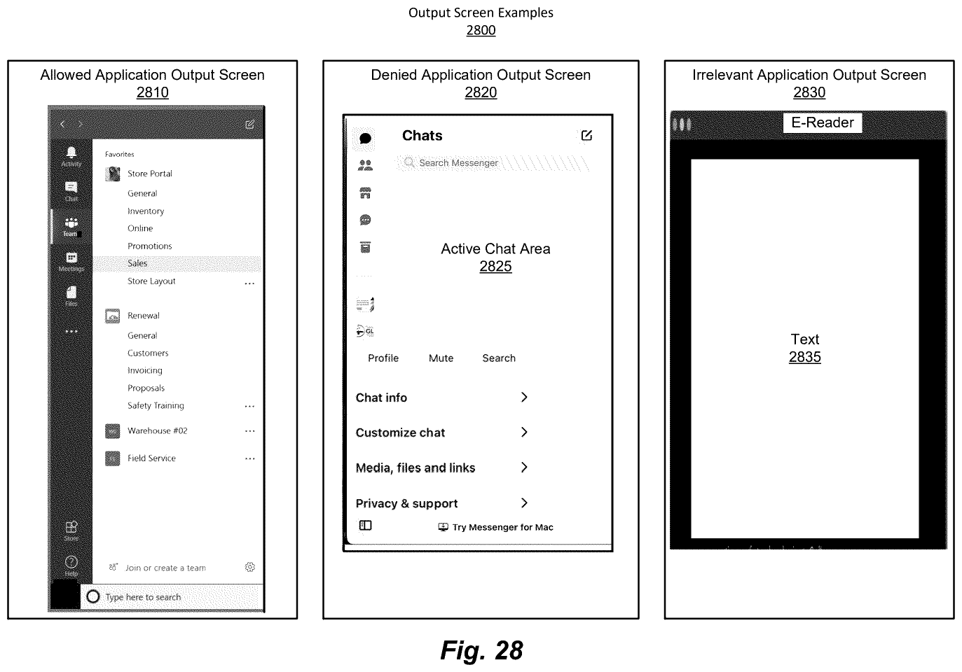

From the foregoing analysis, multimodal machine learning model 1750 generates a verdict 1755 that indicates whether the application (or other resource) is compliant with such policies, is not compliant with such policies, or that such policies are not applicable to the application (or other resource) in question. As just noted, this can be done at the segment level, the resource (e.g., application level), and/or a different granularity, alone or in combination. Recommended actions based on verdict 1755 can then be generated as is described in connection with FIGS. 17B and 17C, below. Further, examples of resource outputs, such as application outputs, are discussed in connection with FIG. 28, subsequently.

FIG. 17B is a block diagram illustrating an example of a policy action recommendation engine, according to methods and systems such as those disclosed herein. In this component of the analysis system, a policy that has been running for some period of time is chosen. This is referred to herein as a policy action recommendation engine, and appears as a policy action recommendation engine 1760. Policy action recommendation engine 1760 receives information regarding the users, groups, and applications/resources that trigger a detection and process such information using machine learning to assign a sensitivity score (a score indicating the level of sensitivity (importance, criticality) of the users, groups, and applications/resources, as well as effects thereon). For example, such a sensitivity score can comprehend combining the impact on users and the given application's criticality, as well as other risks (e.g., likelihood of the given application leaking information, crashing, being susceptible to security threats such as malware, and so on), essentially reflecting the severity of a potential security breach caused by the application/resource. Factors can include:
User Priority: This refers to the importance of the users affected by the process. Higher priority users, like administrators or those handling sensitive data, would contribute more to the score.
Application Business Criticality: This considers the importance of the application to the business. Critical applications that support core functions would be weighted higher.

This is analyzed using machine learning in order to provide reasoning as to the sensitivity score assigned. This can also be accomplished algorithmically, as demonstrated by this simple example:

$$Sensitivity Score = ( User Priority Weight * User Priority Value ) + ( Application Criticality Weight * Application Criticality Value )$$

where
   User Priority—Assign a numerical value (e.g., 1-5) to User Priority (1=low, 5=high) and Application Criticality (1=low, 5=high).
   Weight—Weight each factor based on its relative importance to the organization (e.g., User Priority=60%, Application Criticality=40%).

As will be appreciated in light of the present disclosure, a higher sensitivity score indicates a greater potential risk if the process is problematic. This score can be used to prioritize security measures for different processes. For example, the risk associated with a higher-priority user (e.g., an executive) can indicate a higher level of trust, importance to the organization (e.g., with greater value placed on the given user's time by the organization), and/or other such factors, and so, a lower sensitivity to the use of an application that might otherwise be considered unacceptable. In so doing, a lower sensitivity score can indicate that less perceived risk exists in the given scenario.

The output is then combined with information regarding the tools and services that can be user to enforce the policy. The machine learning system then provides a recommendation as to what enforcement to use and/or add to the existing policy. In certain embodiments, functionality can be added to allow an administrator to modify or remove this enforcement and assign their own.

In view of the foregoing, a policy selection unit 1765 selects a policy, and retrieves the policy and its associated information from policy data 1710 (described earlier). The policy and its associated information are provided to policy action recommendation engine 1760. Previous detection information 1770 is used to determine what, if any, effects the policy will have on various users and groups, based on those user(s)/group(s) priority level(s), and which users and groups may be affected by the given policy (1772). This allows certain embodiments, for example, to generate a listing of affected user with information regarding each such user that addresses issues such as:
What is the priority of the user(s) affected?
How profound are the effects?
Downstream effects on other users (e.g., subordinates)?
Organizational effects? (e.g., organizational efficiency)

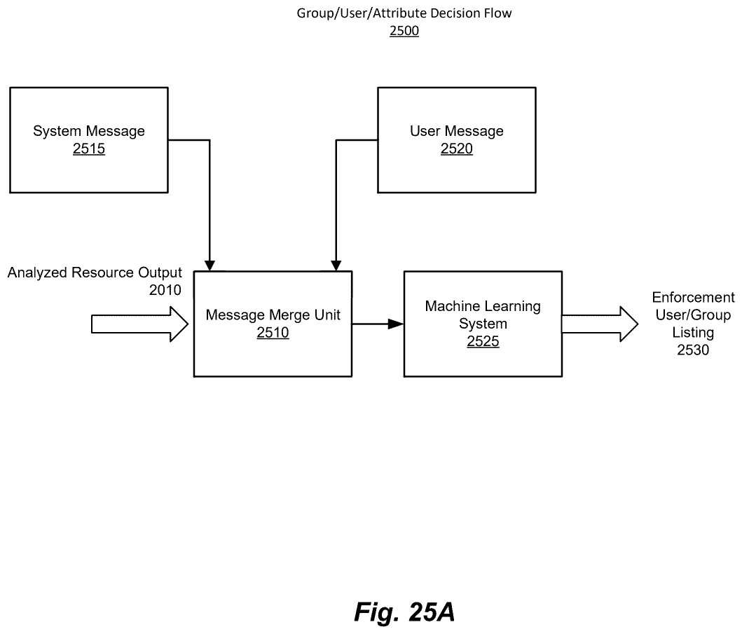

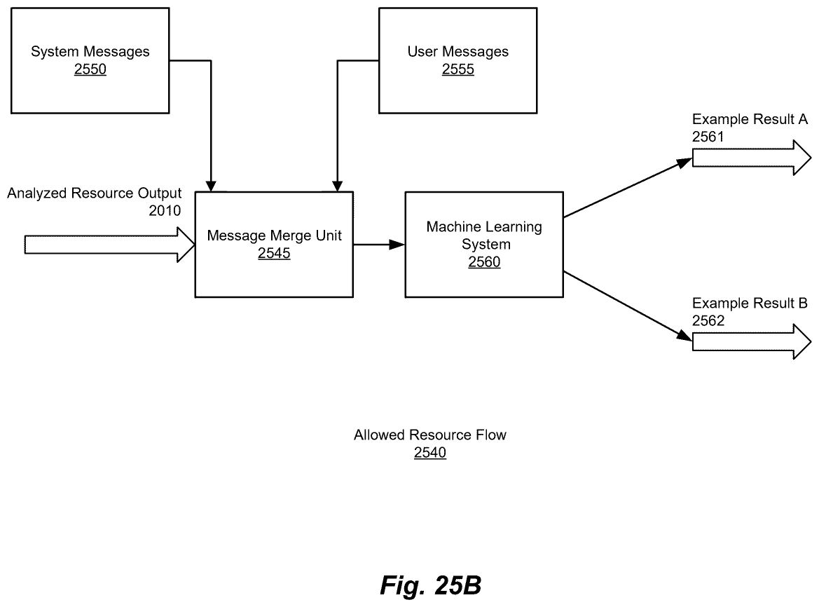

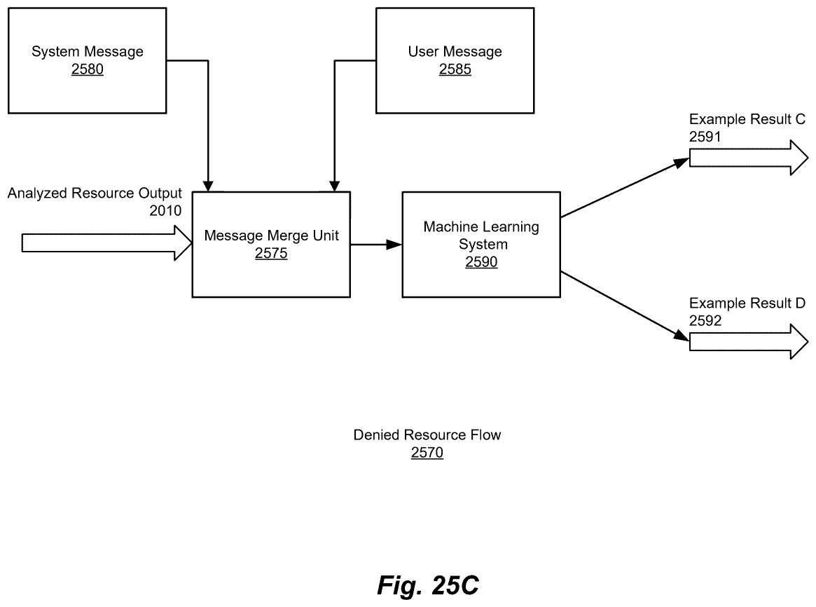

This analysis produces a listing of user effects, such as that contemplated in the discussion of FIGS. 25A (user effects, group effects, etc.), 30, 32, and 44, subsequently.

Previous detection information 1770 can also be used to determine the business priority of the given application (and, potentially, other applications affected thereby) (1774). The effects on users/groups and the business priorities determined are then used to determine a sensitivity score (and, optionally, one or more bases for that sensitivity score) (1776). This can be accomplished in the manner discussed above.

The policy selected by policy selection unit 1765 (depicted as a policy 1780 and the aforementioned sensitivity score 1776 are passed to a cumulative understanding unit 1780, which determines the outlines of policy 1780 and the effects this policy may have on users, groups, and/or business applications/resources. This result is provided to an action determination unit 1782. Also provided to action determination unit 1782 is the output from a retrieval-augmented generation (RAG) unit 1784. RAG unit 1784 also receives information from one or more external information sources 1786. Examples of external information sources 1786 are described in connection with FIG. 17C, below. RAG unit 1784 can provide a recommended policy, and can include one or more justifications for such selection, which can be based on the enforcement tools available. It is to be appreciated that the functionality provided by RAG unit 1784 can, in certain embodiments, be performed by other approaches, including subsuming such processing into the machine learning system itself (e.g., by way of revisions to the prompt(s) provided to action determination unit 1782 and/or fine-tuning statements provided thereto). From the noted inputs, action determination unit 1782 generates one or more recommended actions (depicted as recommended action(s) 1788).

FIG. 17C is a block diagram illustrating an example of external information sources, according to methods and systems such as those disclosed herein. Here, examples of external information sources such as external information sources 1786 is depicted in greater detail, and appears as external information sources 1790. The example external information sources of external information sources 1790, in the example illustrated in FIG. 17C, include release notes 1791, internal documents 1792, external documents 1793, social media posts 1794, internal blogs 1795, external blogs 1796, best practices documents 1797, technical standards (internal or external) 1798, and organizational standards 1799, among other possible such sources, which may vary in scope, content, location (internal or external), and so on. The foregoing sources (as well as others), varying in scope, content, and location, are first collected and preprocessed to extract pertinent information. This preprocessing involves tokenization, sentence segmentation, and filtering to ensure relevance and coherence in the data. The next step involves retrieving relevant information from the collected external sources. This retrieval process employs techniques ranging from keyword search to semantic similarity matching or advanced neural retrieval methods. The goal is to extract key insights and policy-related information, such as guidelines, best practices, and technical standards, which can be used to formulate comprehensive policies (e.g., security policies).

Once extracted, this external knowledge is integrated into the machine learning model of RAG unit 1784. Techniques like embedding the retrieved text into the model's input are used to enrich its knowledge base. This integration is used during the training and/or fine-tuning phases of the model, ensuring that RAG unit 1784 effectively incorporates external insights when applying policies. In practice, when tasked with applying a security policy, the model uses its internal knowledge base augmented by the enriched external knowledge. This approach allows the model to contextualize and synthesize information, thereby producing coherent and context-aware policies. These policies can, as noted elsewhere herein, encompass various aspects such as data protection measures, access control guidelines, incident response protocols, and compliance frameworks, among other such functionality, tailored to meet specific organizational needs and industry standards with enhanced efficiency, adaptability, and comprehensiveness of the policies generated, not only reducing manual effort but also ensuring that policies remain aligned with current best practices and regulatory requirements.

### Example Flows for Machine Learning Analysis of Endpoint Application Output

FIG. 18 is a block diagram illustrating an example of a policy generation flow, according to methods and systems such as those disclosed herein. That being the case, FIG. 18 depicts a policy generation flow 1800. Policy generation flow 1800 begins with receipt of user input 1801, which is passed to a policy chat module 1805. As will be appreciated in light of the present disclosure, certain embodiments of policy chat module 1805 are comparable to policy helper chat module 1310 of FIG. 13, for example. The chat output of policy chat module 1805 (e.g., chat output 1320) is provided to a policy creation engine 1810. Policy creation engine 1810 (described in greater detail subsequently) provides functionality to similar that provided by policy creation engines described elsewhere herein, though differs in certain respects. Policy creation engine 1810 produces policy data that is provided to a policy presentation module 1850. Policy presentation module 1815, while optional, can be used to present such policy data to a user (e.g., an administrator), who can then to determine whether the proffered policy is acceptable (1820). If the policy is not acceptable, policy generation flow 1800 returns operations to policy chat module 1805, to allow for further refinement of the policy in question. Alternatively, if the policy presented is acceptable (1820), the policy's policy data is stored in the appropriate policy database (1825).

Also shown in FIG. 18 are the details of policy creation engine 1810. As noted, policy creation engine 1810 receives chat output (e.g., chat output 1320) and converts chat output 1322 JSON 1830. JSON 1830 is created from chat output 1320 by a JSON creation module 1835. JSON creation module 1835 provides JSON 1830 directly to a user/group generation module 1840, an allowed application example generation module 1850, and a denied application example generation module 1860. In the embodiment depicted in FIG. 18, user/group generation module 1840, allowed application example generation module 1850, and denied application example generation module 1860 receive JSON 1830, without any preprocessing of JSON 1830, unlike other embodiments depicted herein. In such an embodiment, user/group generation module 1840, allowed application example generation module 1850, and denied application example generation module 1860 are configured to accept the entire output of JSON creation module 1835, and so, to identify portions thereof salient to each module's analysis. Further, in certain embodiments, the effects of other such portions may be considered as having bearing to such analyses, despite having no direct impact thereon. IT will be appreciate, in light of the present disclosure, that user/group generation module 1840, allowed application example generation module 1850, and denied application example generation module 1860 operate in the manner of their corresponding flows, as described in connection with FIGS. 25A, 25B, and 25C, subsequently.

The outputs of user/group generation module 1840, allowed application example generation module 1850, and denied application example generation module 1860 are then provided to a policy name and description generation module 1870 which, in combination with the information in those outputs is provided as policy data 1884 presentation and potential storage as policy data in the appropriate policy database (as depicted in 1825).

FIG. 19 is a block diagram illustrating an example of a policy creation engine, according to methods and systems such as those disclosed herein. FIG. 19 thus depicts a policy creation engine such as policy creation engine 1810, in further detail (such detail being illustrated by a policy creation engine 1900. As before, JSON 1830 is created from chat output by JSON creation module, for example (not shown in FIG. 19, for the sake of simplicity). Also as before, JSON 1830 is provided to three modules: a policy effect generator 1910, an allowed application example generator 1920, and a denied application example generator 1930. As noted in connection with FIG. 18, policy effect generator 1910, allowed application example generator 1920, and denied application example generator 1930 are configured to produce their respective outputs directly from JSON 1830, in combination with or as an alternative to other architectures described herein. Also as before, examples of such functionality are, respectively, described in connection with FIGS. 25A, 25B, and 25C, subsequently.

Policy effect generator 1910 includes a retrieval-augmented generation unit 1940 that is part of a machine learning system 1945. Retrieval-augmented generation unit 1940 receives JSON 1830 and information from an identity store 1947, and generates information regarding users, user groups, applications and other resources, and the like, which may be affected by the policy in question. Allowed application example generator 1920 includes a machine learning system 1950, which receives JSON 1830 and a system message 1955. Machine learning system 1950 produces, in certain embodiments, a list of examples of applications that the policy in question would allow. Similarly, denied application example generator 1930 includes a machine learning system 1960, which receives JSON 1830 and a system message 1965. Machine learning system 1960 produces, in certain embodiments, a list of examples of applications that the policy in question would deny.

The information from retrieval-augmented generation unit 1940 (regarding users, user groups, applications and other resources, and the like), as well as the outputs from allowed application example generator 1920 and denied application example generator 1930, are sent to a message generation unit 1970, the output from which is sent to a policy name and description generation module 1980. Policy name and description generation module 1980 includes a machine learning system 1985, which receives the output of message generation unit 1970 and a system message 1987, and generate certain portions of policy data (e.g., policy data 1880). As will be appreciated from FIG. 19, the outputs from allowed application example generator 1920 and denied application example generator 1930 are also provided as other portions of policy data 1880.

FIG. 20 is a block diagram illustrating an example of a resource output analysis flow, according to methods and systems such as those disclosed herein. In this component of the analysis system, the verdict regarding the resource output content (e.g., screenshot, stream, in-memory data, segments of such images/video/data, and the like) being compliant or non-compliant is used to then adhere to a policy by giving effect to an enforcement (one or more actions). The enforcement actions can be executed based on how the enforcement actions were configured (e.g., as by the administrator or other operator).

As in other of the flows described herein, a resource output analysis flow 2000 such as that depicted in FIG. 20 processes resource output captured and analyzed by an endpoint agent 2005. Endpoint agent 2005 provides the analyzed resource output (depicted as analyzed resource output 2010) to a policy check module 2020. Policy check module 2020 also receives policy data 2025 from a policy generation unit 2030. As noted elsewhere herein, policy data 2025 can be in a descriptive language, for example. Policy check module 2020, having received analyzed resource output 2010 and policy data 2025, applies the policy/policies represented by policy data 2025 to analyzed resource output 2010, in order to make a determination as to a verdict regarding the resource's output, and in so doing, generate a verdict 2040 (which can include a justification for that verdict). In certain embodiments, verdict 2040 (and, if employed, its justification) can indicate that the given resource's output demonstrates the given resource is compliant with the policy in question (compliant), is not compliant with the policy in question (non-compliant), or that the policy is not relevant to the resource in question (irrelevant), for example. Verdict 2040 (and, if employed, its justification) is then provided by policy check module 2022 and enforcement action engine 2050. Enforcement action engine 2050 checks the policy and any associated information to determine the enforcement action(s) to be taken in light of verdict 2040. In turn, enforcement action engine 2050 provides information to an enforcement engine 2060, which takes the actions needed in the given situation.

Returning to policy generation unit 2030, policy generation unit 2030, in generating policy data 2025, includes policy helper chat functionality 2070. Policy helper chat functionality 2070 produces chat output 2075 (similar to chat output 1320 described earlier herein). Chat output 2075 can include a description of the policy in question, information regarding interactions between a user (e.g., an administrator) and an LLM machine learning system (which can include portions of a chat transcript or the chat transcript in its entirety), parameters and factors determine during such interactions, and other information, such as that described elsewhere herein. Chat output 2075 is provided to a policy creation engine 2080, which creates policy data 2025, and can include functionality such as a plain text parser to convert descriptive language of chat output 2075 (or some other natural language, for example) to JSON. Policies (and, potentially, their related information, including justifications) can be managed by way of a policy management module (depicted as a policy management module 2085)).

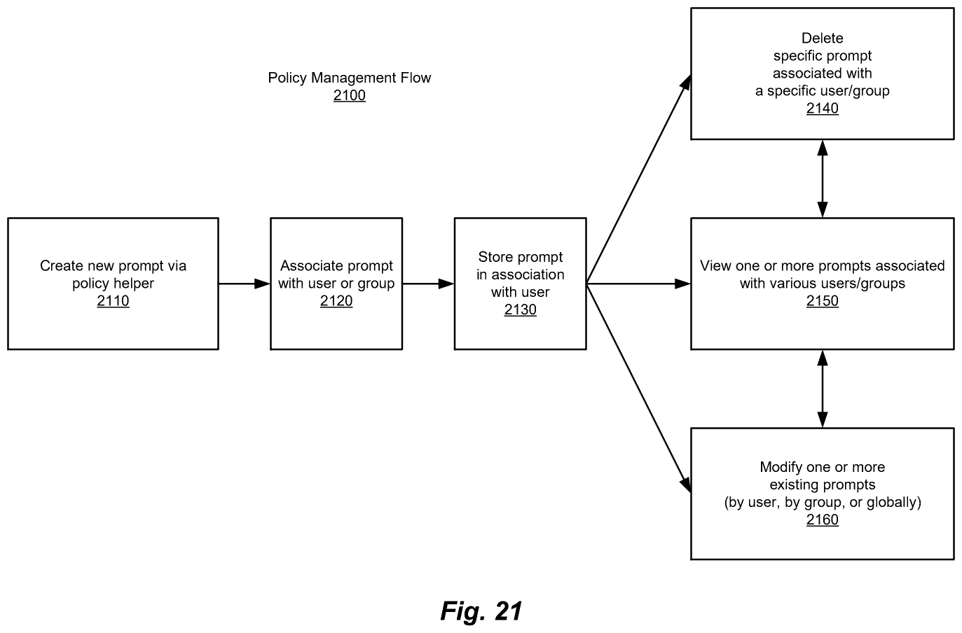

FIG. 21 is a block diagram illustrating an example of a policy management flow, according to methods and systems such as those disclosed herein. That being the case, FIG. 21 depicts a policy management flow 2100, in the manner of policy creation and view flow 1200. However, in the case of policy management flow 2100, rather than creating a new policy manually, policy management flow 2100 creates a new prompt (statement to be used as input to guide the machine learning system, representing a starting point for generating the new policy) via communications with machine learning system (e.g., an LLM-based policy helper system such as policy helper chat module 1310 of FIG. 13), which is depicted in FIG. 21 as a policy helper 2110 and implements policy helper chat functionality 2070. The chat output from policy helper 2110 (e.g., a prompt) is then associated with a given user and/or group (2120). This prompt can then be stored in association with user/group (2130). Such stored prompts can then be deleted (delete specific prompt associated with a specific user/group 2140), viewed (view one or more prompts associated with various users/groups 2150), and/or modified (modify one or more existing prompts (by user, by group, or globally) 2160). Also in contrast to policy creation and view flow 1200 is the ability to move between deleting, viewing, and modifying such prompts, as is indicated in FIG. 21.

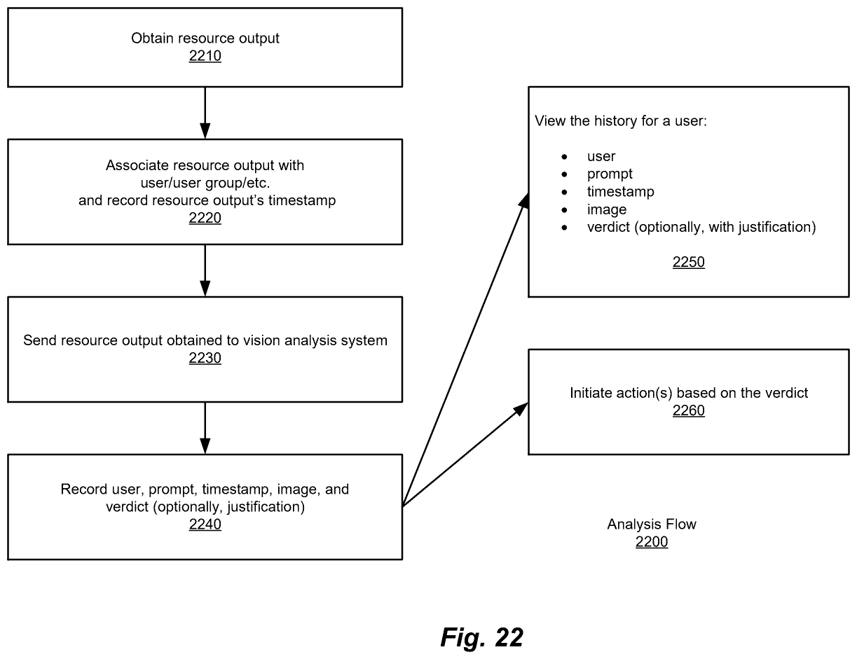

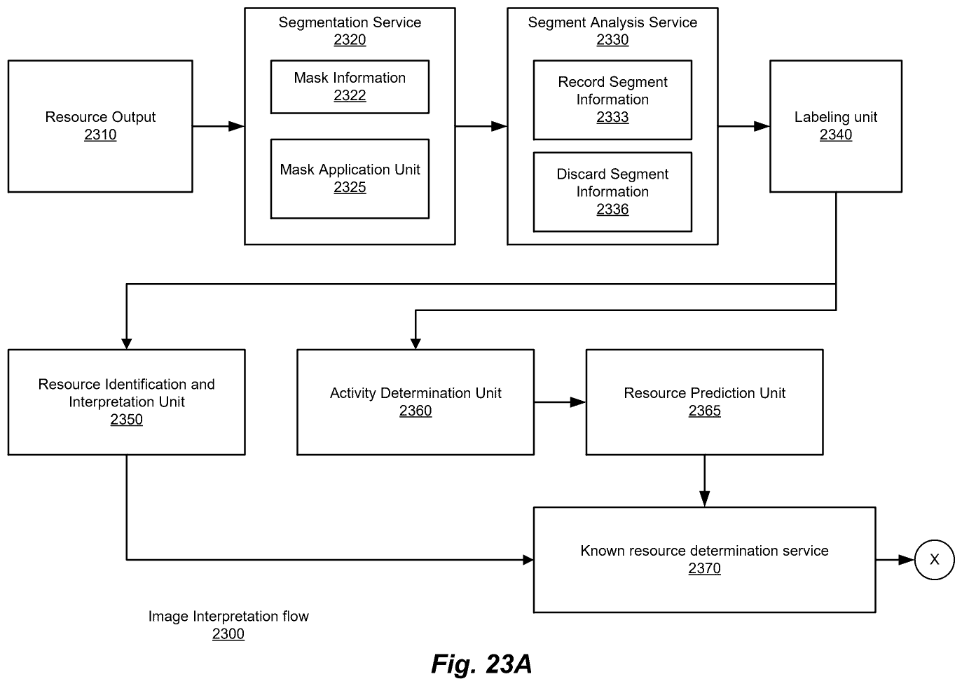

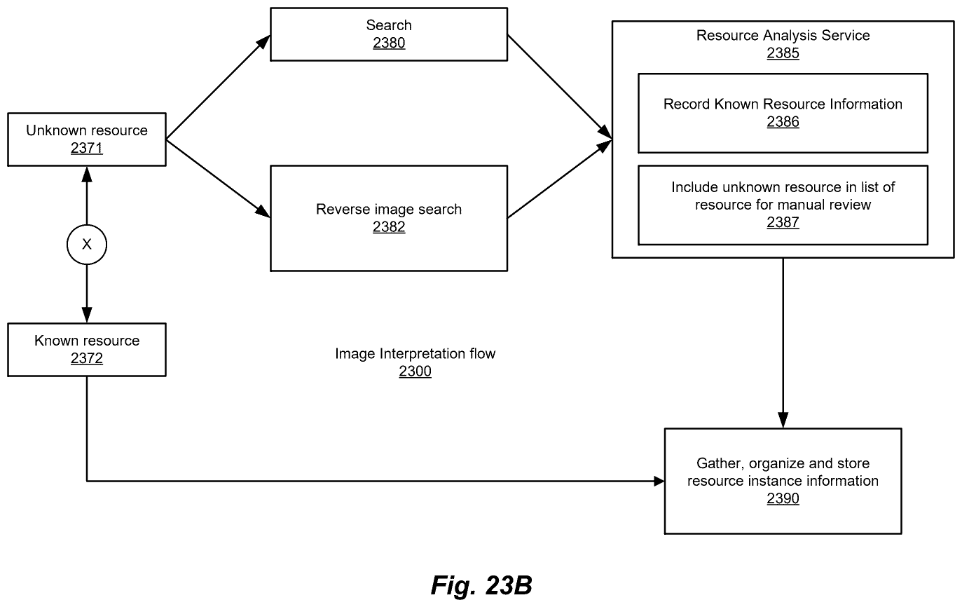

FIG. 22 is a block diagram illustrating an example of an analysis flow, according to methods and systems such as those disclosed herein. As is illustrated in FIG. 22, an analysis flow 2200 begins with obtaining resource output (2210). Such obtaining can be accomplished through the receipt of such resource output, retrieval of such resource output, and/or other such operations, whether performed individually or in combination. For example, obtaining resource output can be effected by capturing a screenshot of a GUI. The resource output is then associated with a user, a user group, or some combination of such information, and in the embodiment depicted in FIG. 22, recorded along with a timestamp (2220). The resource output (e.g., a screenshot including application output) can then be sent to a vision analysis system for analysis based on one or more prompts associated with the given user, group, and/or other organizational unit two for which a policy might apply (e.g., a department, a division, or the like) (2230). For example, such resource output can be sent to a vision analysis system such as an image interpretation module, as is described below in connection with FIGS. 23A and 23B.

Once analyzed, information regarding the user, and user group, the one or more prompts associated there with, the timestamp, the resource output (e.g., image), and verdict (with, optionally, the relevant justification) can be recorded (2240). Once the aforementioned information has been recorded, an operator such as an administrator is then able to view a history for the user/user group in question. Such an operator can view information such as user identifying information, the one or more prompts associated there with, the timestamp, the resource output (e.g. image), and verdict (potentially along with its justification) (2250). Based on such information, analysis flow 2200 can provide the verdict, as well as its justification, to other components of resource output analysis flow 2000, in order for one or more actions to be taken based on the verdict provided (2260).

FIG. 23A is a block diagram illustrating an example of a portion of an image interpretation flow, according to methods and systems such as those disclosed herein. That being the case, FIG. 23A depicts a portion of an image interpretation flow 2300. In a manner such as that described in connection with the vision analysis system noted in connection with FIG. 22, resource output of some type is received (depicted as resource output 2310, an example of which is a screenshot of a graphical user interface (GUI)). Resource output 2310 is provided to a segment station service 2320, which applies mask information 2322 to resource output 2310, which is performed by a mask application unit 2325. An example of such mask application is the application of one or more masks to an image, in order to remove unnecessary portions thereof (e.g., scroll bars, window menus, and the like). The masked version of resource output 2310 is then provided to a segment analysis service 2330, which can perform segment analysis services including, for example, recording segment information (2333) and discarding segment information (2336).

Recorded segment information 2333 is then provided to a labeling unit 2340, which labels the recorded segments for further processing. Such labeled segments are provided to an resource identification and interpretation unit 2350 (which interprets the output of and identifies the resource producing the output (e.g., an application)). The labeled segments are also provided to an activity determination unit 2360 (which determines the nature of activity occurring in the resource's resource output (e.g., such as the content of output displayed in an application's window)). The activity information determined by activity determination unit 2360 is passed to a resource prediction unit 2365, which endeavors to predict the resource in question based on the resource activity information received (e.g., predicting the application in question based on the activity in the application's window, using information such as window state, window contents, and the like).

Resource identification and interpretation information from resource identification and interpretation unit 2350, and predicted resources based on the output of resource prediction unit 2365 are sent to a known resource determination service 2370. Known resource determination service 2370 makes a determination as to whether the resource (e.g., application) is a known resource (e.g., an application with which the analysis system has sufficient experience to be able to identify the application) or an unknown resource (e.g., an application with which the analysis system has insufficient experience to be able to identify the application). The output of known resource determination service 2370 is sent to another portion of image interpretation flow 2300 that appears in FIG. 23B, by way of a connector “X”.

FIG. 23B is a block diagram illustrating an example of another portion of the image interpretation flow, according to methods and systems such as those disclosed herein. Beginning with connector “X”, as noted, this other portion of image interpretation flow 2300 receives the determination by known resource determination service 2370, which, in the example depicted in FIG. 23B, is one of “unknown” (represented by an unknown resource 2371) or “known” (represented by a known resource 2372). If the resource in question is unknown (unknown resource 2371) image interpretation flow 2300 performs a search (depicted in FIG. 23B as a search 2380) and a reverse image search (depicted in FIG. 23B as a reverse image search 2382), which can be performed in parallel or in serial fashion. Unknown resource 2371 is processed by this branch of image interpretation flow 2300 to determine what the unknown application is and record that information, so the application is “known” the next time and need not be analyzed in this manner again. Thus, search 2380 performs a search for information regarding the resource (e.g., application) in question by performing a web search for the resource's name (e.g., application name) and other related information. Similarly, reverse image search 2382 can be implemented by way of a reverse image search for images for the resource (e.g., application), as doing so by way of searching for a resource's (application's) logo. As will be appreciated in light of the present disclosure, other operations can be performed in place of or in addition to search 2380 and reverse image search 2382 to aid in the identification of the resource (e.g., application) in question.

The results of search 2380 and reverse image search 2382 are provided to a resource analysis service 2385. Resource analysis service 2385 can perform operations such as recording known resource information (2386), in the case in which the resource (e.g., application) is successfully identified based on the results of search 2380 and reverse image search 2382, or including the unknown resource in a list of resources for which manual review is needed (2387), in the case in which the resource cannot be identified with sufficient certainty. Thus, as will be appreciated in light of the present disclosure, if the resource in question can be identified with sufficient certainty, known resource information (e.g., known application information) can be recorded, in the case in which a determination can be made as to the identity of the unknown application (which can then be recorded for use the next time the resource is encountered), avoiding the need for the processing involved in proceeding through “unknown” branch of image interpretation flow 2300, for that particular resource (e.g., application). In other words, the resource is now known as a result of the resource's identity having been determined. Now that the resource in question has been identified, the relevant information can be sent to the appropriate machine learning system for a determination as to whether the applicable policy/policies are satisfied thereby. In the alternative, the relevant information can be examined by an operator (e.g., an administrator) to determine whether the policy/policies question apply.

In the case of known resource 2372 (or a successful determination as to the identity of an unknown resource such as unknown resource 2371), resource information (e.g., application instance information) is gathered, organized, and stored. This information can then be checked against relevant policies, as is performed by a policy check module such as policy check module 2020 of FIG. 20, which is described in further detail in connection with FIG. 23, below.

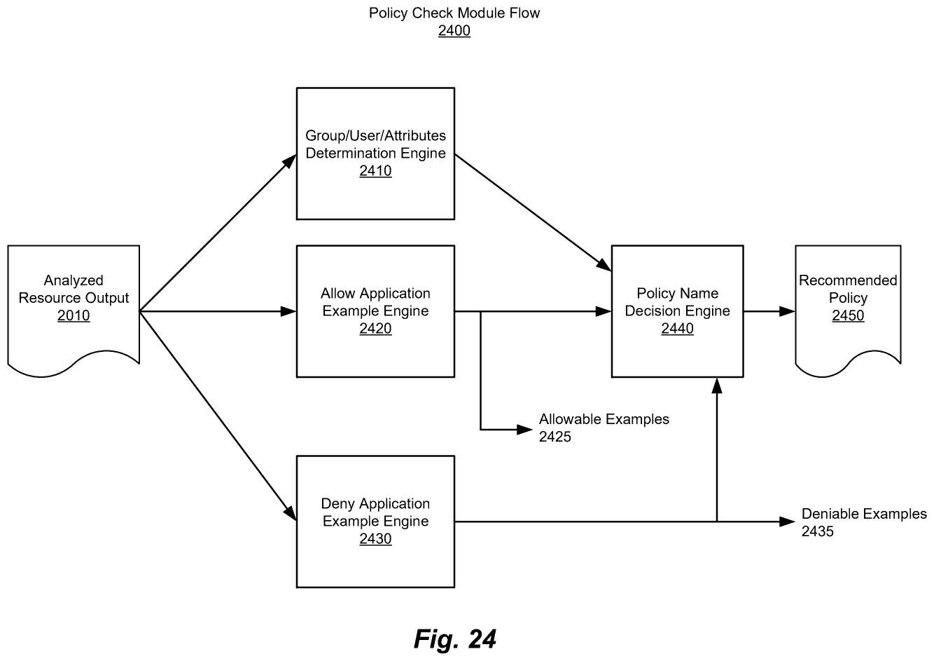

FIG. 24 is a block diagram illustrating an example of a policy check module flow, according to methods and systems such as those disclosed herein. FIG. 24 thus depicts a policy check module flow 2400. Policy check module flow 2400 receives analyzed resource output 2010 from endpoint agent 2005, in the manner depicted in FIG. 20. Analyzed resource output 2010 is provided to a group/user/attribute determination engine 2410, an allow application example engine 2420, and a deny application example engine 2430. As before, however, respective examples of the functionalities provided by each of group/user/attribute determination engine 2410, allow application example engine 2420, and deny application example engine 2430 are described in connection with FIGS. 25A, 25B, and 25C, subsequently. Briefly, group/user/attribute determination engine 2410 determines users (e.g., other than the user in question) and user groups (of which the user may be a member, or groups other than that), which may be affected by the actions that may be taken in view of the given policy, as well as other organization units of the organization (departments, subsidiaries, divisions, etc.). Allow application example engine 2420 generates examples of acceptable scenarios (e.g., acceptable applications and acceptable usage thereof) that would be acceptable under the given policy, which are passed to a policy name determination engine 2440 and out of policy check module flow 2400 as allowable examples 2425. Deny application example engine 2430 generates examples of unacceptable scenarios (e.g., unacceptable applications or unacceptable usage of a given application (whether or not the application itself is acceptable)) that would be unacceptable under the given policy, which are passed to a policy name determination engine 2440 and out of policy check module flow 2400 as deniable examples 2435.

In a manner similar to that noted in connection with FIG. 18, the embodiment depicted as policy check module 2400 provides analyzed resource output 2010 to all three of group/user/attribute determination engine 2410, allow application example engine 2420, and deny application example engine 2430, which are configured to identify and extract the portions of analyzed resource output 2010 appropriate to their respective functions. Further, referring to FIG. 22B, it will be appreciated that analyzed resource output 2010 can include information gathered, organized, and stored as resource instance information 2290.

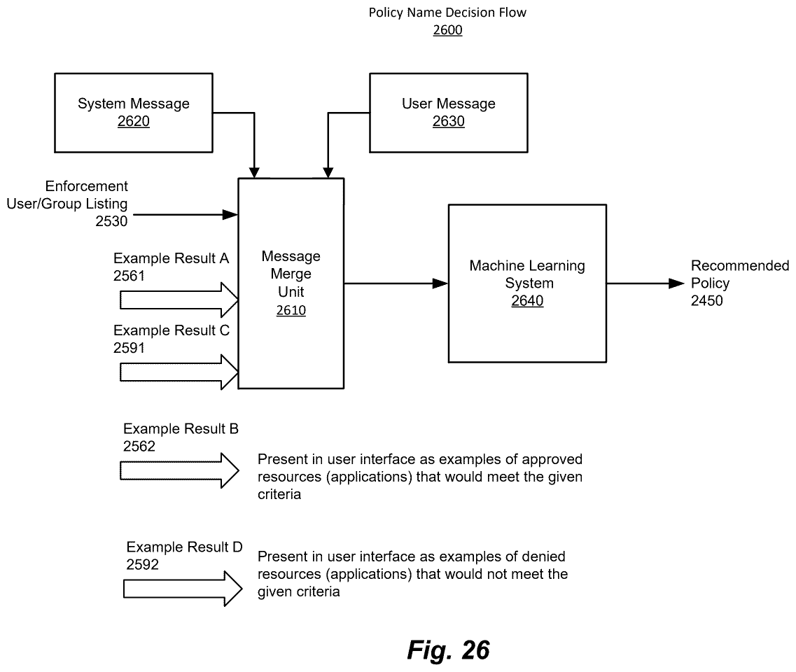

The outputs of group/user/attribute determination engine 2410, allow application example engine 2420, and deny application example engine 2430 are, respectively, provided to policy name determination engine 2440. Policy name determination engine 2440 thus receives information regarding affected users/groups/etc. and the impact on those affected, allowable examples, and deniable examples, as well as guidance in analyzing such information (e.g., system and user statements, as noted in the discussion of FIG. 26, subsequently. After such processing, policy name determination engine 2440 outputs one or more policies in response thereto (e.g., a recommended policy 2450, which can be a policy identifier, a policy name, a policy in its entirety (including justification and other information), and/or the like).

FIG. 25A is a block diagram illustrating an example of a group/user/attribute decision flow, according to methods and systems such as those disclosed herein. FIG. 25A thus depicts a group/user/attribute decision flow 2500, such as that contemplated by group/user/attribute determination engine 2410 of FIG. 24. Group/user/attribute decision flow 2500 receives analyzed resource output 2010, which, in certain embodiments, includes information identifying one or more users may be affected by determinations made by the analysis system (user effects), groups that may be affected thusly (group effects), and/or other collections/combinations of users as may be appropriate to the organization in question and affected in this manner. Analyzed resource output 2010 is received by a message merged unit 2510, which also receives a system message 2515 and, optionally, a user message 2520. As described elsewhere herein (and examples of which are provided subsequently), system message 2515 provides context to a machine learning system 2525, when merged with analyzed resource output 2010. User message 2520, in a similar fashion, is merged in with analyzed resource output 2010 and system message 2515, to allow fine-tuning of the interpretation of analyzed resource output 2010 and system message 2515 by machine learning system 2525. Thus, machine learning system 2525 receives a merged version of analyzed resource output 2010, system message 2515, and user message 2520, producing therefrom an enforcement user/group listing 2530, which captures information such as the effects on other users, other groups, and the like.

FIG. 25B is a block diagram illustrating an example of an allowed resource flow, according to methods and systems such as those disclosed herein. FIG. 25B thus depicts an allowed resource flow 2540, such as that contemplated by allowed application example engine 2420 of FIG. 24. Allowed resource flow 2540 receives analyzed resource output 2010, which, in certain embodiments, includes a list of examples of resources (e.g., applications) that can be allowed. As in the case of user/group effects, analyzed resource output 2010 is received by a message merged unit 2545, which also receives one or more system messages (depicted as system messages 2550) and, optionally, one or more user messages (depicted as user messages 2555). As before (and as described elsewhere herein, with examples provided subsequently), system messages 2550 provide context to a machine learning system 2560, when merged with analyzed resource output 2010, while user messages 2555 allow fine-tuning of the interpretation of analyzed resource output 2010 and system message 2515 by machine learning system 2560. Thus, machine learning system 2560 receives a merged version of analyzed resource output 2010, system messages 2550, and user messages 2555, producing therefrom an example result A 2561 and an example result B 2562, which represent examples of resources that the analysis system should allow, and which will typically be comparable or even identical to one another.

FIG. 25C is a block diagram illustrating an example of a denied application flow, according to methods and systems such as those disclosed herein. FIG. 25C thus depicts a denied application flow 2570, such as that contemplated by deny application example engine 2430 of FIG. 24. Denied application flow 2570 receives analyzed resource output 2010, which, in certain embodiments, includes a list of examples of applications that are to be denied. As in the case of user/group effects, analyzed resource output 2010 is received by a message merged unit 2575, which also receives a system message 2580 and, optionally, a user message 2585. As before (and as described elsewhere herein, with examples provided subsequently), system message 2580 provides context to a machine learning system 2590, when merged with analyzed resource output 2010, while user message 2585 allows fine-tuning of the interpretation of analyzed resource output 2010 and system message 2515 by machine learning system 2590. Thus, machine learning system 2590 receives a merged version of analyzed resource output 2010, system message 2580, and user message 2585, producing therefrom an example result C 2591 and an example result D 2592, which represent examples of resources that the analysis system should deny, and which will typically be comparable or even identical to one another.

FIG. 26 is a block diagram illustrating an example of a policy name decision flow, according to methods and systems such as those disclosed herein. FIG. 26 a policy name decision flow 2600, such as that contemplated by policy name determination engine 2440 of FIG. 24. Policy name decision flow 2600 receives enforcement user/group listing 2530 (as might be generated by group/user/attribute decision flow 2500), example result A 2561 (as might be generated by allowed resource flow 2540), and example result C 2591 (as might be generated by denied resource flow 2570) at a message merged unit 2610. In a manner such as that noted earlier, these inputs to message merged unit 2610 provide information regarding users/groups/etc., examples of allowable applications, and examples of applications that should be denied. Message merged unit 2610 also receives a system message 2620 and, optionally, a user message 2630. As before (and as described elsewhere herein, with examples provided subsequently), system message 2620 provides context to a machine learning system 2640, when merged with the aforementioned inputs. Similarly, user message 2630 allows fine-tuning of the interpretation of those inputs with respect to the interpretation thereof. Thus, machine learning system 2640 produces a recommended policy (or policies, as well as justifications and other information, optionally) as recommended policy 2450, in the manner of policy 2370.

Also provided with recommended policy 2452 and administrator GUI are example result B 2562 and example result D 2592. Example result B 2562, presented in the administrator's user interface, includes examples of approved resources (e.g., applications) that would be expected to meet the given criteria of the policy or policies in question. Similarly, example result D 2592, presented in the administrator's user interface, includes examples of resources (e.g., applications) that would not meet the given criteria of the policy or policies in question, and so would be expected to be denied.

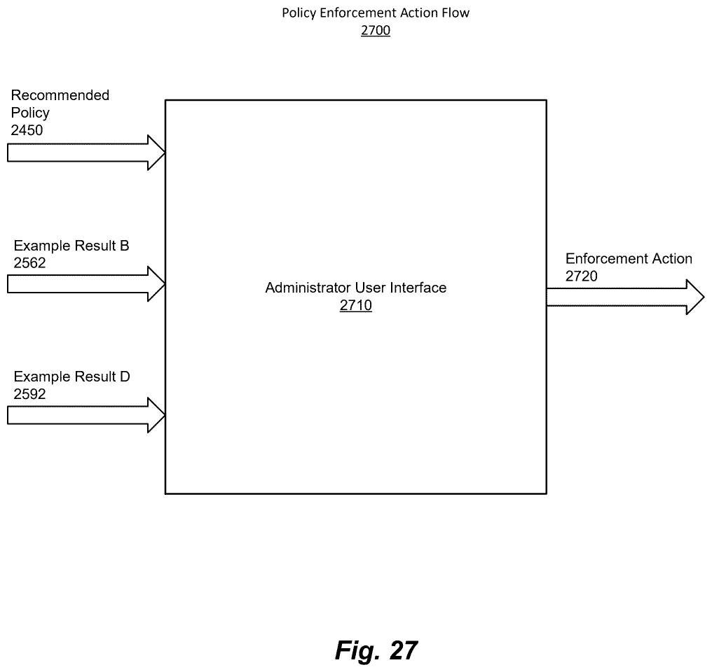

FIG. 27 is a block diagram illustrating an example of a policy enforcement action flow, according to methods and systems such as those disclosed herein. FIG. 27 thus depicts a policy enforcement action flow 2700. As noted in earlier figures, information received at an administrator user interface 2710 includes recommended policy 2450, which, as its name suggests, is the recommended policy or policies resulting from policy name decision flow 2600. Also presented to an operator such as an administrator are examples of applications that would be allowed in view of the policy or policies in question (denoted by receipt of example result B 2562 by administrator user interface 2710) and examples of applications that would be denied in view of the policy or policies in question (denoted by receipt of example result D 2592 by administrator user interface 2710). As noted in connection with policy creation engine architecture 1400, for example, such an administrator can optionally be provided with the ability to approve the recommended action(s) in question. In the alternative, administrator user interface 2710 can be bypassed (although in certain embodiments such recommended action(s) can be displayed for the administrator's edification) and the recommended action(s) passed on for enforcement. Whether by approval or bypass, such recommended action(s) are provided to an enforcement unit such as enforcement unit 1182 of FIG. 11.

FIG. 28 is a diagram illustrating an example of output screen examples, according to methods and systems such as those disclosed herein. FIG. 28 thus depicts output screen examples 2800. In one embodiment, such output screen examples can include alternatives that result from the agent enforcement recommendation flow described earlier. For example, output screen examples 2800 are depicted as including an allowed application output screen 2810, a denied application output screen 2820, and irrelevant application output screen 2830.

In the case of allowed application output screen 2810, a business application used in a manner appropriate to the user's business function can be identified as being compliant with a policy that requires such a user to use business-appropriate applications in a business-appropriate manner.

For example, a GUI window of an application that is compliant with the given policy (including, potentially, the contents of the GUI window indicating an acceptable use of the application by the user in question, also therefore being in compliance with the given policy) is presented in allowed application output screen 2810. Application output screen 2810 depicts an application output (a window in a GUI) that would be compliant with the policy of an application being for a business purpose (a business application). Its evaluation would be as follows:
Interface Layout: The interface shows a well-organized and structured layout with clear sections for different functionalities, such as chats, teams, meetings, and files. It is visually clean and free from clutter, which enables easy navigation and focused communication.
Professional Functionality: The interface displays features that suggest advanced communication capabilities, including thread management seen in the conversation threads, and file sharing, as indicated by the ‘Files’ tab. There is evidence of project management functionality, with different channels for team collaboration and a search bar that may allow for integrations with other corporate tools.
Branding and Business Orientation: The software uses a structured and formal labeling system for different sections, suggesting it is designed for corporate use. Although there is no visible presence of an organization's specific logo or color scheme, the professional layout aligns with corporate branding elements.
Access Control and Administration: The left sidebar indicates a structured organization into teams and channels, which can imply user roles and permissions. There is a section at the bottom with settings and help icons, which might include user management and administration functionalities. This image appears to be of MICROSOFT TEAMS, which is a corporate communication tool that is compliant with the policy of providing features for corporate use. It includes all the functionalities required for a messaging app designed for professional use, such as team messaging, file sharing, video calls, task management, and integration with other tools.
Conclusion: Business Application
Response: COMPLIANT

In the case of denied application output screen 2820, a non-business application or a business application used in an inappropriate manner (e.g., to the user's business function) can be identified as being non-compliant with a policy that requires such a user to use business-appropriate applications in a business-appropriate manner. Denied application output screen 2820 depicts an application output (a window in a GUI) that would not be compliant with the policy mandating a business application used for an acceptable business purpose. The interface shown in the application output is similar to that of FACEBOOK MESSENGER, which is known for personal rather than corporate communication. Such an application's output would be evaluated as follows:
Interface Layout: The interface is well-organized, with a clear section for a chat list and the active chat displayed as active chat area 2825, which is visually clean and clutter-free. Navigation seems straightforward, focusing on communication.
Professional Functionality: Advanced communication capabilities such as reactions to messages are visible, but there's no clear evidence of thread management or file sharing. There is no visible evidence of project management functionality like task assignment or progress tracking.
Branding and Business Orientation: The interface does not show any specific labels, icons, or notifications that suggest it is designed for corporate use. There is no professional branding related to a specific organization, such as a logo or a distinct color scheme.
Access Control and Administration: There is no evidence of hierarchical access control or centralized administration. There are no visual cues that suggest user management or group creation functionalities.
Conclusion:
Response: NON-COMPLIANT

In the case of irrelevant application output screen 2830, there will be applications for which the given policy is not relevant (does not apply). A non-business application appears to be in use, but does not appear to be used in an inappropriate manner (e.g., to the user's business function). Such an application would be deemed irrelevant, with respect to the application of the policy in question. Irrelevant application output screen 2830 thus depicts an application output (a window in a GUI) that would not be relevant to application of a policy mandating a business application used for an acceptable business purpose. Such an application's output would be evaluated as follows:
Interface Layout: The interface shown is from an e-reader or application, displaying the text of a book (text 2835). It is well-organized and structured, with a clear section dedicated to displaying the text and a percentage indicator for reading progress. The interface is visually clean and free from clutter, enabling focused reading. However, it does not show different functionalities related to corporate communication.
Professional Functionality: The e-reader app is designed primarily for reading and does not display features that suggest advanced communication capabilities such as thread management, file sharing, or integrations with corporate tools. There is no evidence of project management functionality, such as task assignment, progress tracking, or team collaboration tools.
Branding and Business Orientation: While the e-reader application is a professional product, it does not display labels, icons, or notifications that suggest it is designed for corporate communication. It lacks indications of professional branding in the context of corporate communication tools.
Access Control and Administration: There is no evidence of user roles and permissions in irrelevant application output screen 2830, nor does the application typically support hierarchical access control or centralized administration in a corporate communication context. There are no visual cues of user management, group creation, or user audit trail functionalities.
Conclusion: Because the e-reader application is neither compliant nor non-compliant—it simply falls outside the scope of the policy, which is focused on messaging apps designed for corporate purposes—the policy in question is not relevant to the application. The application is designed for reading books and does not possess the functionalities associated with corporate communication tools.
Response: IRRELEVANT (Not relevant with respect to this policy)

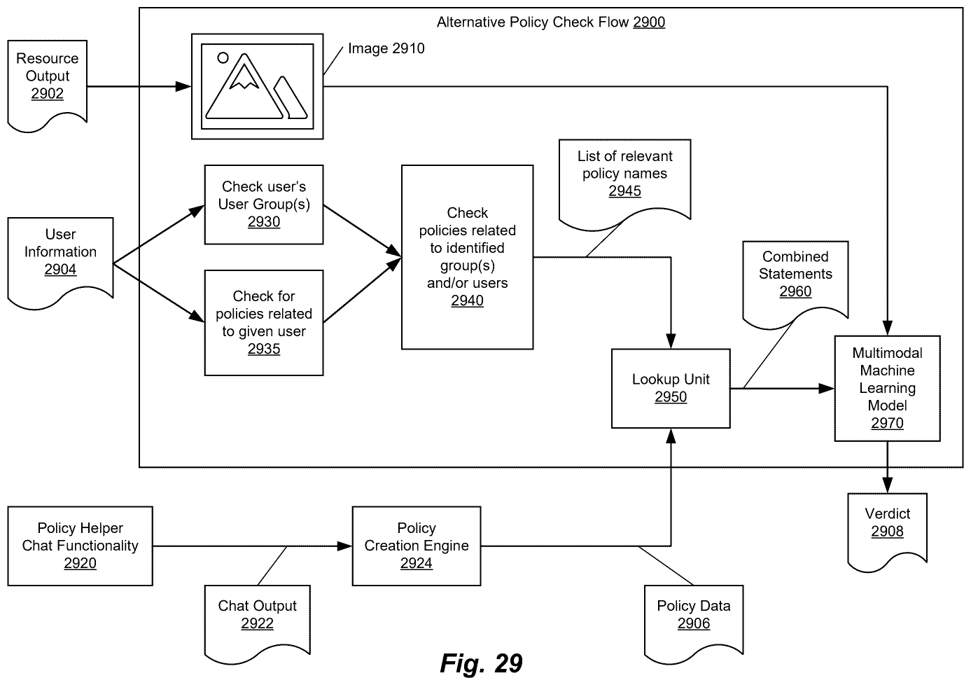

FIG. 29 is a diagram illustrating an example of an alternative policy check flow, according to methods and systems such as those disclosed herein. FIG. 29 thus depicts an alternative policy check flow 2900. Alternative policy check flow 2900 provides functionality, in certain respects, comparable to that described in connection with policy check module 2020. However, alternative policy check flow 2900 simply receives resource output (e.g., depicted as resource output 2902), user information (e.g., depicted as user information 2904) and policy data (e.g., depicted as policy data 2906), and based on this information, generates a verdict 2908 (optionally, with appropriate justification) by processing resource output 2902 directly using policies identified using the user information and the policy data. As is illustrated in alternative policy check flow 2900, resource output 2902 is some manner of data representing visual information, such as an image, video capture, video stream, and/or other such visual information as may be represented using digital information. An example of such visual information is depicted as an image 2910, which can be the output from a single application (not segmented) or screen (segmented), or simply an entire screen (and not segmented).

For its part, policy data 2906 can be generated in a fashion such as that described in connection with resource output analysis flow 2000. That being the case, policy helper chat functionality 2920 generates chat output 2922 (in the manner of the generation of chat output 2075 by policy helper chat functionality 2070, where the chat output can be in the descriptive language), which is received by a policy creation engine 2924. In turn, policy creation engine 2924 generates policy data 2906 (in the manner of the generation of policy data 2025 by policy creation engine 2080. In the manner noted in connection with resource output analysis flow 2000, policy data 2906 can include information such as the combination of policy information, resource information (e.g., application information), and other related information salient to the policy checking performed in alternative policy check flow 2900, and can also be in the descriptive language. And with respect to verdict 2908, outcomes in the depicted embodiment can be compliant, non-compliant, or irrelevant with regard to the policy in question for the user in question.

As noted, visual information such as image 2910 is received as part of alternative policy check flow 2900, as is user information 2904. User information 2904 is processed to check the given user's user group(s) (2930) and which policies are related to the given user (2935). The results of these operations are then analyzed to check for policies related to the identified group or groups and/or users (2940). This generates a list of relevant policy names 2945, which is passed to a lookup unit 2950. Lookup unit 2950 identifies applicable system prompts (system statements), producing combined statements 2960. Image 2910 and combined statements 2960 are passed to a multimodal machine learning model 2970 multimodal machine learning model 2970 analyzes image 2910 with respect to combined statements 2960 (and so, the policy or policies represented thereby), generating verdict 2908, which can include information regarding justification for verdict 2908, as desired.

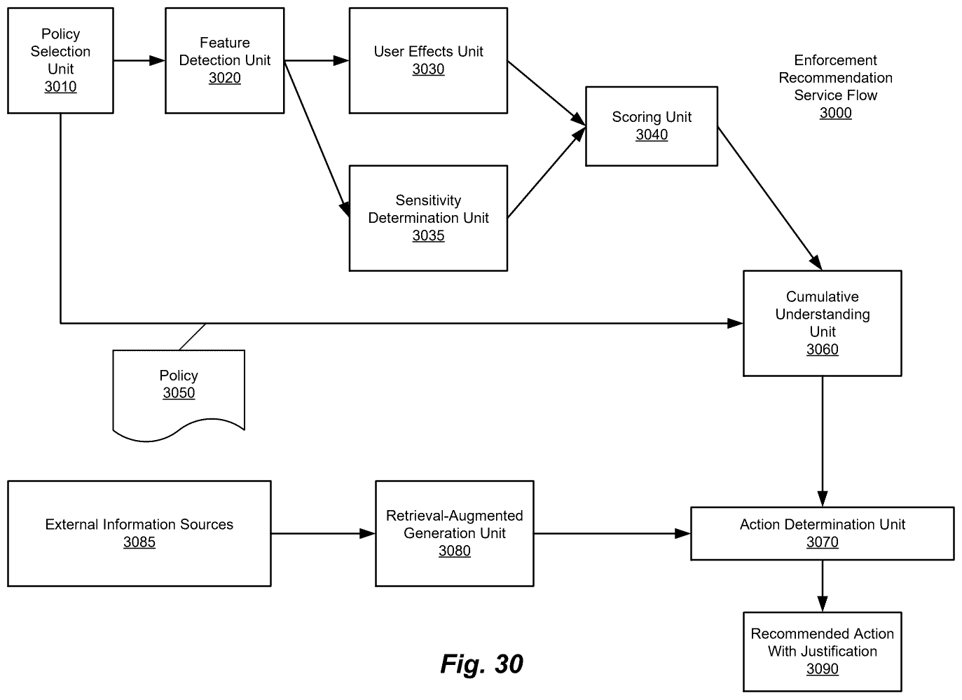

FIG. 30 is a diagram illustrating an example of an enforcement recommendation service flow, according to methods and systems such as those disclosed herein. FIG. 30 thus depicts an enforcement recommendation service flow 3000, which is a more general representation of the policy check operations that also provides for the creation of policies without necessarily associating actions therewith. Enforcement recommendation service flow 3000 thus provides for an analysis system in which a given user may employ a given application in a given manner, and enforcement recommendation service flow 3000 can decide on which policy or policies are applicable, and what actions to take based on those policy or policies.

Enforcement recommendation service flow 3000 begins with the selection of the applicable policy or policies by a policy selection unit 3010, based on the resource output received. Given that such a policy or policies are in a descriptive language such as that described herein (e.g., a natural language), such policy or policies also serve as an indicator of an administrator's, organization's, or other such entity's intent. This resource output is passed (potentially with the selected policy or policies) to a feature detection unit 3020, which identifies one or more features of the resource output that are salient to the selected policy or policies. Such features are passed (potentially with other information) to a user effects unit 3030 and a sensitivity determination unit 3035. User effects unit 3030 determines what effects, if any, such activity and potential actions may have on what are to be considered high priority users. In a comparable fashion, sensitivity determination unit 3035 determines the sensitivity of the resources in question to the given context and environment at hand. The outputs of user effects unit 3030 and sensitivity determination unit 3035 are provided to a scoring unit 3040 which determines sensitivity scores and the reasoning for such scoring.

The output of scoring unit 3040 and the selected policy or policies (depicted as policy 3050) are passed to a cumulative understanding unit 3060, which processes the output of scoring unit 3040 in view of the applicable policy or policies. In turn, the output of cumulative understanding unit 3060 is provided to an action determination unit 3070. Action determination unit 3070 is comparable in function to action determination unit 1783 of FIG. 17B, in certain embodiments. Action determination unit 3070 also receives the output of a retrieval-augmented generation unit 3080, which retrieves external information from external information sources 3085. External information sources 3085 can include information sources such as release notes, internal and external documents, internal and external blogs, best practices documents, and the like, and such information, as noted, can be external to the analysis system, incomparable fashion to such functionalities discussed in connection with FIGS. 17B and 17C, previously. The foregoing inputs are used by action determination unit 3070 to arrive at a recommended action (which can include a justification) 3090.

### Example Processes for Resource Management by Policy Analysis of Resource Outputs

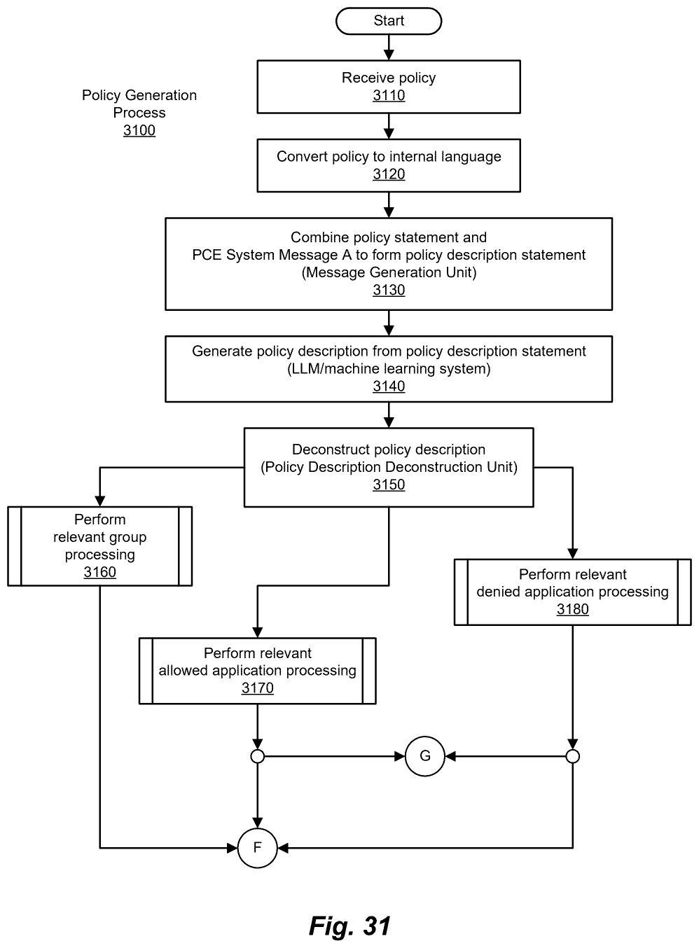

FIG. 31 is a simplified flow diagram illustrating an example of a portion of a policy generation process, according to methods and systems such as those disclosed herein. FIG. 31 thus depicts a policy generation process 3100 that begins with the receipt of a policy (3110), where the system acquires the policy that is to be implemented. Once the policy is received, the next operation of policy generation process 3100 converts the policy into an internal language format that the system can properly interpret and process efficiently (e.g., converting a descriptive language such as a natural language into its JSON representation) (3120). Following this, the JSON version of the policy statement is combined with PCE System Message A to form a policy description statement, which can be facilitated by a message generation unit (3130). As noted, certain embodiments can provide fine-tuning by including an additional user statement into the policy description statement (such additional user statement being referred to as a supplemental user statement, in such embodiments where the original policy is treated as a user statement to begin with).

Subsequently, the policy description statement is used to generate a detailed policy description. In certain embodiments, such a generation process can be performed by a machine learning system, such as an Large Language Model (LLM) machine learning system or comparable advanced machine learning framework (3140). Once the policy description has been generated, a policy description deconstruction unit deconstructs the policy description, such processing breaking down the detailed policy description into appropriate components for further processing (3150).

In the embodiment shown, the deconstructed information thus generated (deconstructed policy description information) is subsequently used in relevant group processing (3160), allowed application processing (3170), and denied application processing (3180). These operations ensure that the policy is accurately interpreted and represented, as well as being applied appropriately, thereby effecting the desired outcomes and facilitating subsequent functionality in the analysis system's operations (e.g., in supporting appropriate resource usage (e.g., applications), and preventing use of inappropriate resources and/or misuse of appropriate resources (e.g., inappropriate applications and/or misuse of applications), while minimizing impact on computing systems and business operations, for example) and ensuring that the resource (e.g., application) in question is handled according to the policy description generated earlier.

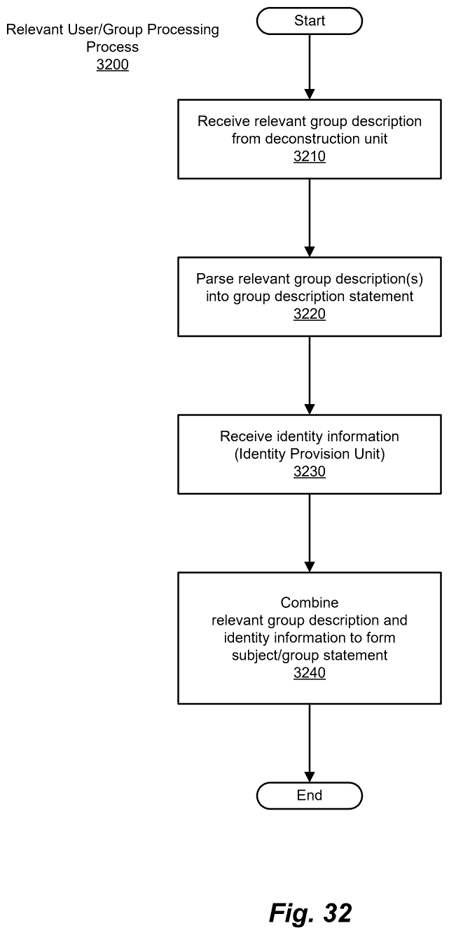

Various portions of the deconstructed policy description are then used to give effect to the policy in question. Thus, that portion of the policy description having bearing on relevant group processing (3160) is used to determine the user effects of the policy. The relevant group processing performed involves analyzing and processing the policy based on specific group criteria that might be pertinent to the policy's application or enforcement and determines the effects on not only the user in questions, but, potentially, the user's user group(s) and other organizational units, other users (whether in those group(s) and other organizational units, or otherwise), and the like. This operation ensures that resources (e.g., applications) permitted by the policy are correctly handled and processed. Such operations are described in greater detail in connection with FIG. 32, subsequently, and produce user effects information that can be used by other components of the given policy creation engine.

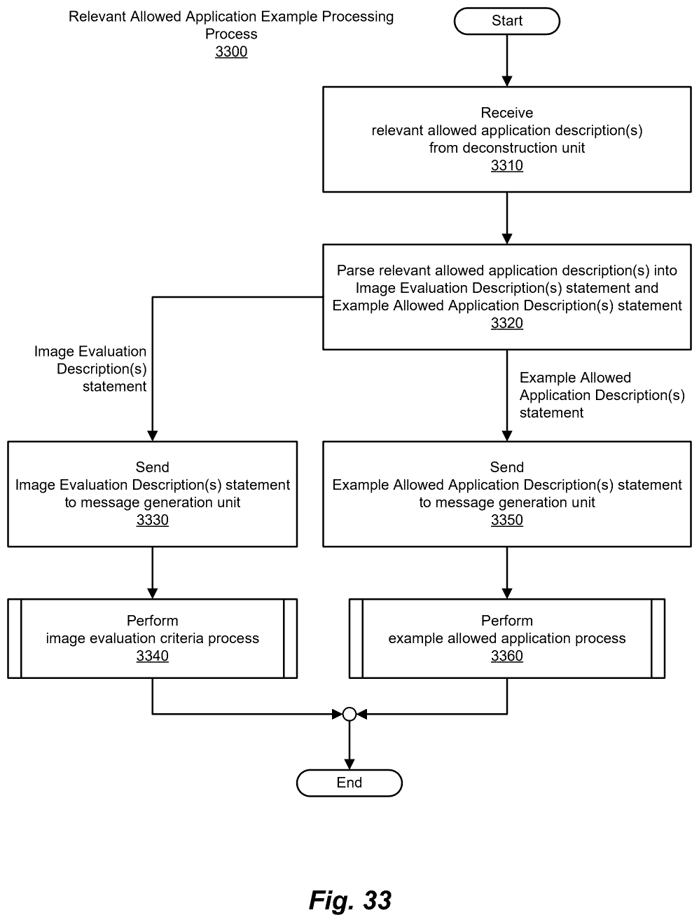

With regard to that portion of the policy description relevant to examples of allowed applications, the process of relevant allowed application processing (3170) is performed to generate examples of applications that the policy in question would allow, such as approved business applications being used in an appropriate manner. Such operations are described in greater detail in connection with FIGS. 33, 34, and 35, subsequently.

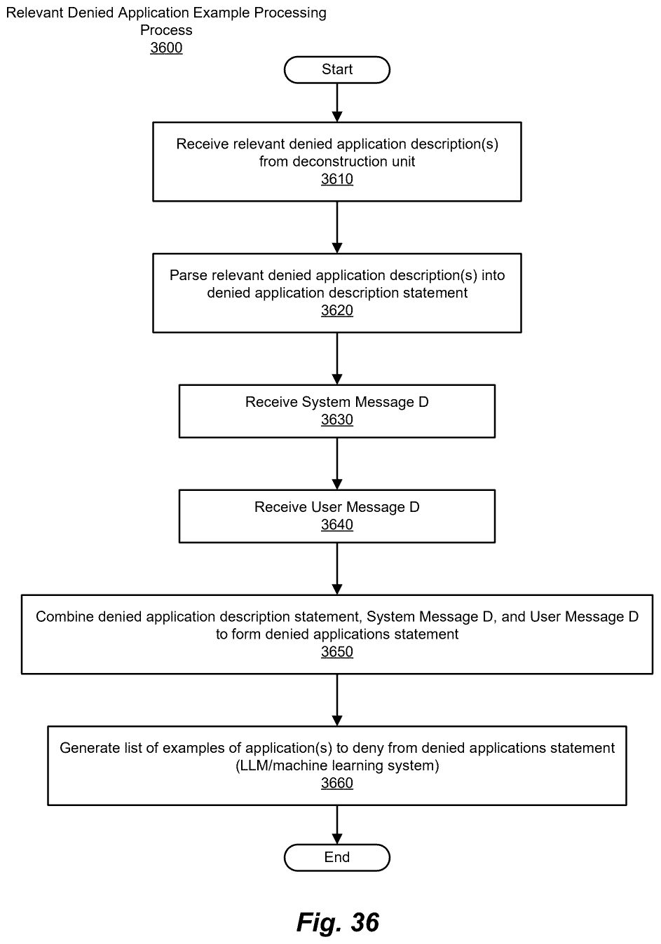

Similarly, with regard to that portion of the policy description relevant to examples of denied applications, the process of relevant denied application processing (3180) is performed to generate examples of applications that the policy in question would deny, such as inappropriate applications (e.g., FACEBOOK), otherwise allowable applications being misused/used inappropriately (e.g., an approved web browser being used to play online games). This operation handles any instances where certain applications should be denied as per the policy, ensuring that these are handled appropriately. The performance of denied application processing generates examples of applications that the policy in question would not allow, such as approved business applications being used in an inappropriate manner, disapproved applications being used, and the like. Such operations are described in greater detail in connection with FIG. 36, subsequently.

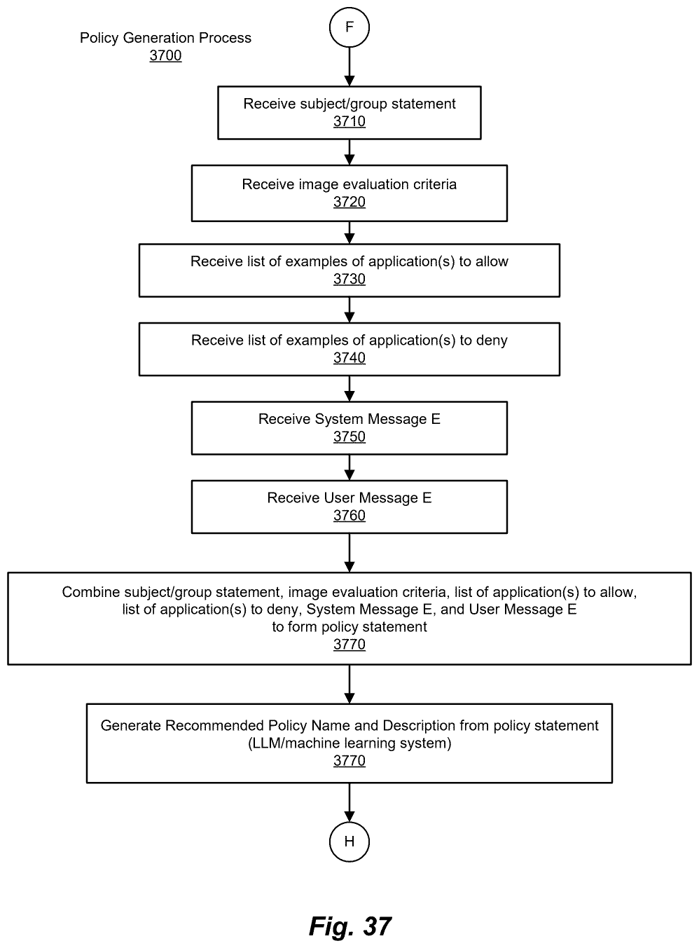

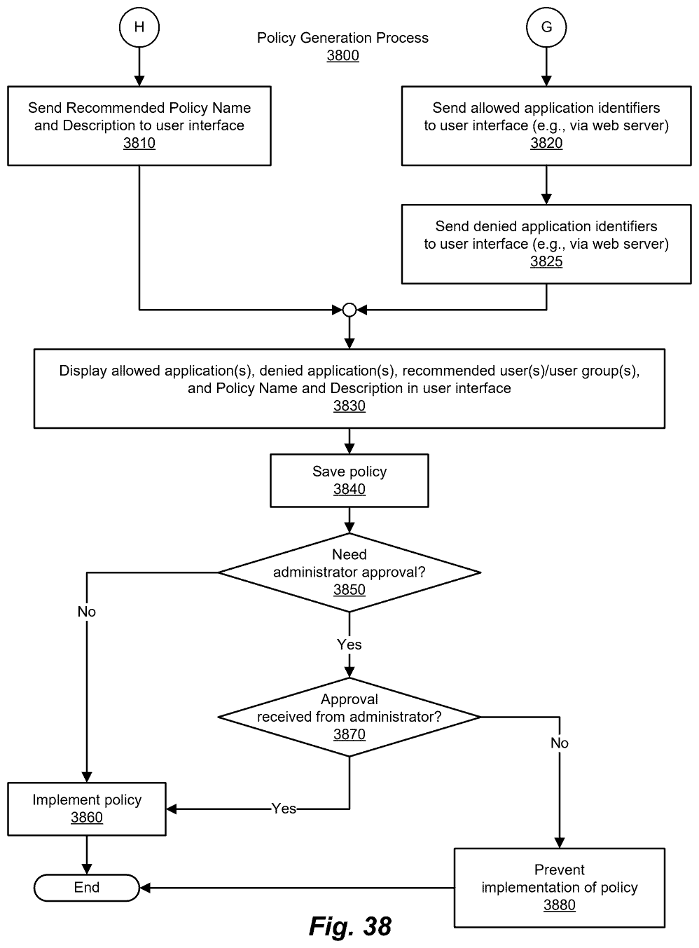

Once the foregoing processing has been performed, with the affected users, groups, and the like identified, as well as example of allowed resource and denied resources generated, as appropriate, policy generation process 3100 proceeds to provide such information to other components of the policy creation engine. Provision of such information is represented in FIG. 31 by connectors “F” and “G”. Connector “F” receives the user effects information, allowed application examples, and denied application examples, which are provided to the policy generation process continued in FIGS. 37 and 38. In a similar fashion, connector “G” receives allowed application examples and denied application examples, which are provided to the policy generation process continued in FIG. 38. Policy generation process 3100, with respect to the operations shown in FIG. 31, thus can proceed to those portions of the policy generation process shown in the aforementioned figures.

FIG. 32 is a simplified flow diagram illustrating an example of a relevant user/group processing process, according to methods and systems such as those disclosed herein. FIG. 32 thus depicts relevant user/group processing process 3200. Relevant user/group processing process 3200 begins with receiving the relevant group description from the deconstruction unit (3210). Next, relevant group description(s) are parsed into one or more group description statements (3220). Identity information is then received from the identity provision unit (3220). Such identity information can include the identity of the user in question, other users with whom the given user is associated, groups/departments/divisions/etc. with which the given user is associated, and other such information. Subsequently, relevant user/group processing process 3200 combines the relevant group description and identity information to form a subject/group statement (3230). In certain embodiments, such a subject/group statement can in fact be a definitive listing of specific groups and users affected by the given policy or policies. Following this, relevant user/group processing process 3200 concludes.

FIG. 33 is a simplified flow diagram illustrating an example of a relevant allowed application example processing process, according to methods and systems such as those disclosed herein. FIG. 33 thus depicts a relevant allowed application example processing process 3300. Relevant allowed application example processing process 3300 begins with the receipt of one or more relevant allowed application descriptions from the deconstruction unit (3010). This initial step involves collecting descriptions that are pertinent to the allowed application examples, as derived by the prior deconstruction/analysis phase.

Following the receipt of these descriptions, the embodiment depicted in FIG. 33 parses these one or more relevant allowed application descriptions into two distinct statements: an image evaluation description statement and an example allowed application description statement (3320). After parsing, the system performs two parallel operations, carrying out an image evaluation criteria process, which generates specific image evaluation criteria, and an allowed application process, which generates examples of allowed applications.

Thus, relevant allowed application example processing process 3300 sends the image evaluation description statement to a message generation unit (3310). This operation involves transmitting specific information related to image evaluation to the given message generation unit, ensuring that the message generation unit has the necessary details to process and generate relevant messages regarding image evaluation for the capture resource output in question. In a similar fashion, relevant allowed application example processing process 3300 sends the example allowed application description statement to the message generation unit (3330). This is then followed by an example allowed application process (3340), which results in processing the example allowed application description(s), in order to generate a statement regarding examples of allowed applications for use by subsequent components of the policy creation engine.

Finally, the image evaluation description and the example allowed application description statements having been processed, relevant allowed application example processing process 3300 concludes. The performance of the image evaluation criteria processing and example allowed application processing marks the end of relevant allowed application example processing process 3300, ensuring that the requisite information is available for subsequent message generation and machine learning (e.g., LLM) processing stages.

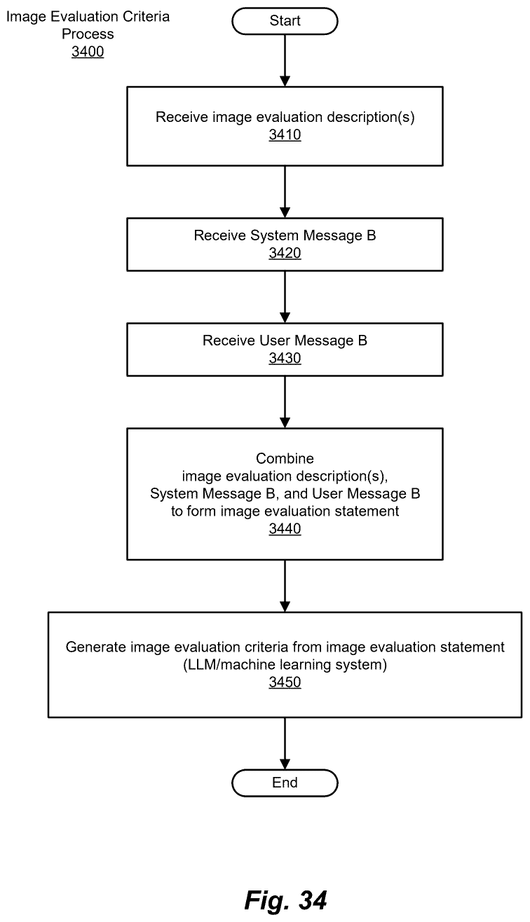

FIG. 34 is a simplified flow diagram illustrating an example of an image evaluation criteria process, according to methods and systems such as those disclosed herein. FIG. 34 thus depicts an image evaluation criteria process 3400, which generates image evaluation criteria by leveraging various sources of information and the statements representing that information. Image evaluation criteria process 3400 begins with receiving an image evaluation description, which captures the key characteristics or aspects if the given resource output needed to evaluate such resource output (3410). This description can be in a standardized format or free text, depending on the analysis system's design.

Next, in the embodiment depicted in FIG. 34, the analysis system receives two additional messages: a system message B (3420) and a user message B (3430). These statements provide supplementary information relevant to the generation of image evaluation criteria. System message B, as with others of the system statements discussed herein, can be a statement that guides the given machine learning system. As discussed in connection with FIG. 26, such information can guide the machine learning system in determining the technical details of the visual information in question, prior analysis results, and other such information, as may be useful in a message that provides appropriate guidance in the generation of the image evaluation criteria noted. User message B, on the other hand, is intended to provide fine-tuning of such criteria by allowing additional statements to be input by an administrator (e.g., by allowing an administrator to specify specific evaluation goals or focusing on certain image features).

Assuming such additional messages are present, as they are in FIG. 34, the analysis system combines them with the initial image evaluation description (3440). These statements are combined, in certain embodiments, by a message generation unit, which can involve techniques like information fusion, message summarization, or the like. This combined image evaluation statement can further encompass a richer understanding of the desired evaluation criteria, potentially incorporating both user intent and system-specific knowledge.

Finally, the process leverages a machine learning system (ML system), such as a large language model (LLM) to generate the image evaluation criteria (3450). The ML system, having been trained on a dataset of image evaluations and their corresponding criteria, is able to provide for the analysis of the image evaluation statement, considering the combined information from the initial description, system message, and user message, and translate it into a set of concrete evaluation metrics, or guidelines, for example. Image evaluation criteria process 3400 then concludes. Overall, image evaluation criteria process 3400 outlines an approach for generating image evaluation criteria using a combination of user input, system knowledge, and machine learning capabilities.

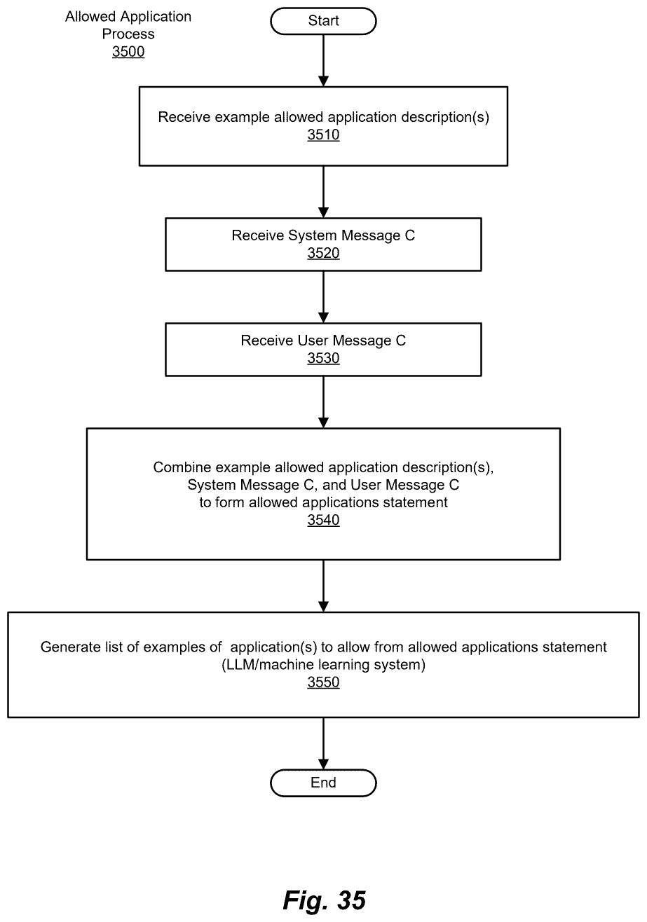

FIG. 35 is a simplified flow diagram illustrating an example of an allowed application process, according to methods and systems such as those disclosed herein. FIG. 35 thus depicts a process for defining one or more examples of applications that would be allowable in view of the given policy (depicted in FIG. 35 as an allowed application process 3500), which can be based on a system message, as well as a user message (e.g., for fine-tuning). Allowed application process 3500 starts by receiving a description of examples of allowed applications, which can be a list of specific applications, a set of features that can be used to determine those of allowed applications, or information regarding such applications in any other format that can be used to define what applications are considered permissible, among other such possible information (3510).

Next, in the embodiment depicted in FIG. 35, allowed application process 3500 receives two messages: a system message C (3520) and a user message C (3530). These statements provide supplementary information relevant to the interpretation and other processing performed on the description(s) of examples of allowed applications. For example, system message C might can include details about the current system state, security posture, and/or available resources, which may be pertinent to the interpretation of the description(s) of examples of allowed applications, in addition to guiding the interpretation and analysis thereof. For its part, user message C can reflect administrator preferences, specific details regarding known-good applications, and other such information intended to fine-tune the analysis.

Following receipt of the description(s) of examples of allowed applications and one or more messages such as those described above, allowed application process 3500 proceeds with combining the information from the allowed applications description, system message C, and user message C (3540). This combination operation, performed by a message generation unit, can involve integrating the details from all three sources and/or others, to create an allowed applications statement. Such combination can involve logical operations (e.g., applying filters based on system message C or user message C to the initial allowed applications description(s)), rule-based reasoning, and/or other operations that merge the information provided into a form appropriate for consumption by a machine learning system such as an LLM machine learning system. Such a statement can take the form of a definitive list of applications that are considered permissible or a set of clear criteria that define allowed applications. This list of examples of applications to allow serves as the final output of allowed application process 3500, which then concludes. The list of examples of applications to allow can be employed subsequently for a variety of purposes, including making a determination as to the appropriateness of a given resource's use by determining that resource's resource output, as described subsequently, but can also be used in dynamically configuring an application firewall, informing users of permitted applications, or feeding into a separate process that enforces application access control.

FIG. 36 is a simplified flow diagram illustrating an example of a relevant denied application example processing process, according to methods and systems such as those disclosed herein. FIG. 36 thus depicts a process for generating a list of examples of applications to deny (depicted in FIG. 36 as a relevant denied application example processing process 3600), based on a denied application description, system message D, and user message D. The process starts with the receipt of a description of relevant denied application examples from a deconstruction unit (3610). This description specifies the applications that should be denied or otherwise restricted, based on criteria elucidated in the applicable policy.

Next, relevant denied application example processing process 3600 parses the received denied application description(s) into a standardized format, which is referred to as a denied application description statement (3620). This parsing operation produces a statement in a form appropriate for combination with other statements and consumption by a machine learning system such as an LLM machine learning system, and can further involve structuring the information from the deconstruction unit into a format that can be easily processed in the subsequent steps.

Following this parsing operation, relevant denied application example processing process 3600 reflects the receipt of two messages: a system message D (3630) and a user message D (3640). In a fashion comparable to the operations depicted in FIG. 35, these statements provide supplementary information relevant to the interpretation and other processing performed on the description(s) of examples of denied applications. For example, system message D can contain details regarding the reason or other basis for application denial (e.g., security vulnerabilities, licensing restrictions, and so on). For its part, user message D can reflect specific user characteristics, preferences regarding denied applications, specific details regarding known-bad applications, and other such information intended to fine-tune the analysis.

Once the inputs described above are received, relevant denied application example processing process 3600 combines the denied application description statement, system message D, and user message D to form a denied applications statement (3650). This combination operation, performed by a message generation unit, can involve integrating the details from all three sources and/or others, to create a denied applications statement. Such combination can involve logical operations (e.g., applying filters based on system message D or user message D C to the initial allowed applications description(s)), rule-based reasoning, and/or other operations that merge the information provided into a form appropriate for consumption by a machine learning system such as an LLM machine learning system, creating a statement that encapsulates the rationale and criteria for application denial, in certain embodiments.

Finally, relevant denied application example processing process 3600 utilizes a machine learning system (e.g., an LLM machine learning system) to generate a list of examples of applications to deny from the denied applications statement (3660). The LLM analyzes the combined information in the denied applications statement to identify patterns, relationships, and/or attributes that characterize the denied applications. Based on this analysis, the LLM generates a list of application examples that share these characteristics. Application output demonstrating such characteristics therefore indicates an application that should be considered as a candidate for denial. Having generated the list of denied application examples (3660), relevant denied application example processing process 3600 then concludes.

FIG. 37 is a simplified flow diagram illustrating an example of another portion of the policy generation process begun in FIG. 31, according to methods and systems such as those disclosed herein. FIG. 37 illustrates examples of additional operations (depicted in FIG. 37 as a policy generation process 3700), as noted in the discussion of policy generation process 3100. That being the case, policy generation process 3700 is a continuation of policy generation process 3100, by way of connector “F”, and is an example of that portion of a process for generating a policy statement that governs the selection of one or more policies, in order to control access and resource usage for a specific subject, group, and/or the like. As is noted in connection with FIG. 31, connector “F” represents information that, in certain embodiments, includes one or more subject/group statements, image evaluation criteria, examples of allowable applications, and/or examples of applications which are to be denied. Policy generation process 3700 depicts the intake of these inputs via connector “F”, which provide a basis for the application of the policy in question.

Policy generation process 3700 thus begins with the receipt of a subject/group statement (3710). This statement acts as the foundation for policy selection, defining the users or groups to whom the policy will apply, as well as users and/or groups that will (or could) be affected as a result of such policy/policies being given effect. Such a subject/group statement can encompass information such as usernames, group IDs, and/or one or more other identifiers that delineate the affected user(s).

Policy generation process 3700, in the embodiment depicted in FIG. 37, also provides for the receipt of image evaluation criteria (3720). As noted earlier, such image evaluation criteria for a business application can include, for example, interface layout, professional functionality, branding and business orientation, access control and administration, and/or other such aspects of the application in question.

Policy generation process 3700, in the embodiment depicted in FIG. 37, further provides for the receipt of a list of examples of applications to allow (3730). This list provides examples of applications (and/or, in certain embodiments, their features) that affected users within the defined subject/group are authorized to use (e.g., for accessing or manipulating the organization's data).

Still further, policy generation process 3700 provides for the receipt of a list of examples of applications to deny (3740). This list serves as a complementary input, specifying applications (and/or, in certain embodiments, their features) from which users within the subject/group are prohibited.

Once the foregoing inputs been received by policy generation process 3700, policy generation process 3700 receives a system message E (3750) and a user message E (3760). These messages provide supplementary information and guidance relevant to shaping application of the policy. System message E provides context to a machine learning system (e.g., an LLM machine learning system) regarding how the foregoing inputs should be interpreted, at least in general terms, conveying details about the policy's intent, capabilities or limitations regarding resources and/or access control, and/or other such information, as may be advantageous to applying the policy in question. User message E, on the other hand, can be employed to fine-tune the interpretation of resource output, system message E's intent and/or effect(s), user or administrator preferences, specific policy requirements, and/or the like.

After receipt of the aforementioned inputs, policy generation process 3700 combines the inputs to form a policy statement (3770). This consolidation step involves merging the information from the subject/group statement, image evaluation criteria, allowed and denied application example lists, and system and user messages, and is performed by a message generation unit in certain embodiments. The resulting policy statement serves as the basis for taking action with regard to the given resource, based on that resource's resource output, by giving effect to the policy in question (and in so doing, control such a resource based on authorized users or groups, permitted applications, prohibited applications, and/or other access control measures or security protocols).

Finally, policy generation process 3700 generates a policy name and description by providing the formulated policy statement to a machine learning system (e.g., a LLM machine learning system) (3780). The LLM analyzes the policy statement to extract details and translate them into a policy name and description (e.g., in a descriptive language such as a natural language, which in certain embodiments can be a human-readable format). Having generated the recommended policy name and description, policy generation process 3700 then concludes.

FIG. 38 is a simplified flow diagram illustrating an example of yet another portion of the policy generation process begun in FIG. 31, according to methods and systems such as those disclosed herein. FIG. 38 depicts additional operations (depicted in FIG. 38 as a policy generation process 3800), as noted in the discussion of policy generation process 3100. That being the case, policy generation process 3800 is a continuation of policy generation process 3100, by way of connectors “H” (from FIG. 37) and “G” (from FIG. 31). Policy generation process 3800 is an example of that portion of a policy generation process that involves sending policy information to a user interface, potentially followed by saving, then implementing the policy, potentially subject to administrator approval.

Policy generation process 3800 receives the recommended policy name and description by way of connector “H”, and sends the recommended policy name and description to the user interface (e.g., via a web server such as that described earlier) (3810). This provides the administrator with a high-level understanding of the recommended policy, as well as, in certain embodiments, a justification therefor. At this point, the analysis system also causes policy generation process 3800 to send identifiers for the allowed application examples and the denied application examples to the user interface (e.g., via web server), which can be accomplished by sending one or more allowed application identifiers and/or denied application identifiers (3820, 3825). This operation can inform the administrator of specific applications that are allowed or denied by the policy identified, for example. As a result, the analysis system displays the relevant policy information in the user interface, including allowed application examples, denied application examples, (potentially) affected users or user groups, and the recommended policy name and description (3830). This view enables the administrator to review the full details of the policy and its effects. Once displayed (or as part of being display), the recommended policy name and description, as well as other information such as the examples presented and/or their identifiers, can be stored (3840).

Policy generation process 3800 then proceeds to a determination as to whether administrator approval is needed for the given policy to be implemented and appropriate action(s) taken (3850). In the case in which the administrator approval is not needed, policy generation process 3800 proceeds with implementing the given policy (3860). If, on the other hand, if administrator approval is needed (3850), policy generation process 3800 proceeds with making a determination as to whether administrator approval has been received (3870). As in the earlier case, if the requisite administrator approval is received, policy generation process 3800 proceeds with implementing the given policy (3860). Conversely, if approval is not received from the administrator, implementation of the policy is prevented (3880). In any of these cases, once the given policy has been implemented (or not), policy generation process 3800 concludes.

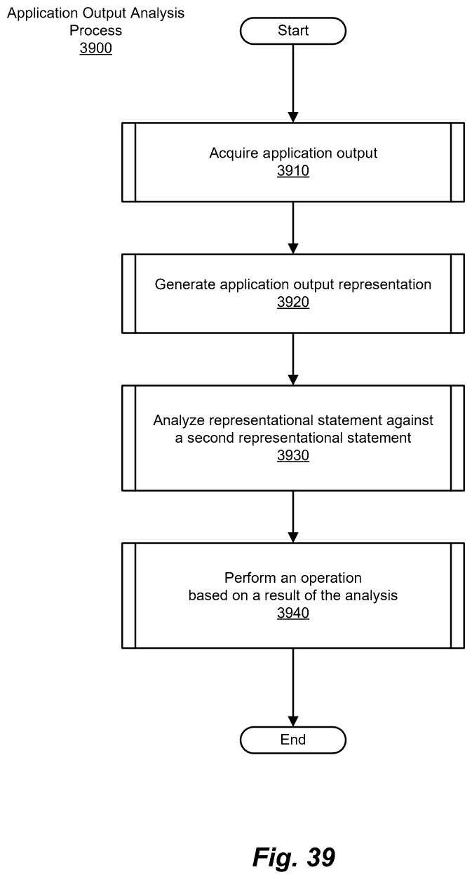

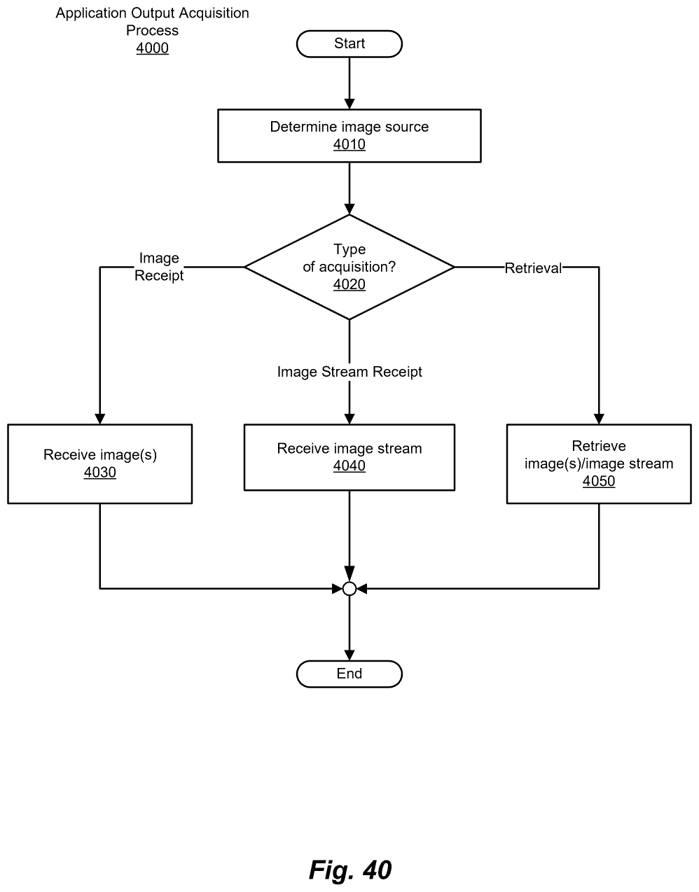

FIG. 39 is a simplified flow diagram illustrating an example of an application output analysis process, according to methods and systems such as those disclosed herein. FIG. 39 thus depicts an application output analysis process 3900, which analyzes a first representational statement against a second representational statement, potentially to determine if they are equivalent or similar, and in so doing, determine the operation or operations to be performed with regard to the given resource (e.g., application). Application output analysis process 3900 begins by acquiring the output of a resource such as an application output, which can be screen output, data output, results generated, changes in data or its storage, or other such effects, as might be caused by a software application (3910). An example of such an application output acquisition process is discussed in connection with FIG. 40, subsequently.

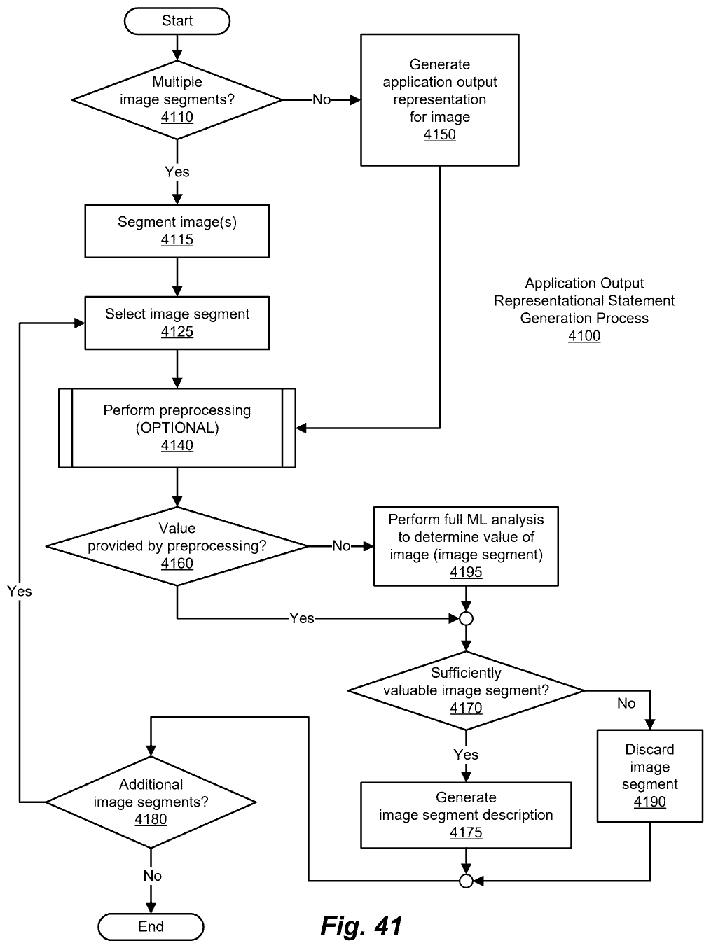

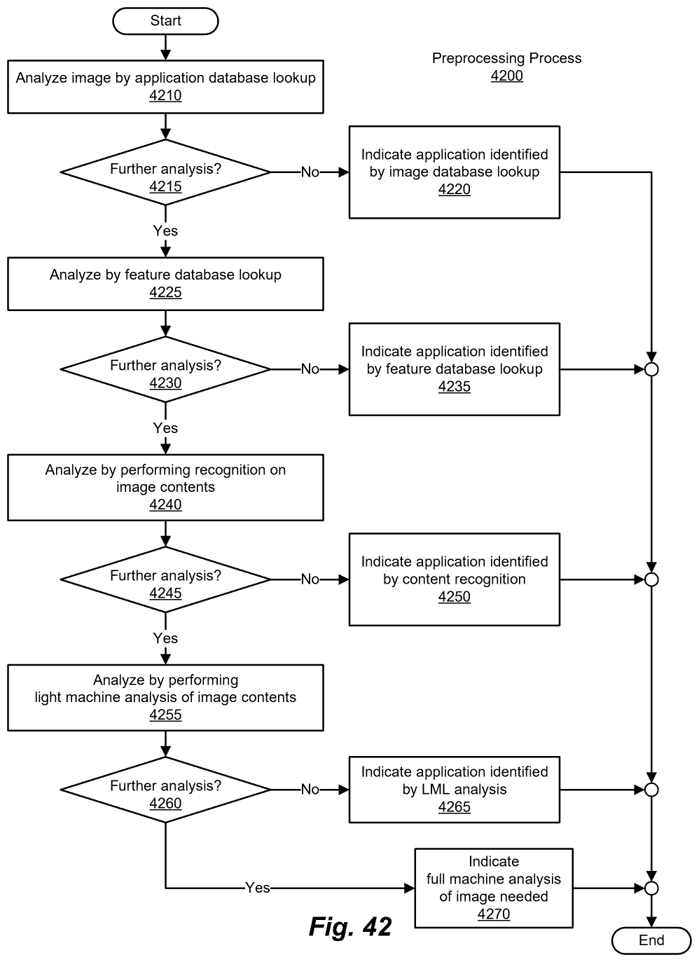

Next, application output analysis process 3900 generates a representation of the acquired application output (3920). This representation can be a data structure, a textual description (e.g., in a descriptive language such as a natural language), or descriptive information in another format that captures the essential characteristics of the application output acquired. An example of the generation application output representation is discussed in connection with FIGS. 41 and 42, subsequently.

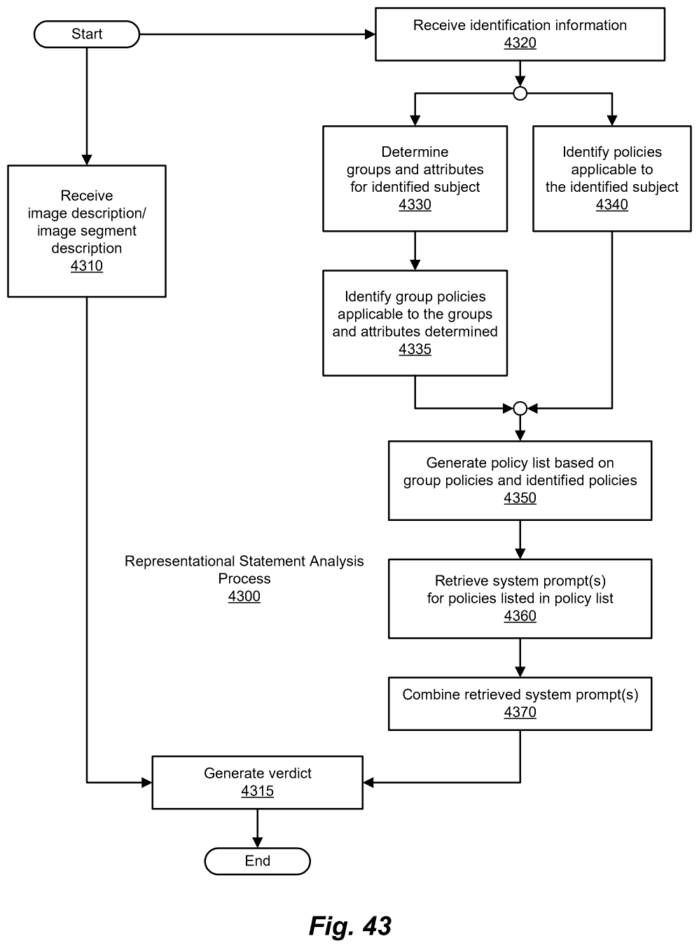

Following the generation of this representation, application output analysis process 3900 analyzes the generated representational statement against a second representational statement (3930). This second representational statement serves as a reference point for such a comparison, and comprehends a predefined representation that embodies a desired application output, a representation derived from a previous execution of the same application, the product of a machine learning process (e.g., an LLM machine learning process), or other such representation. An example of such an analysis process is discussed in connection with FIG. 43, subsequently.

Finally, the results of the foregoing analysis are used to make a decision as to the action or actions to be performed as a result (3940). If the foregoing analysis determines that the representational statements are sufficiently equivalent, the action or actions are taken, and conversely, if the foregoing analysis determines that the representational statements are not sufficiently equivalent, no action is taken. Application output analysis process 3900 then concludes.

FIG. 40 is a simplified flow diagram illustrating an example of an application output acquisition process, according to methods and systems such as those disclosed herein. As noted in the discussion of application output analysis process 3900@3910, FIG. 40 depicts a process for acquiring application output, which can be a single image, a stream of images (video information), or retrieved data, depending on the chosen acquisition method at the outset, and is depicted in FIG. 40 as an application output acquisition process 4000. Application output acquisition process 4000 begins by determining the type of acquisition to be performed. If a single image is to be analyzed (depicted as an image receipt path), the process proceeds with receipt of the image (4030). Such acquisition can be accomplished by receiving the image over a network connection, capturing the image from a hardware device, or other such mechanisms. Once such an image has been received, application output acquisition process 4000 concludes, indicating the successful acquisition of a single image.

On the other hand, if a continuous stream of images, often referred to as video information, is desired (depicted as an image stream receipt path), application output acquisition process 4000 proceeds to receiving the image stream (4040). Such an operation can involve establishing a connection with a video source and then continuously acquiring and processing the individual frames that make up the video stream, for example. Once such an image stream has been received, application output acquisition process 4000 concludes, indicating the successful acquisition of the image stream.

In the alternative, the application output can be retrieved from a designated location or storage system, rather than being received from a given source (4050). Such retrieval can encompass various alternatives, depending on the resource in question (e.g., application). For instance, application output acquisition process 4000 can retrieve image data associated with a specific image (e.g., the image itself, metadata, timestamps, and/or other such information), or the process can retrieve configuration settings or control parameters relevant to the processing of an image. The retrieval method can involve database queries, file system access, communication with other applications or services, and/or other such mechanisms. Following successful retrieval, application output acquisition process 4000 proceeds with providing the retrieved information to other components in the analysis system, which utilize the retrieved data to make a determination such as those described elsewhere herein. Once the image, image stream, or other visual information has been retrieved, application output acquisition process 4000 concludes, indicating the successful acquisition thereof.

FIG. 41 is a simplified flow diagram illustrating an example of an application output representational statement generation process, according to methods and systems such as those disclosed herein. FIG. 41 thus depicts a process for analyzing the output of a given resource (resource output such as application output (e.g., visual information, such as an image, image stream, or the like)) and generating a representation of that content, in some manner of interpretable description (e.g., descriptive information in a descriptive language that can be a machine-readable language, a natural language, or the like), which can then be used in subsequent processing (depicted in FIG. 41 as an application output representational statement generation process 4100), as noted earlier in connection with FIG. 39 at 3920.

Application output representational statement generation process 4100 begins with a determination as to whether the given input consists of multiple image segments, which can be individual image elements (features), individual images, parts of a larger image, or the like (4110). If the input comprises multiple segments, the process first segments the image(s) (4115). This segmentation involves dividing the image into smaller, more manageable, individual elements (e.g., window elements) that can be analyzed individually. Following segmentation, the process enters a loop that iterates through each image segment, as is now described. Inside this loop, one of the image segments is selected (4125), and, optionally, a preprocessing of the selected image segment is performed (4140). Such preprocessing can involve various mechanisms to quickly and efficiently decide if a given segment has the possibility of having sufficient value. For example, such preprocessing can include operations such as those described earlier, such as identifying window elements standard to the given GUI, screen backgrounds, standard applications (e.g., a clock app), elements containing no information, and other such elements, as might appear in a given GUI.

Returning to the decision as to whether multiple image segments are to be processed (4110), if the application output does not include multiple image segments, the process proceeds with generating the application output representation for the given image (4150). Once again, preprocessing can be performed (4140), though such preprocessing is optional. An example of such preprocessing is discussed in connection with FIG. 42, subsequently.

Once the aforementioned preprocessing has been performed (if indeed, such preprocessing is to be performed), a determination is made as to the value of the given segment (4160). In the case in which such preprocessing is able to determine a value for the given segment, the process proceeds with making a determination as to whether the image segment is sufficiently valuable to warrant the generation of an image segment description (4170). Such a value threshold can be application-specific, and can be based on a confidence score generated by the machine learning model or a human-defined criterion.

In the case in which the segment has sufficient value, and image segment description is generated (4175). Such a description can be a textual summary of the segment's content or a set of keywords that capture its key features, for example. A determination is then made as to whether additional segments remain to be analyzed (4180). This alternative involves moving to the next segment in the image or the next item in a queue or data structure that stores the segments. If further segments remain to be analyzed, the process loops to the selection of the next image segment (4125), proceeding to the next image segment for analysis. In the alternative, application output representational statement generation process 4100 concludes.

Returning to the determination as to whether the given segment has sufficient value to warrant further analysis, if the given image segment does not possess sufficient value, the given image segment is discarded (4190), and the determination discussed above as to whether additional segments remain (4180), as well as iteration or conclusion, are performed.

Returning to the determination with regard to the aforementioned optional preprocessing (4160), in the case in which such preprocessing is unable to determine the value for the given segment, the process can proceed with performing a full machine learning analysis of the segment, in order to determine the segment's value (4195). Such a full machine learning analysis is performed on the image segment to obtain a definitive value (e.g., by extracting features or characteristics from the image segment and using them to generate a numerical value or classification). In such case, process again proceeds with making a determination as to whether the segment in question is sufficiently valuable (4170), and the associated operations (4175, 4190) and determination as to iteration (4180) performed. Subsequently, as noted, application output representational statement generation process 4100 will conclude.

FIG. 42 is a simplified flow diagram illustrating an example of a preprocessing process, according to methods and systems such as those disclosed herein. FIG. 42 depicts a process for identifying an application that is compatible with a given image (depicted in FIG. 42 as a preprocessing process 4200), as noted earlier in connection with FIG. 39 at 3930. As noted, preprocessing process 4200 provides the ability to quickly and efficiently decide if a given segment has the possibility of having sufficient value. For example, such preprocessing can include operations such as those described earlier, such as identifying window elements standard to the given GUI, screen backgrounds, standard applications (e.g., a clock app), elements containing no information, and other such elements, as might appear in a given GUI. In fact, as noted earlier, such segments can be digital images that have been broken into segments corresponding to, for example, application output in the windows of a GUI, portions of one or more digital images, screen background, window elements (e.g., title bars, menu bars, icons, application and company logos, window controls, scroll bars, content areas, tabs, and so on), or the like, which can then be subject to a determination as to each such segment's value. Such valuation is performed by segment value determination unit 940, which places a value on each such segment based on, for example, the importance of each such segment in view of the context and applicable policies in the given situation. For example, window elements such as window controls and scroll bars, and screen backgrounds, have little or no intrinsic value when determining whether a given policy applies to a given application. By contrast, elements such as content areas, application and company logos, and the like provide valuable information as to whether a given policy applies to a given application. By making such distinctions, a system according to methods and systems such as those described herein is able to winnow down the amount of information needing to be subjected to further analysis, improving the efficiency of the policy determination needing to be made. Further, by sufficiently isolating elements such as application and company logos (e.g., sufficient to allow identification of such screen elements), such a system can make decisions for certain applications/resources/content quickly, simply by identifying the application/resource/content in question by its application and company logo, avoiding the need for further processing of the application's/resource's output (and potentially, avoiding the need for policy processing, as where no applications from a certain company are allowed in the given context, for example).

Preprocessing process 4200 begins by analyzing the image element by performing an image lookup in an image database (4210). Such an application database can contain information regarding various applications and the image characteristics each exhibits. Such a process for searching the application database can, for example, involve matching extracted image features with pre-defined criteria associated with applications within the database.

A determination is then made as to whether further analysis is needed, or, in the alternative, the image database lookup has provided the requisite information as to the segment's value (4215). In the case in which no further analysis is needed to determine the segment's value, an indication is made as to the resource's identification, such that (in the case of an application) the application, and so it's value, were able to be identified by way of the image database lookup (4220). In this case, preprocessing process 4200 then concludes.

In the alternative, where such identification was not successful and further analysis is needed, the segment is analyzed by way of a feature database lookup (4225). A determination is once again made as to whether further analysis is needed, or, in the alternative, the feature database lookup was able to successfully identify the resource in question (4230). In the case in which no further analysis is needed to determine the segment's value, an indication is made as to the resource's identification and the value the resource (e.g., application) (4235). In this case, preprocessing process 4200 then concludes.

In the alternative, where such identification was not successful and further analysis is needed, the segment is analyzed by way of performing recognition of image contents (4240). A determination is once again made as to whether further analysis is needed, or, in the alternative, the image recognition performed was able to successfully identify the resource (e.g., application) and its value (4245). In the case in which no further analysis is needed to determine the segment's value, an indication is made as to the resource's identification and the value the resource (e.g., application) (4250). In this case, preprocessing process 4200 then concludes.

In the last alternative depicted in FIG. 42, where such identification was not successful and further analysis is needed, the segment is analyzed by way of performing light machine analysis of the image segment's contents (4255). As before, a determination is made as to whether further analysis is needed, or, in the alternative, the light machine learning analysis performed was able to successfully identify the resource (e.g., application) and its value (4260). In the case in which no further analysis is needed to determine the segment's value, an indication is made as to the resource's identification and the value the resource (e.g., application) (4265). In the alternative, the foregoing analyses having been unable to successfully identify the resource (e.g., application) and its value an indication is made that a full machine learning analysis of the segment is needed (4270). In either case, preprocessing process 4200 then concludes.

FIG. 43 is a simplified flow diagram illustrating an example of a representational statement analysis process, according to methods and systems such as those disclosed herein. FIG. 43 thus depicts a process for analyzing a representational statement, in order to assess the statement's validity and determine if the resource output in question meets specific criteria in generating a given verdict (e.g., compliant, noncompliant, or irrelevant, in the given embodiment), and is depicted as a representational statement analysis process 4300. Representational statement analysis process 4300 performs such analysis in the manner previously noted in connection with FIG. 39 (3930).

Representational statement analysis process 4300 begins with the receipt of an image description/image segment description, for example, that is to be analyzed (4310). This description is used as input to a machine learning system such as an LLM machine learning system, in order to generate the aforementioned verdict (4315). Such image information, as well as the identification information (e.g., subject identity information) discussed subsequently, can be received from an endpoint agent such as that described earlier herein, for example. The functionality of such an LLM machine learning system can be implemented in the manner of multimodal machine learning model 1750 of FIG. 17A or multimodal machine learning model 2970 of FIG. 29, for example.

Identification information is also received at the beginning of representational statement analysis process 4300 (4320). This information can be a username, a user identifier code, a description of the user and their position within the given organization, or any other data that serves to uniquely identify the subject of interest (as well as other information identifying a subject's organization, division, department, and/or the like, potentially). As noted above, such identification information can be received from an endpoint agent such as that described earlier herein, for example. In this path through representational statement analysis process 4300, the identification information received is used to determine groups and attributes for the subject identified by the identification information (4330), and so group policies applicable to the identified group's and attributes determined are also identified (4335). Such group policy identification can involve matching the retrieved groups and attributes of the subject against pre-defined group policies to determine which policies are relevant. The identification information received is also used to identify policies applicable to the identified subject, in specific (4340). Such subject identification can involve querying a database or knowledge base to retrieve relevant information about the subject based on the identification information provided. The subject identification information can, for example, specify the data or criteria needed to determine whether a policy is relevant to the subject in question.

Having identified group policies and policies applicable to the identified subject, representational statement analysis process 4300 proceeds with generating a list of policies based on this information, which is referred to herein as a policy list (4350). One or more system prompts are then retrieved for the policies listed in the policy list (4360). Subsequently, the process combines the retrieved system prompts from applicable policies listed in the policy list thus generated (4370). This merging of prompts can involve consolidating common elements and/or generating a single, unified prompt that encompasses the requirements of the relevant policies listed in the policy list.

Representational statement analysis process 4300 then generates a verdict (e.g., such as that described elsewhere herein) based on the combined system prompts and the image/segment/other description received (4315). This verdict involves assessing the identification information in view of the criteria/requirements/description(s)/other information specified in the combined prompts. The ultimate outcome represented by the verdict (e.g., compliant, noncompliant, or inconclusive) reflects the assessment performed by the machine learning system (e.g., LLM machine learning system) in light of the foregoing inputs. Representational statement analysis process 4300 then concludes, having completed the process of analyzing the representational statement in question.

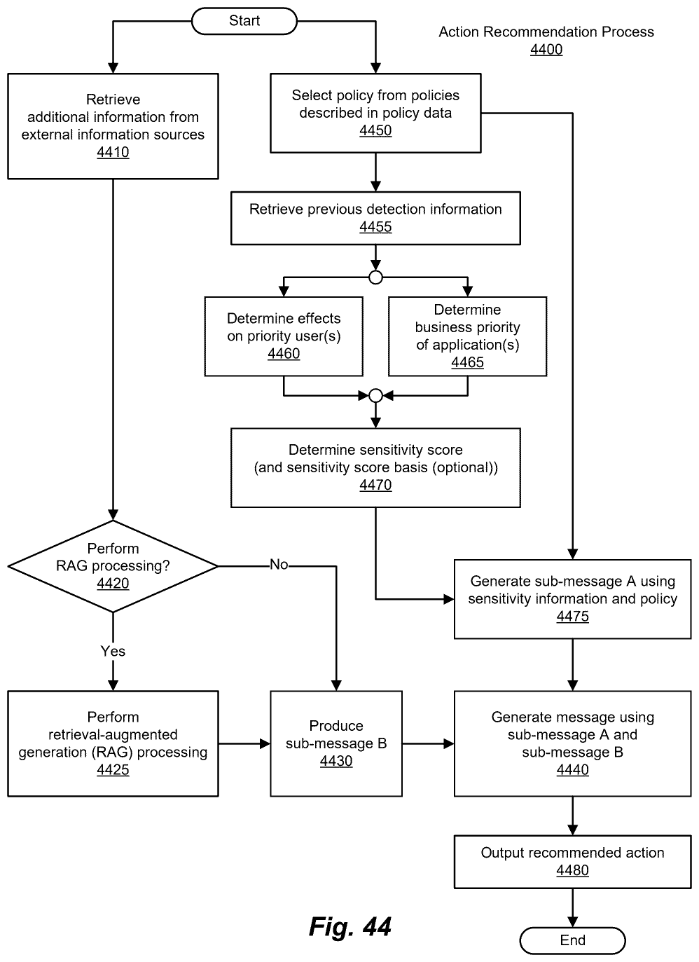

FIG. 44 is a simplified flow diagram illustrating an example of an action recommendation process, according to methods and systems such as those disclosed herein. FIG. 44 thus depicts a process for generating a recommended action in response to a detected application and prioritizing that action based on business priorities (depicted in FIG. 44 as an action recommendation process 4400). Action recommendation process 4400 begins by retrieving additional information regarding resource features (e.g., application features) from one or more external information sources that can be used to drive policy data (4410). Such external information sources maintain information regarding various applications and the policies that govern their use, policy statements (whether internal or external to the organization), white papers (whether internal or external to the organization), threat intelligence data, updates on the given resource's (e.g., application's) functionality, and other such information/information sources, such as those described subsequently.

The additional information retrieved can then be used to perform retrieval-augmented generation (RAG). To this end, a determination is made as to whether such additional information is to be used in RAG processing (4420). In the case in which such RAG processing is to be performed, the RAG processing is performed (4425). Such RAG processing, described elsewhere herein, can be performed to leverages retrieved information to enhance the generation of a recommended action, and can be subsumed into the machine learning processing (e.g., LLM machine learning processing) used to inform the verdict ultimately produced.

Once the requisite RAG processing has been performed (or a determination is made that such RAG processing is not to be performed, and the results of the additional information retrieval are to be used in the form in which they were received), the results thereof are used to produce a sub-message B (4430). It is to be appreciated at this juncture that, in certain situations, some or all of the additional information retrieved may be in a form appropriate for inclusion in sub-message B, and so no further processing (e.g., RAG processing) is warranted. In treating such additional information in this manner, the computational and storage requirements such RAG processing entails can be reduced or eliminated.

Returning to the beginning of action recommendation process 4400, one or more policies are selected from the policies described in the policy data received (4450). The selected policy or policies are then used as a basis for retrieving previous detection information when using such policies (4455). In supporting such functionality, the analysis system tracks past detections of such resource usage, such information be useful for assessing risk and/or determining appropriate actions that might be recommended by the analysis system.

At this juncture, the effects on priority users are determined (4460), and the business priority of the resources (e.g., applications) in question determined (4465). The determination with regard to the effects of the detected application on priority can involve consulting a list of designated priority users and assessing the potential impact of the application on their work or activities, but can also employ LLM machine learning techniques to predict such effects based on such information. Similarly, the determination as to the business priority of the given resource (e.g., application) can involve evaluating the resource's (e.g., application's) potential impact on critical business operations, for example.

The foregoing information is used to determine a sensitivity score and, optionally, the basis for the sensitivity score thus determined, which can comprehend the potential severity of infraction or risk associated with the identified application detected (4470). As noted earlier, such a sensitivity score can take into account a variety of factors, including the level of sensitivity (importance, criticality) of the users, groups, and applications/resources involved, as well as effects thereon.

Returning to the selection of one or more policies from those described in the policy data received (4450) action recommendation process 4400 also provides such information for the generation of a sub-message A, combining this information with the sensitivity information described above (4475). Action recommendation process 4400 then combines sub-message A and sub-message B, and generates a final message that reflects the action or actions recommended by the analysis system (4440). Such combination and generation can be performed by a cumulative understanding unit such as cumulative understanding unit 1780 of FIG. 17B or cumulative understanding unit 3060 of FIG. 30.

Finally, the recommended course of action (the recommended action or actions) is output, in the case of an application, such recommendation considering the business priority of the application (determined earlier), the potential effects on priority users (determined earlier), and the message content generated through sub-messages A and B (or message B alone if RAG processing was not employed). The nature of the recommended action can represent a decision to allow the application, deny the application, restrict the application's operation or use, quarantine the application, or take some other appropriate action. Action recommendation process 4400 then concludes.

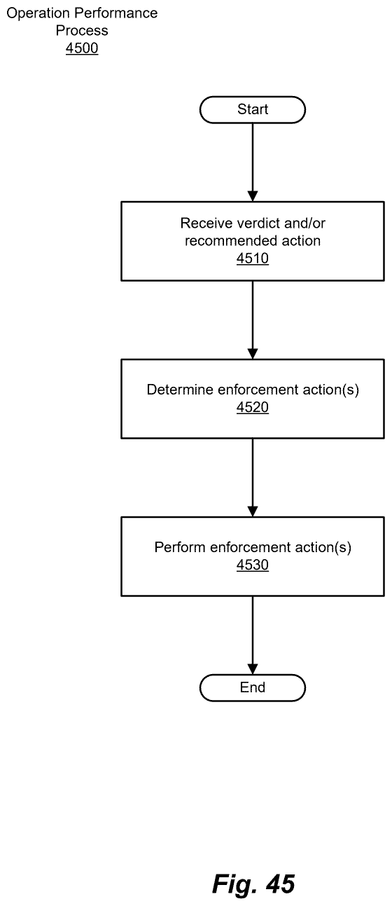

FIG. 45 is a simplified flow diagram illustrating an example of an operation performance process, according to methods and systems such as those disclosed herein, and so illustrates a process for receiving a verdict, determining an enforcement action, and performing the enforcement action (depicted in FIG. 45 as an operation performance process 4500), as noted earlier in connection with FIG. 39 at 3940.

Operation performance process 4500 can begin with the receipt of a verdict such as that generated by representational statement analysis process 4300, directly, and/or in the alternative, with the action or actions recommended as a result of action recommendation process 4400 (4510). Next, a determination is made as to what enforcement actions, if any, need to be taken based on the verdict received (4520), and can involve evaluating the verdict and referencing pre-defined rules or guidelines that map verdicts to specific enforcement actions. Following the determination of enforcement actions, operation performance process 4500 proceeds with performing those actions (4530). Operation performance process 4500 then concludes, indicating the completion of the process for determining and performing enforcement actions based on the verdict received.

### Example Application of Machine Learning to Security Determination Processes

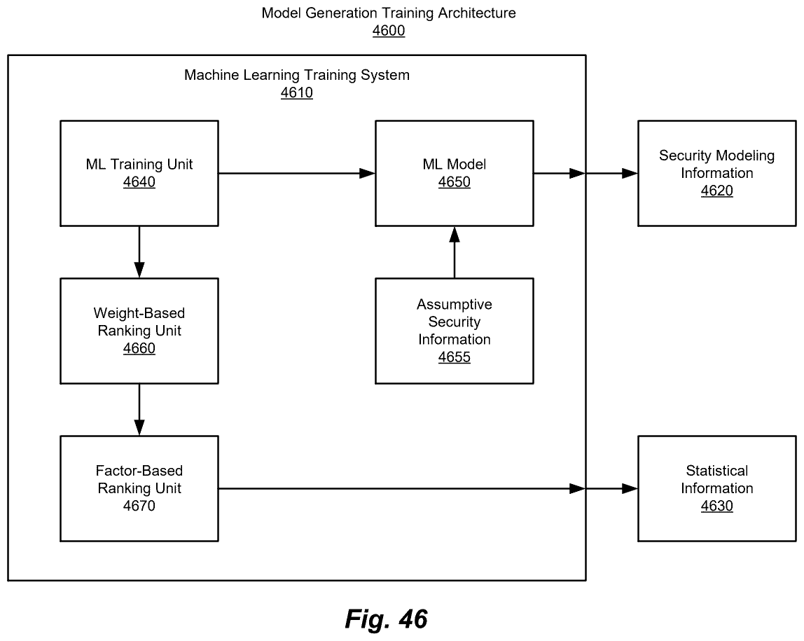

FIG. 46 is a simplified block diagram illustrating an example of a security model generation training architecture, according to methods and systems such as those disclosed herein, as might be used to train a security model generation unit. FIG. 46 thus depicts a security model generation training architecture 4600, which includes a machine learning training system 4610. Machine learning training system 4610 generates security modeling information 4620 and statistical information 4630 (information regarding the likely effects of the security context on the risk assessment performed in applying the policy in question, among other statistical information). In so doing, security model generation training architecture 4600 is able to “learn” from prior security scenarios, and so provide some level prediction as to the conditions and performance that might be encountered presently. Further, such techniques can be used to cleanse data by learning not only the likelihood of a given piece of information containing an error (or conversely, the accuracy of a given piece of information), but also the types of errors (error type) a given piece of information may contain, and do so based on the source of the information. These and other machine learning analysis operations allow methods and systems such as those described herein to automatically process the information used as inputs to the security management algorithms performed by machine learning systems such as those described herein (thus doing so without human intervention, nor interpretation of that information, and while improving the accuracy and dependability of the information input, as part of effecting the given policy/policies), thereby resulting in security determinations that are faster, more efficient, and more accurate, resulting in better decisions than would otherwise be possible.

In order to generate security modeling information 4620 and statistical information 4630, machine learning training system 4610 includes a machine learning (ML) training unit (depicted in FIG. 46 as an ML training unit 4640), which is communicatively coupled to a machine learning model (depicted in FIG. 46 as a ML model 4650) that also can take as input assumptive security information 4655 (e.g., information regarding acceptable resource/their usage, unacceptable resources, unacceptable usage, acceptable/unacceptable effects, and so on). In one implementation, ML training unit 4640 is implemented using a multi-layer perceptron (MLP) architecture that employs regularization. As such, ML training unit 4640 can be a feedforward artificial neural network model that maps large sets of input data (e.g., information regarding various risk characteristics and potential risk characteristics (e.g., a risk profile), in view of various factors) onto a set of appropriate outputs. As will be appreciated in light of the present disclosure, assumptive security information 4655 can include various (expected) values for various of these characteristics.

ML training unit 4640 can include multiple layers of nodes in a directed graph, with each layer fully connected to the next. Except for the input nodes, each node acts as a neuron (or processing element) with a nonlinear activation function, as described elsewhere herein. As will be further appreciated, MLP techniques can provide salutary effects in the methods and systems such as those described herein due at least in part to the ability of such techniques to solve problems stochastically, which allows for approximate solutions of extremely complex problems such as fitness approximations of the characteristics described herein. Such MLP techniques are well-suited to situations such as those considered herein, at least as a result of the large number of parameters involved in each of the possible factors affecting the security stance in question in these various circumstances, particularly when interactions between such parameters are considered. That being the case, such solutions can facilitate not only improvements in the prediction of security factors, but also in the efficiency and overall accuracy of the process by which such predictions are made.

ML training unit 4640 thus receives inputs from ML training unit 4640 and assumptive security information 4655. ML training unit 4640 determines the impact of various behavioral factors (e.g., the circumstances described earlier herein) on potential solutions, and maps information that may affect such security stance onto corresponding output sets. Such output sets can include individual parameters, attributes, and other factors, as well as combinations of such factors. ML training unit 4640 generates a machine learning model (depicted in FIG. 46 as a security ML model 4650), and so is communicatively coupled thereto. ML training unit can perform such generation by mapping the aforementioned output sets onto security ML model 4650 as an MLP model. In so doing, such mapping of the output sets into the MLP model is dynamic and automatic, and so can be accomplished without human intervention. That being said, security ML model 4650 will typically take assumptive security information 4655 as input. Security ML model 4650 can thus include data that is based on current dynamic information and existing information, as part of the training operations performed. One or more constraints may also be set. ML training unit 4640 can then vary one or more algorithm parameters, environmental parameters, and/or other parameters to take such constraints into consideration and best meet them.

Security ML model 4650 can thus map output sets to generate an MLP model. Security ML model 4650 will typically provide for multiple layers of nodes in a directed graph or graphs, with each layer fully connected to the next. This neural network can be used to identify acceptable/unacceptable/irrelevant resources/resource usage, as well as circumstances that may affect outcomes and/or give rise to such outcomes, and can account not only for the given set of conditions, but also the interactions between such conditions. Security ML model 4650, having interacted with ML training unit 4640 and having received assumptive security information 4655, can then be used to produce security modeling information 4620. As will be appreciated in light of the present disclosure, a determination can be made as to whether security modeling information 4620 appears to be sufficiently accurate (e.g., such that a given threshold for accuracy is met or exceeded). In this manner, a feedback loop of sorts is effected, wherein security ML model 4650 can be adjusted based on the sufficiency of security modeling information 4620, in order to arrive at a machine learning model that provides the requisite level of confidence in its output. The information that results can then be used to inform a security model.

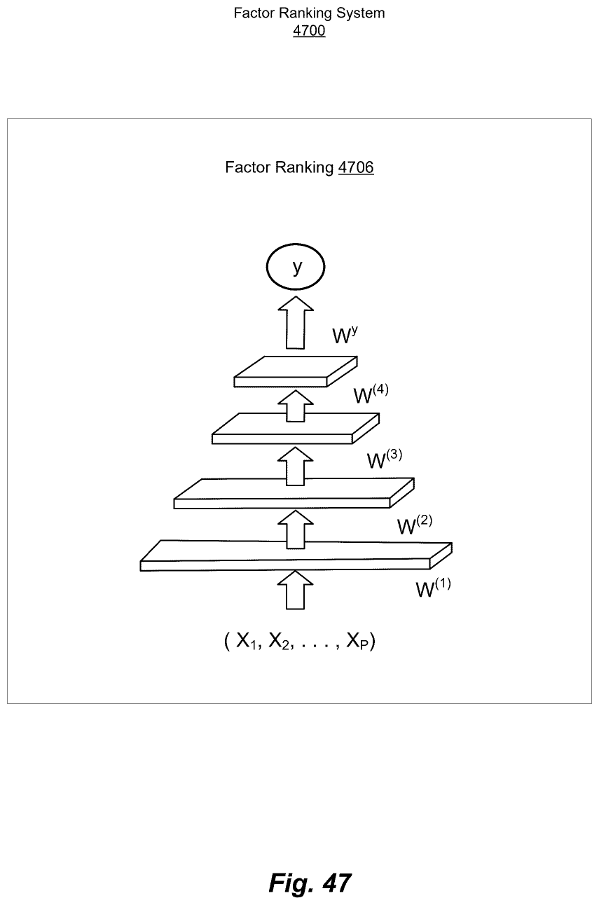

ML training unit 4640 also provides information to a weight-based ranking unit 4660, which uses this information to generate weighting information. Such weight-based ranking is described in further detail in connection with FIG. 47, subsequently. ML training unit 4640 communicates information, such as the impacts on outcomes that have been determined, to weight-based ranking unit 4660. Weight-based ranking unit 4660 assigns a weight to each parameter based on the parameter's impact on the given outcome within the environment in question. Weight-based ranking unit 4660 assigns a weight to each interaction of the parameters with the environment based on the interaction's impact on the security stance produced. Weight-based ranking unit 4660 then compares the effects of such interactions, based on various sets of parameters.

Weight-based ranking unit 4660 can, for example, assign a magnitude value of weight based on the impact of a given factor's effect on a given outcome. A larger weight value is assigned to certain factors (e.g., effects on high-priority users) than other factors (e.g., overall effect on the subject's productivity). The ranking of such factors by weight-based ranking unit 4660 is then performed by interpreting the weights assigned thereto. Weight-based ranking unit 4660 provides these results to an interaction-based ranking unit 4670.

Interaction-based ranking unit 4670 ranks the weighted interactions based on the magnitudes of the weights produced by weight-based ranking unit 4660. Factor-based ranking unit 4670 determines a strength for each weighted factor. That being the case, a first weighted factor having a larger magnitude than a second weighted factor is assigned a higher order in the ranking. The strengths assigned to the factors produced by factor-based ranking unit 4670 can be stored as statistical interaction information 4630. Statistical interaction information 4630 thus represents the nature of the various factors as they apply to the given security stance, from statistical perspective.

FIG. 47 is a simplified diagram illustrating an example of a factor ranking system for ranking factors based on weighted factors, according to methods and systems such as those disclosed herein. FIG. 47 thus illustrates a factor ranking system 4700 including the ranking factors by interpreting one or more weight components. The ranking of such factors by interpreting weight components assigns weights to each of the attributes or parameters that impact the given security policy, for example. The ranking of such factors using weight components assigns weights to each factor/combination of two or more attributes/parameters that may have a meaningful impact on the enforcement of the security policy in question. For example, the attributes or parameters can be associated with a given user, a resource (e.g., application), the user's use of the resource (e.g., application), the given user's group/department/etc., and other attributes/parameters having bearing (e.g., on the security stance of the resource, the user, the organization, and so on).

A ranking unit (e.g., factor-based ranking unit 4670 of FIG. 46) assigns a weight to each such factor. The ranking unit can assign a weight to factors for a given input in light of a given policy, but can also consider factors between the attributes, parameters, and other such characteristics of the application(s) and the situation/circumstances at hand (e.g., the computer system's/organization's current security stance). Weights are assigned based on the impact of the given attribute(s), parameter(s), factors, and or the like, as well as one or more combinations thereof. Through the use of machine learning systems such as those described herein, the ranking unit is able to rank such attributes, parameters, and their factors based on the assigned weights. The weighted attributes, parameters, factors, and the like, which can be used to rank their impacts on the security stance determined. A magnitude value can be assigned to the weighted attributes, parameters, and factors, and so the weighted attributes, parameters, and factors can be ranked based on their magnitude values.

For example, as shown in FIG. 47, X_{I} can represent the attribute, the parameter, or other factor as an input to the ranking factors by interpreting the weights components shown as part of factor ranking 4706, where I=1, 2, . . . . P. In this example, X₁, X₂, . . . . X_{P} are treated as factors between various combinations of potential security stances as delineated by the policy or policies in question. The variable Y can be treated as the impact on the desirability of each such security stance (e.g., as measured by the given computer system's/organization's attack surface, and changes thereto, with respect to various attack vectors), where Y=1, 2, . . . y. W(1), W(2), . . . W(y) are thus the weights assigned to the factors according to their impact on this desirability. By assigning the weights to the attributes, parameters, and other factors, changes in such feedback resulting from the effects of various combinations of such attributes, parameters, and other factors can be used by the machine learning system to predict the desirability of the security stance in question based on the given factors.

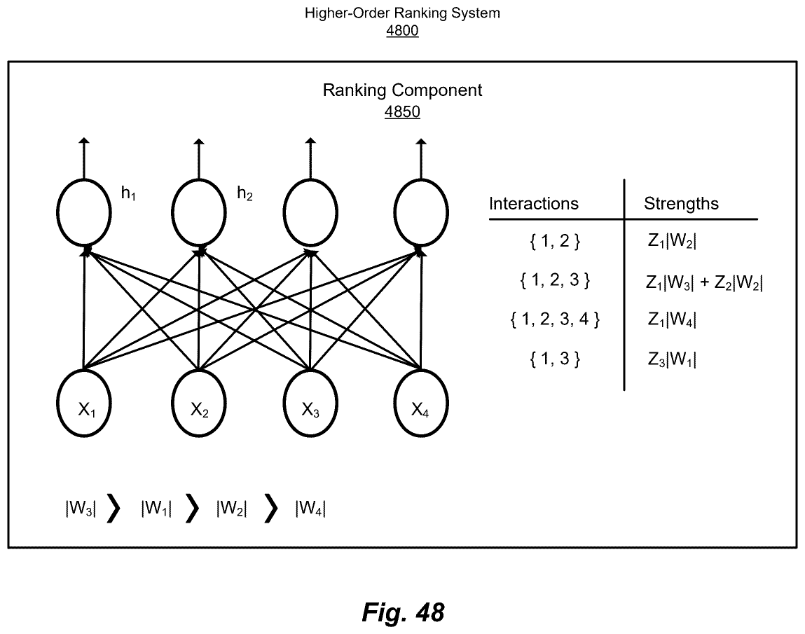

FIG. 48 is a simplified diagram illustrating an example of a higher-order ranking system for ranking attributes, parameters, and other factors, based on their impacts on the security stance (e.g., by way of determinations as to attack surface, as noted), according to methods and systems such as those disclosed herein. FIG. 48 thus depicts a higher-order ranking system 4800 that includes a ranking component 4850. Ranking component 4850 ranks the attributes, parameters, and other factors as higher-order interactions based on their strengths (their impacts, individually and in various combinations, on the security performance of the system). The attributes, parameters, and other factors are, in this example, treated as the inputs X₁, X₂, X₃, and X₄. For example, the X₁, X₂, X₃, and X₄ inputs can be factors such as a prediction of risk associated with a given resource (e.g., an application or class of applications), usage of such a resource (e.g., application usage), user/group/etc. effects, security goals of the organization, and other such factors. W₁, W₂, W₃, and W₄, in this example, are the weights corresponding to the inputs X₁, X₂, X₃, and X₄. Z, in this example, is a factor applied to the inputs based on the type of the attribute or parameter (e.g., the priority of the affected user(s)/group(s)/etc.). Ranking component 4850 ranks the interactions of the inputs X₁, X₂, X₃, and X₄ higher-order interactions (such as h₁, h₂, . . . ) based on the strengths, such as the magnitude value of the impact on the level of security provided (alternatively, the level of risk expected).

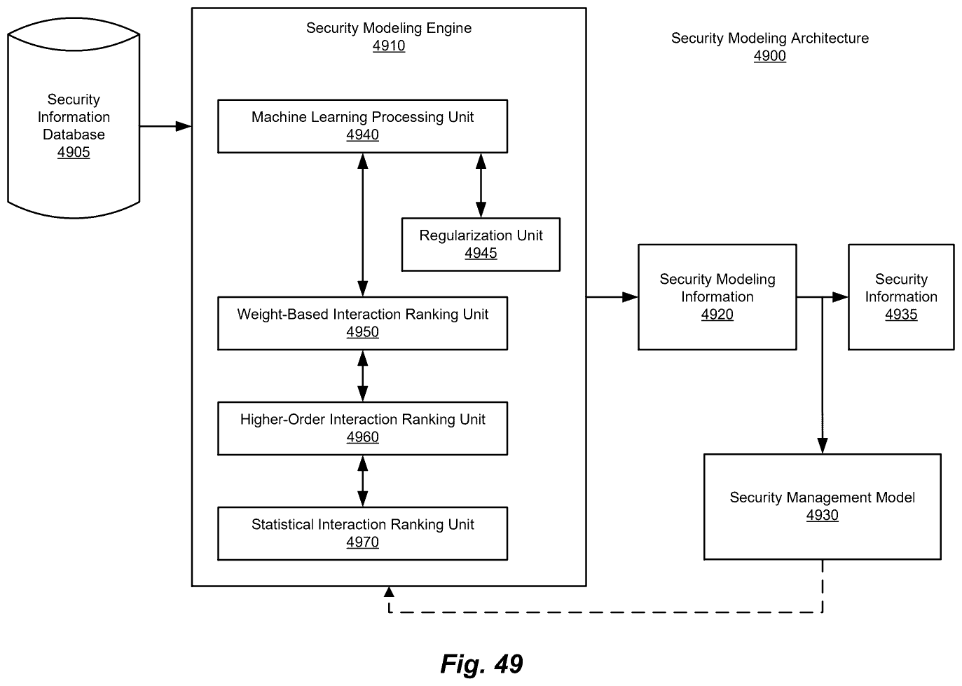

FIG. 49 is a simplified block diagram illustrating an example of a security prediction architecture, according to methods and systems such as those disclosed herein. FIG. 49 thus depicts a security modeling architecture 4900. As will be appreciated in light of the present disclosure and FIG. 49, security modeling architecture 4900 can be implemented, for example (and more specifically), as a multi-layer perceptron (MLP) machine learning architecture. Information from a security information database 4905 provides security information to a security modeling engine 4910. In turn, security modeling engine 4910 produces subject security modeling information 4920 (which can be, e.g., an MLP model). Results from the processing of security modeling information 4920 can then be made available as a security management model 4930, which can be updated using security information 4935, for example. Security information 4935 can then be used by a security management server such as security management server 260 to analyze outcome and other information, in order to provide policy analysis, attack surface predictions (predictive information), what-if analyses, and other functionality to other modules within a security management system according to the present disclosure. Additionally, as depicted, security information 4935 can be used to update security management model 4930, which can then be used by (or even as part of) a machine learning processing unit 4940 of security modeling engine 4910, supported by various other components of security modeling engine 4910.

In order to produce the requisite information for use of security modeling engine 4910 in making the determinations described elsewhere herein (e.g., image/segment interpretation, policy generation and application, allowed/denied resource (e.g., application) examples, policy and action recommendations, and so on), security modeling engine 4910 includes machine learning processing unit 4940, which can be implemented, for example, as a multi-layer perceptron (MLP) processing unit. Machine learning processing unit 4940 is coupled to communicate with a regularization unit 4945. Regularization unit 4945, in certain embodiments, implements a process of adding information to that received by machine learning processing unit 4940, in order to address situations in which insufficiently-defined information is provided (in security modeling engine 4910, for example, overly-vague application descriptions, a lack of certain identifying features (e.g., blurred logos), factors exhibiting excessive variability (e.g., widely-varying usage, as demonstrated by displayed content), and the like) and/or to prevent overfitting (the production of an analysis that corresponds too closely or exactly to a particular set of data, and may therefore fail to fit additional data or predict future observations reliably; in security modeling engine 4910, for example, scenarios in which a machine learning model could otherwise be tied too closely to a given factor such that the model's overdependence on that factor would result in an unacceptably high sensitivity to changes in that factor). For example, an MLP network with large network weights can be a sign of an unstable network, where small changes in the input can lead to large changes in the output. This can be a sign that the network has “overfit” the training dataset, and so is more likely to perform poorly when making predictions on new data. A solution to this problem is to update the learning algorithm to encourage the network to keep the weights small. This is called weight regularization and it can be used as a general technique to reduce overfitting of the training dataset and improve the generalization of the model. As will be appreciated in light of the present disclosure, given the potential for wide variability in factors such as collection/distribution goals, performance, system attributes, and other such factors, the benefits of regularization in applications such as those described herein include the ability of an analysis system according to the present disclosure to identify, for example, applications and their usage that, while not identical to allowed/denied examples, are sufficiently close to allow parallels to be drawn, and so, provide for the consistent, uniform treatment of such application in the actions taken in their regard.

In support of the generation of security modeling information 4920 (and so, security management model 4930), ML processing unit 4940 also produces information that is communicated to a weight-based interaction ranking unit 4950. Weight-based interaction ranking unit 4950 generates weight-based interaction ranking information, that is, in turn, provided to a higher-order interaction ranking unit 4960, for purposes and to effects in the manner of those described earlier. In turn, having generated higher-order interaction ranking information, higher-order interaction ranking unit 4960 communicates such information to a statistical interaction ranking unit 4970. In so doing, security modeling engine 4910 is able to appropriately weight relevant factors, and produce statistical information that allows security modeling information 4920 to be used in creating security information 4935 in such a manner that uncontrolled swings in outcome predictions produced using security modeling information 4920 (and ultimately, security management model 4930) are avoided.

FIG. 50A is a simplified block diagram illustrating an example of a multi-level neural network architecture, according to methods and systems such as those disclosed herein. FIG. 50 thus depicts a multi-layer neural network architecture 5000, an example of which is an LLM machine learning system having a number of layers. These layers include an embedding layer 5010, a number of neural network layers (depicted in FIG. 50 as neural network layers 5020(1)-(N), which are referred to in the aggregate as neural network layers 5020), an attention layer 5030, and an output layer 5040. Input information 5050 is received at embedding layer 5010, and results are produced at an output of output layer 5040, as output information 5055 (representing, e.g., security management model 4930 and/or security information 4935). Multi-layer neural network architecture 5000 is thus a more detailed example of machine learning processing unit 4940 of FIG. 49.

Neural networks, and in particular, large language models such as multi-level neural network architecture 5000 (in the aggregate, LLMs, as noted), are useful in processing and generating human-like text, analyses of combinations of text, and generating such information from images/audio/video, as well as interactions with computing platforms (e.g., such as the change in the usage of an application starting out as acceptable (opening an acceptable business application (e.g., a word processing application), but then using that application in an unacceptable manner (e.g., as by entering content for a job application for another organization)) and other forms of information. LLMs, such as convolutional neural networks (CNNs)/transformational neural networks (TNNs) with attention mechanisms, achieve such ends through an interplay of various components within their architecture, primarily relying on deep learning techniques. Internal components of such a machine learning architecture can include:
i) Embedding Layer (e.g., embedding layer 5010): This layer acts as a translator, taking individual words, image features, or other such inputs (e.g., input information 5055) and converting them into numerical representations (also referred to as “tokens”). These representations, called embeddings, capture the meaning and context of each piece of information input to multi-level neural network architecture 5000.
ii) Neural Network Layers (e.g., neural network layers 5020(1)-(N)): LLMs rely on stacked layers of artificial neural networks. Examples of such layers include:
   (1) Recurrent Neural Networks (RNNs): RNNs are deep learning models that are trained to process and convert sequential data inputs into a specific sequential data outputs; that being the case, for components such as machine learning system 1360 of policy helper chat unit 1310, certain of the machine learning systems (MLSs) of policy creation engine 1410 (e.g., MLSs 1528, 1538, and 1560), cumulative understanding unit 1780, and other such MLSs that may be employed in an analysis system such as that described herein, the sequential nature of the descriptive language (e.g., natural language) inputs and outputs, where the meaning of a word may depend on prior words in the sequence of input words, RNNs can prove advantageous.
   (2) Feedforward Neural Networks (FNN): FNNs perform more general computations, allowing the model to learn complex relationships between various pieces of information (e.g., words, statements, images, image features, segments, and so on); that being the case, such nodes/layers can be put to good use in MLS 1440, RAG unit 1510, MLS 1610, multimodal machine learning models 1750 and 2970, cumulative understanding unit 1780.
   (3) Memory-Augmented Neural Network (MANN): MANNs incorporate an external memory component that allows the model to store and retrieve information over time, simulating an accumulation function and so, a cumulative understanding.
iii) Attention Layer (e.g., attention layer 5030): The attention layer allows the model to focus on specific parts of the processed input that are most relevant to the current task. This enables such architectures to, for example, grasp long-range dependencies within sentences, with which traditional may RNNs struggle.
iv) Output Layer (e.g., output layer 5040): Finally, the processed information reaches the output layer, where the LLM makes predictions. These predictions can be generating text that describes the input, generates textual statements based on the input(s), describes an image or segment, or performs operations such as those described elsewhere herein.

The model extant within multi-layer neural network architecture 5000 performs embedding to convert pieces of information (e.g., words, images, segments, and so on) into high-dimensional vector representations. In the architecture depicted in FIG. 50, this data is then passed through multiple transformer layers (neural network layers 5020). The output of the transformer layers is then passed to attention layer 5030, which focuses the analysis on specific parts of the processed input that are most relevant to the current task, as noted. That said, in certain embodiments, the self-attention mechanism is situated within the transformer layers and provides for “understanding” of the relationships between the pieces of information, as they appear to the given layer/perceptron (e.g., words in a given sequence). Finally, after processing through the neural network layers, the model generates a result (e.g., an answer, description, rating, ranking, and so on (e.g., text)) by predicting the most likely next token (e.g., word) in the sequence based on the learned context.

These components thus work together in a coordinated fashion. In the example of generating a statement or image description, embedding layer 5010 prepares the text/images/etc., neural network layers 5020 process and analyze the output of embedding layer 5010, attention layer 5030 refines the focus, and finally, output layer 5040 generates the results. By training on large amounts of data, LLMs are able to “learn” the relationships between words/images/segments/etc. and perform various tasks (e.g., generating JSON, identifying salient image features, selecting policies, and so on).

In further detail, embedding layer 5010 converts words in input information 5050 (e.g., input text) into a high-dimensional vector representation. These embeddings capture semantic and syntactic information about the words and help the model to understand the context. The feedforward layers of LLMs have multiple fully-connected layers that apply nonlinear transformations to the input embeddings (such fully-connected layers being depicted in FIG. 50 as neural network layers 5020). Neural network layers 5020 facilitate the learning of higher-level abstractions from the input text by multi-layer neural network architecture 5000. Recurrent layers of LLMs (e.g., one or more of neural network layers 5020) are designed to interpret information from the input text in sequence. Such functionality can be provided by such layers by maintaining a hidden state that is updated at each time step, allowing the model to capture the dependencies between words in a sentence. An attention mechanism (e.g., attention layer 5030) is another important part of LLMs, which allows the model to focus selectively on different parts of the input text. This mechanism helps the model attend to the input text's most relevant parts and generate more accurate predictions. And while functionalities such as recurrence, attention, and feedforward mechanisms are depicted in FIG. 50 as being separate neural network layers, neural network layers such as neural network layers 5020 can include their own recurrence, attention, and feedforward components, in addition (or as an alternative) to the other layers shown in FIG. 50. Further in this regard, various combinations of such functions are also contemplated by the present disclosure, as noted in the previous example.

In an analysis system of the present invention, it is to be appreciated that efficiency in resource usage (whether computational, storage, or network resources) is an important consideration, at least with regard to being able to rapidly respond to resource usage and changes therein, as well as the burdens place on users (e.g., performance degradation in the user's computer system) and organizations (e.g., delays caused by such processing delaying implementation of policies in specific situations), among many other such considerations. To address such concerns, LLMs such as those described above can map varying amounts of parallelism to different stages of/paths through the networks between perceptrons in each stage, and between outputs of one stage and inputs of another. Such load-balancing can provide improved performance for MLSs in an analysis system such as that described herein, particularly those with higher computational needs, such as multimodal machine learning models 1750 and 2970.

A flexible collective algorithm to reduce impact of network latency can also be employed. Such techniques can be used in any of the MLSs of an analysis system of the present disclosure. Further in this regard, load balancing of network traffic and compute needs can also be used to good effect in such MLSs. Indeed, as will be appreciated in light of the present disclosure, a server cluster (a group of independent servers that managed as a single system) can be employed, and so provide not only the aforementioned load balancing, but also higher availability, easier manageability, and greater scalability. For example, in an analysis system such as that described herein, multiple database servers can be architected using clustering techniques to provide high-availability/high-throughput database facilities. In so doing, such a database server cluster is able to provide advantages such as load balancing, high availability, and the like, by breaking up the data to be accessed by other systems (e.g., breaking a database into “shards”), by allowing separate data sources to be accessed separately, and so on. Similarly, a web server cluster (a group of computer systems executing web server software (e.g., HTTP servers)) can be employed to collectively provide a web page delivery mechanism, with advantages comparable to those noted above.

FIG. 50B is a simplified block diagram illustrating an example of another multi-level neural network architecture, according to methods and systems such as those disclosed herein. FIG. 50 thus depicts a multi-layer neural network architecture 5060, an example of which is an LLM machine learning system having a number of layers. Multi-layer neural network architecture 5060

FIG. 50B is a simplified block diagram illustrating an example of another multi-level neural network architecture, according to methods and systems such as those disclosed herein. FIG. 50 thus depicts a multi-layer neural network architecture 5060, an example of which is an LLM machine learning system having a number of layers. Multi-layer neural network architecture 5060 receives input information 5065 at an embedding layer 5066, which, in certain embodiments, is comparable to embedding layer 5010 of FIG. 50A. In turn, multi-layer neural network architecture 5060 produces output information 5067 as a result of a classifier layer 5068 receiving information provided by some number of attention blocks (depicted in FIG. 50B as attention blocks 5070(1)-(N), which are referred to in the aggregate as attention blocks 5070), such attention blocks having received representational tokens received from embedding layer 5066 (e.g., vectors in a higher-dimensional space, where inputs (words, images, segments, features, and the like) received by embedding layer 5066 are grouped together). For its part, a classifier layer such as classifier layer 5068 serves the function of mapping the learned representations (processed embeddings) to the desired output labels for various tasks (e.g., output information 5078). For their part, attention blocks 5070 focus the attention of multi-layer machine learning architecture 5060 on the more salient pieces of information, in order to provide a cogent and concise result. Such attention blocks can provide functionality such as self-attention, multi-head attention, cross-attention, and causal-attention.

Internally, using attention block 5070(1) as an example, each of attention blocks 5070 can include a linear layer 5080 and a feed forward layer 5085, between which are vector processing units. Such vector processing units can include a number of Q nodes (depicted in FIG. 50B as Q nodes 5092(1)-(N), and referred to in the aggregate as Q nodes 5092), K nodes (depicted in FIG. 50B as K nodes 5094(1)-(N), and referred to in the aggregate as K nodes 5094), V nodes (depicted in FIG. 50B as V nodes 5096(1)-(N), and referred to in the aggregate as V nodes 5096), and A nodes (depicted in FIG. 50B as A nodes 5098(1)-(N), and referred to in the aggregate as A nodes 5098).

In operation, embedding layer 5066 of multi-layer neural network architecture 5060 performs embedding to convert the pieces of information input to multi-layer neural network architecture 5060 into high-dimensional vector representations (e.g., matrices). The resulting representations are then passed through multiple transformer layers. After processing by those transformer layers, information thus generated is processed by classifier layer 5067, which generates output information 5078 (e.g., the words of a statement, the policy identified, examples of allowed/denied applications, and/or other such information, as may be appropriate and necessary to the component of the analysis system implemented thereby).

Within attention blocks 5070, linear layer 5080 performs a series of linear transformations that allow the attention mechanism to function effectively, enabling the model to focus on different parts of the input sequence dynamically and produce meaningful representations for downstream tasks. A feed-forward layer within an attention block (e.g., feed forward layer 5085) can perform a number of functions, such as introducing non-linearity (enhancing the model's capacity to learn complex patterns and representations through non-linear activation functions), position-wise processing (e.g., applying transformations independently to each token's representation, allowing the model to refine token-specific features), and dimensionality expansion and compression (projecting inputs to higher-dimensional spaces to learn more intricate features before reducing back to the original size, facilitating richer representations). Further, the nodes within each attention block (e.g., Q nodes 5092, K nodes 5094, V nodes 5096, and A nodes 5098) represent the following operations:
Q (Queries): Vector representations derived from input embeddings used to query the relevance of other tokens.
K (Keys): Vector representations derived from input embeddings used to be compared against queries to compute relevance scores.
V (Values): Vector representations derived from input embeddings that contain the information to be aggregated based on the computed attention scores.
A (Attention): The mechanism that computes attention scores and applies them to values to produce a context-aware representation of each token.

Advantageously, such representations can be used to implement a scaled dot-product attention, which can be generated using Q, K, and V matrices, in the following order, for example:
query sequence→key sequence→value sequence→attention

A self-attention mechanism in scenarios such as those described herein, for use in such LLM architectures, can employ Q, K, and V matrices with characteristics such as those now discussed.

With regard to input embeddings, the input to a self-attention layer is a sequence of word (or token) embeddings representing the pieces of information received by the layer. The input embeddings can be denoted as X, which has a shape of (N, d_{{model}}), where N is the sequence length (number of tokens) and d_{{model}} is the dimensionality of the embeddings.

With regard to the linear transformations performed, such transformations linearly transform the input embeddings X to produce the queries (Q), keys (K), and values (V) matrices. This is done using learned weight matrices W_{Q}, W_{K}, and W_{V}:
Q=XW_{Q}, K=XW_{K}, V=XW_{V}
where W_{Q}, W_{K}, and W_{V} typically have shapes (d_{{model}}, dₖ), (d_{{model}}, dₖ), and (d_{{model}}, dᵥ) respectively, and where dₖ and dᵥ are the dimensionalities of the queries/keys and values, often chosen such that dₖ=dᵥ=d_{{model}}/h (where h is the number of attention heads).

With regard to dot-product attention, the self-attention mechanism calculates the attention scores by taking the dot product of Q and K, scaling by \sqrt{dₖ}, and applying a softmax function to obtain the attention weights:

$$Attention ( Q , K , V ) = softmax ( \frac{Q {K}^{T}}{\sqrt{{d}_{k}}} ) V$$

Example of typical values can, for example, be as follows. During the initialization phase, the weight matrices W_{Q}, W_{K}, and W_{V} are usually initialized using methods like Xavier (Glorot) or He initialization. This means their initial values are small, random numbers, typically drawn from a normal distribution with a mean of 0 and a variance that is a function of the layer dimensions.

During training, the values in Q, K, and V matrices change as the model trains. Their exact values depend on the input embeddings and the learned weights. However, typical characteristics include:
Scale: The values are generally scaled to prevent the dot products from becoming too large, which is why the division by \sqrt{dₖ} is important.
Range: The elements in Q, K, and V matrices can vary widely, but they are often in the range of small positive and negative values due to the initial small random values and the learning process.

For example, Q, K, and V matrices can appears as follows, for a single token when d_{{model}}=512, and 8 attention heads (so dₖ=dᵥ=64) are used, where in such an example:
Q Matrix (for a single token):

$$Q = [ \begin{matrix}0.12 & … & 0.02 \\ ⋮ & ⋱ & ⋮ \\ 0.03 & … & 0.04\end{matrix} ]$$

Shape: (N, dₖ)=(1, 64)
K Matrix (for a single token):

$$Q = [ \begin{matrix}0.15 & … & 0.01 \\ ⋮ & ⋱ & ⋮ \\ 0.02 & … & 0.07\end{matrix} ]$$

Shape: (N, dₖ)=(1, 64)
V Matrix (for a single token):

$$Q = [ \begin{matrix}0.09 & … & 0.02 \\ ⋮ & ⋱ & ⋮ \\ 0.03 & … & 0.05\end{matrix} ]$$

Shape: (N, dᵥ)=(1, 64)

These matrices are concatenated across multiple heads and then linearly transformed to form the final output of the self-attention layer. That being the case, the Q, K, and V matrices in self-attention mechanisms contain values that are typically small due to initialization and normalization during training. They are learned representations that capture different aspects of the input sequence, enabling the model to focus on relevant parts of the data dynamically.

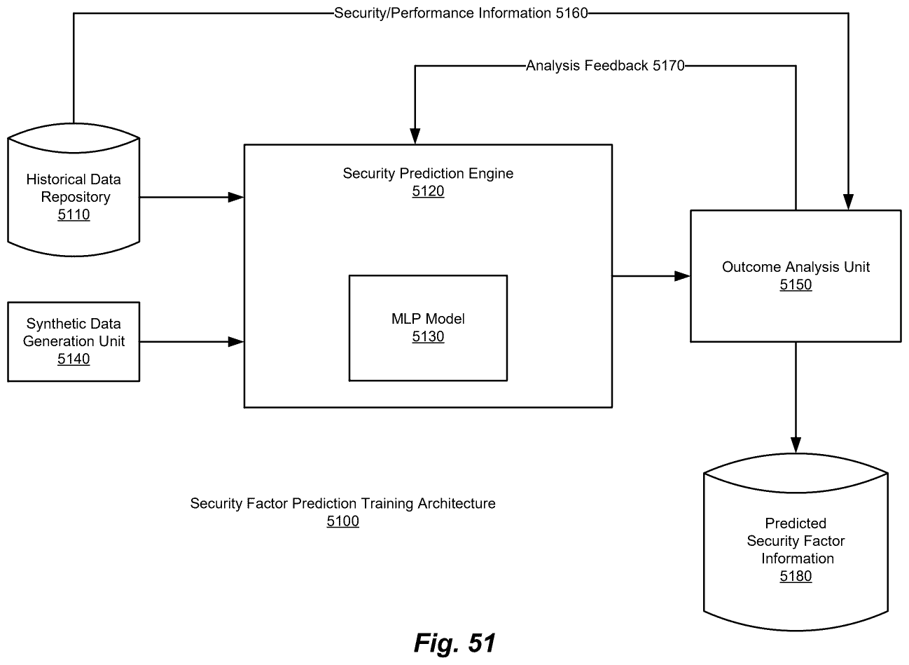

FIG. 51 is a simplified block diagram illustrating an example of a security factor prediction training architecture, according to methods and systems such as those disclosed herein. FIG. 51 thus depicts a security factor prediction training architecture 5100, where such security factor comprehends a given system's security stance and attack surface. Security factor prediction training architecture 5100, in the manner noted in connection with machine learning training system 4610 of FIG. 46, can use historical data such as that discussed earlier herein that is provided by (or retrieved from) historical data repository 5110, for example. For example, historical data repository 5110 can include historical information regarding the security of resources such as application(s), historical scenarios, endpoint computing device and/or resource performance (e.g., application performance), and other relevant information. This information is provided to (or retrieved by) a security prediction engine 5120. Security prediction engine 5120 uses the historical data from historical data repository 5110 to update a multi-layer perceptron (MLP) model 5130, and can also receive synthetic training data from a synthetic data generation unit 5140 for such purposes. Synthetic data from synthetic data generation unit 5140 is generated to simulate various scenarios and circumstances, in order to make MLP model 5130 more robust (e.g., with regard to its efficacy in various scenarios (situations and circumstances), as well as its ability to remain stable in various scenarios, such as by training on images/segments, usage scenarios, etc. that are clearly compliant, non-compliant, or irrelevant with respect to a given policy, for example). Security prediction engine 5120 provides results to an outcome analysis unit 5150, based on information generated by MLP model 5130 using the historical data from historical data repository 5110 and synthetic data from synthetic data generation unit 5140. Outcome analysis unit 5150 analyzes the outcomes produced by security prediction engine 5120 (produced using MLP model 5130, whether MLP model 5130 is simply the weights and biases extant in security prediction engine 5120, or stored separately therefrom), in view of various security/performance metrics observed as a result of information regarding the factors giving rise to those scenarios (received by outcome analysis unit 5150 as security/performance information 5160). Such analysis results are fed back to security prediction engine 5120 (as analysis feedback 5170), and used to update MLP model 5130. Factor information for various of the factors considered is, once confirmed as being acceptable (also as a result of the outcome analysis performed), stored as predicted security factor information in a predicted security factor information repository 5180. The predicted security factor information stored is thus made available for use in security operations performed as part of the security management processes described herein. For example, such predictions can be used in combination with historical information, as inputs to the large language models described elsewhere herein

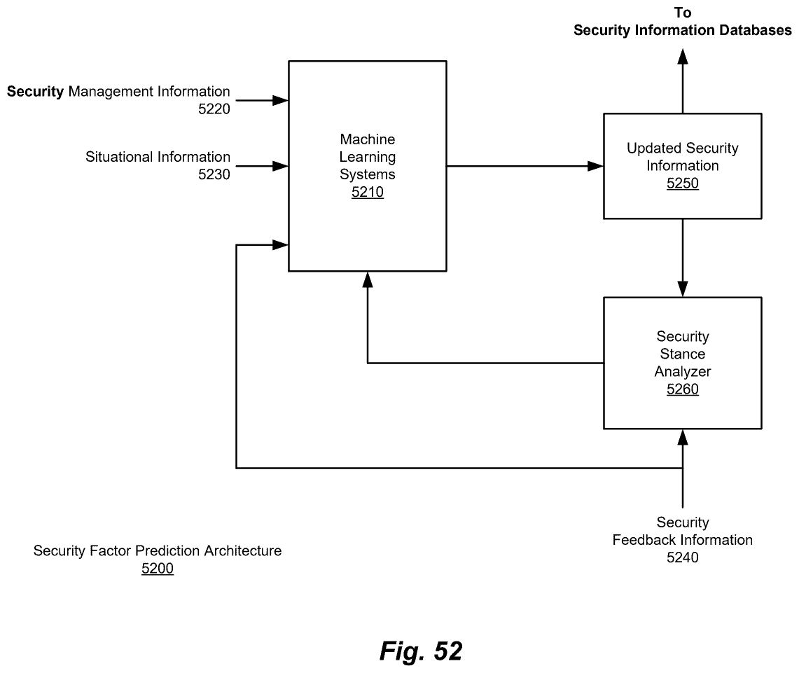

FIG. 52 is a simplified block diagram illustrating an example of a security factor prediction architecture, according to methods and systems such as those disclosed herein. Machine learning inputs are presented to machine learning systems 5210, and include security management information 5220, situational information 5230 (which can include resource output), and security performance feedback information 5240. Security management information 5220 can include information from one or more security management information databases (e.g., static security management information, dynamic security management information, and other security management information), historical data, and other such information, including information regarding existing security stance. Situational information 5230 can include information regarding the current state of the security system including the state of one or more endpoint computing systems, applications, and/or the like.

Machine learning systems 5210 analyze these machine learning inputs, and update the security management information with updated information 5250. Updated information 5250 is sent to one or more of the security management system's security management information databases, making such updated information available to other components of the security management system. Such updated information is also provided to a security stance analyzer 5260, which analyzes the updated information in light of security performance feedback information received once the updated information has been made available via the security management information databases. The output of security analyzer 5260 is also provided to machine learning systems 5210 as feedback with respect to the solutions generated by machine learning systems 5210. Such feedback, resulting from analyzing the updated information in light of the security performance feedback information received, provides for positive reinforcement of information that can result in improved performance of the security system. Further, it will be appreciated that such positive reinforcement also tends to deemphasize poorer solutions, thereby protecting such systems from feedback resulting in local minima and performance.

In view of the foregoing, as well as earlier discussions herein, it is to be appreciated that a machine learning system such as that described above can not only be used for the prediction of factors in determining security stances, but can also be used to implement a hyper-heuristic system that is able to identify the appropriate heuristic(s)/metaheuristic(s) for analyses using the machine learning techniques described above. In general, a hyper-heuristic is a search heuristic that automates the selection, combination, generation, and adaptation of multiple heuristics/metaheuristics. In addition to the predictive capabilities offered, such a hyper-heuristic provides for the selection of not only the heuristic(s)/metaheuristic(s) to be used in a given situation, but also the parameters therefor. In so doing, such a hyper-heuristic is able to tailor the heuristic(s)/metaheuristic(s) invoked and the applicable parameters to the circumstances faced by the security system. In so doing, the resources needed for potentially heavy customization of one heuristic/metaheuristic or another for a given potential situation (a particular advantage when dealing with rapidly-changing systemwide scenarios). Such a hyper-heuristic, using the aforementioned machine learning techniques, provides for intelligently selecting a suitable heuristic/metaheuristic for a given circumstance. While it will be appreciated that such techniques can also be used to generate suitable heuristics, the present disclosure employs machine learning in such an approach only to selecting the appropriate heuristic/metaheuristic. In so doing, a hyper-heuristic such as that described herein provides a mechanism for searching a search space of heuristic(s)/metaheuristic(s) (rather than attempting to include components thereof, and build the desired result, a more time-consuming and compute-intensive alternative than selection, and, as a result, one which the potential circumstances do not favor), which reduces the amount of domain knowledge needed to address such considerations (e.g., as might be necessitated by performing such selection manually). Such a selection thus processes the circumstances and state information without the need for operators to have extensive domain expertise (whether in heuristics or in the domain in which the problem lies).

As noted, and while not required, certain embodiments will, in light of the present disclosure, be understood as providing various platforms and/or services to support the aforementioned functionalities and the deployment thereof in a cloud environment. Such an architecture can be referred to as, for example, a cloud-native application architecture, which provides for development by way of a platform that abstracts underlying infrastructure. In so doing, methods and systems such as those described herein are able to further focus on the provision of security management services, while providing access thereto to a broader range of devices, and so, a greater pool of potential users of such systems. As also noted, evaluation and enforcement on the endpoint computing system as also a possible deployment.

### Example Computing and Network Environments

As shown above, the systems described herein can be implemented using a variety of computer systems and networks. The following illustrates an example configuration of a computing device such as those described herein. The computing device may include one or more processors, a random access memory (RAM), communication interfaces, a display device, other input/output (I/O) devices (e.g., keyboard, trackball, and the like), and one or more mass storage devices (e.g., optical drive (e.g., CD, DVD, or Blu-ray), disk drive, solid state disk drive, non-volatile memory express (NVME) drive, or the like), configured to communicate with each other, such as via one or more system buses or other suitable connections. While a single system bus is illustrated for ease of understanding, it should be understood that the system bus may include multiple buses, such as a memory device bus, a storage device bus (e.g., serial ATA (SATA) and the like), data buses (e.g., universal serial bus (USB) and the like), video signal buses (e.g., THUNDERBOLT, DVI, HDMI, and the like), power buses, etc.

Such CPUs are hardware devices that may include a single processing unit or a number of processing units, all of which may include single or multiple computing units or multiple cores. Such a CPU may include a graphics processing unit (GPU) that is integrated into the CPU or the GPU may be a separate processor device. The CPU may be implemented as one or more microprocessors, microcomputers, microcontrollers, digital signal processors, central processing units, graphics processing units, state machines, logic circuitries, and/or any devices that manipulate signals based on operational instructions. Among other capabilities, the CPU may be configured to fetch and execute computer-readable instructions stored in a memory, mass storage device, or other computer-readable storage media.

Memory and mass storage devices are examples of computer storage media (e.g., memory storage devices) for storing instructions that can be executed by the processors 502 to perform the various functions described herein. For example, memory can include both volatile memory and non-volatile memory (e.g., RAM, ROM, or the like) devices. Further, mass storage devices may include hard disk drives, solid-state drives, removable media, including external and removable drives, memory cards, flash memory, floppy disks, optical disks (e.g., CD, DVD, Blu-ray), a storage array, a network attached storage, a storage area network, or the like. Both memory and mass storage devices may be collectively referred to as memory or computer storage media herein and may be any type of non-transitory media capable of storing computer-readable, processor-executable program instructions as computer program code that can be executed by the processors as a particular machine configured for carrying out the operations and functions described in the implementations herein.

The computing device may include one or more communication interfaces for exchanging data via a network. The communication interfaces can facilitate communications within a wide variety of networks and protocol types, including wired networks (e.g., Ethernet, DOCSIS, DSL, Fiber, USB, etc.) and wireless networks (e.g., WLAN, GSM, CDMA, 802.11, Bluetooth, Wireless USB, ZigBee, cellular, satellite, etc.), the Internet and the like. Communication interfaces can also provide communication with external storage, such as a storage array, network attached storage, storage area network, cloud storage, or the like.

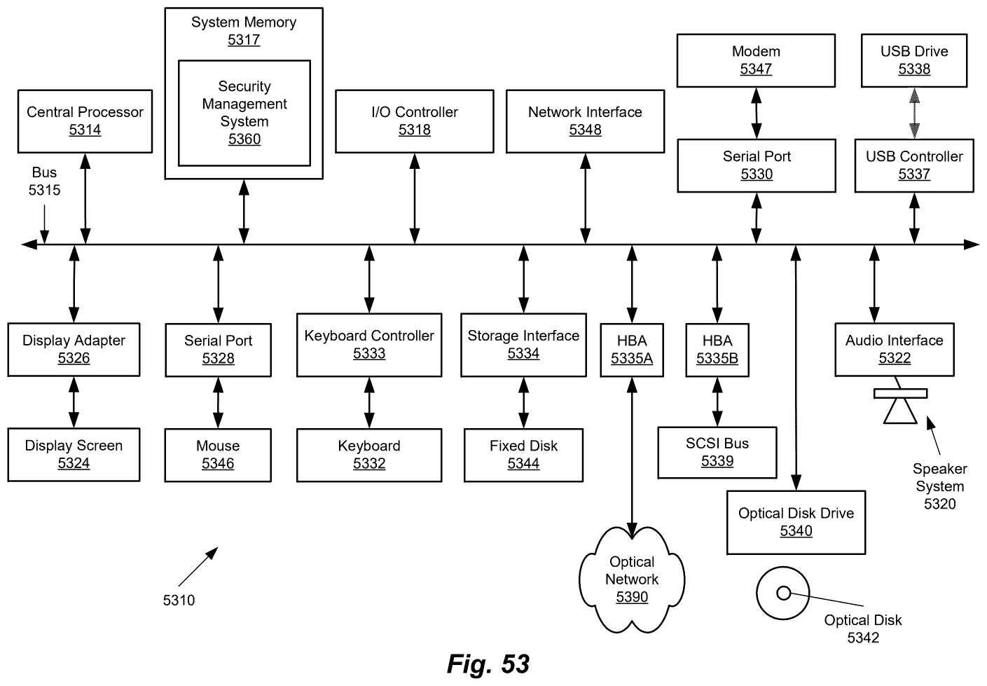

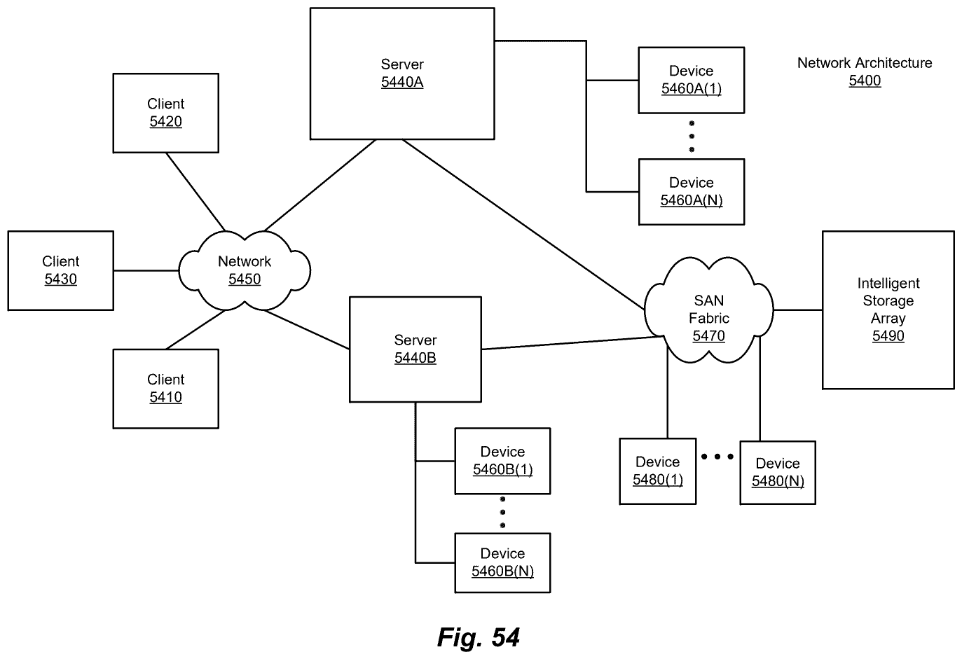

The display device may be used for displaying content (e.g., information and images) to users. Other I/O devices may be devices that receive various inputs from a user and provide various outputs to the user, and may include a keyboard, a touchpad, a mouse, a printer, audio input/output devices, and so forth. The computer storage media, such as memory 504 and mass storage devices, may be used to store software and data, such as, for example, an operating system, one or more drivers (e.g., including a video driver for a display such as display 180), one or more applications, and data. Examples of such computing and network environments are described below with reference to FIGS. 53 and 54.

FIG. 53 depicts a block diagram of a computer system 5310 suitable for implementing aspects of the systems described herein, and so can be viewed as an example of a computing device supporting security management server, for example. Computer system 5310 includes a bus 5312 which interconnects major subsystems of computer system 5310, such as a central processor 5314, a system memory 5317 (typically RAM, but which may also include ROM, flash RAM, or the like), an input/output controller 5318, an external audio device, such as a speaker system 5320 via an audio output interface 5322, an external device, such as a display screen 5324 via display adapter 5326 (and so capable of presenting visualization data), serial ports 5328 and 5330, a keyboard 5332 (interfaced with a keyboard controller 5333), a storage interface 5334, a USB controller 5337 operative to receive a USB drive 5338, a host bus adapter (HBA) interface card 5335A operative to connect with an optical network 5390, a host bus adapter (HBA) interface card 5335B operative to connect to a SCSI bus 5339, and an optical disk drive 5340 operative to receive an optical disk 5342. Also included are a mouse 5346 (or other point-and-click device, coupled to bus 5312 via serial port 5328), a modem 5347 (coupled to bus 5312 via serial port 5330), and a network interface 5348 (coupled directly to bus 5312).

Bus 5312 allows data communication between central processor 5314 and system memory 5317, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications resident with computer system 5310 are generally stored on and accessed from a computer-readable storage medium, such as a hard disk drive (e.g., fixed disk 5344), an optical drive (e.g., optical drive 5340), a universal serial bus (USB) controller 5337, or other computer-readable storage medium.

Storage interface 5334, as with the other storage interfaces of computer system 5310, can connect to a standard computer-readable medium for storage and/or retrieval of information, such as a fixed disk drive 5344. Fixed disk drive 5344 may be a part of computer system 5310 or may be separate and accessed through other interface systems. Modem 5347 may provide a direct connection to a remote server via a telephone link or to the Internet via an internet service provider (ISP). Network interface 5348 may provide a direct connection to a remote server via a direct network link to the Internet via a POP (point of presence). Network interface 5348 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 53 need not be present to practice the systems described herein. The devices and subsystems can be interconnected in different ways from that shown in FIG. 53. The operation of a computer system such as that shown in FIG. 53 is readily known in the art and is not discussed in detail in this application. Code to implement portions of the systems described herein can be stored in computer-readable storage media such as one or more of system memory 5317, fixed disk 5344, optical disk 5342, or floppy disk 5338. The operating system provided on computer system 5310 may be WINDOWS, UNIX, LINUX, IOS, or another operating system. To this end, system memory 5317 is depicted in FIG. 53 as executing a security management system 5360, in the manner of the systems discussed previously herein, for example.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above-described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 54 is a block diagram depicting a network architecture 5400 in which client systems 5410, 5420 and 5430, as well as storage servers 5440A and 5440B (any of which can be implemented using computer system 5410), are coupled to a network 5450. Storage server 5440A is further depicted as having storage devices 5460A(1)-(N) directly attached, and storage server 5440B is depicted with storage devices 5460B(1)-(N) directly attached. Storage servers 5440A and 5440B are also connected to a SAN fabric 5470, although connection to a storage area network is not required for operation. SAN fabric 5470 supports access to storage devices 5480(1)-(N) by storage servers 5440A and 5440B, and so by client systems 5410, 5420 and 5430 via network 5450. An intelligent storage array 5490 is also shown as an example of a specific storage device accessible via SAN fabric 5470.

With reference to computer system 5310, modem 5347, network interface 5348 or some other method can be used to provide connectivity from each of client computer systems 5410, 5420 and 5430 to network 5450. Client systems 5410, 5420 and 5430 are able to access information on storage server 5440A or 5440B using, for example, a web browser or other client software (not shown). Such a client allows client systems 5410, 5420 and 5430 to access data hosted by storage server 5440A or 5440B or one of storage devices 5460A(1)-(N), 5460B(1)-(N), 5480(1)-(N) or intelligent storage array 5490. FIG. 54 depicts the use of a network such as the Internet for exchanging data, but the systems described herein are not limited to the Internet or any particular network-based environment.

### OTHER EMBODIMENTS

The example systems and computing devices described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only, and are in no way exhaustive of the scope of the claims.

Such example systems and computing devices are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

The foregoing thus describes embodiments including components contained within other components (e.g., the various elements shown as components of computer system 2110). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation. As such, the various embodiments of the systems described herein via the use of block diagrams, flowcharts, and examples. It will be understood by those within the art that each block diagram component, flowchart step, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

In light of the foregoing, it will be appreciated that the foregoing descriptions are intended to be illustrative and should not be taken to be limiting. As will be appreciated in light of the present disclosure, other embodiments are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer-implemented method, implemented in a computer system, comprising:
acquiring a resource output, wherein
the resource output is an output produced by a computing resource;
generating a representation of the resource output, wherein
the representation is generated by a machine learning system, and
the machine learning system generates the representation based, at least in part, on the resource output; and
in response to an analysis of the representation against a representational statement, performing an operation, wherein
the representational statement is in a representational language.

2. The method of claim 1, further comprising:
producing a determination, wherein
the computing resource is a software application,
the resource output is an application output of the software application,
the representation of the resource output is a first representational statement in the representational language,
the representational statement is a second representational statement in the representational language,
the first representational statement is generated by the machine learning system,
the machine learning system generates the first representational statement based, at least in part, on the resource output,
the producing the determination comprises
the performing the analysis of the first representational statement against a second representational statement, and
producing the determination based, at least in part, on the analysis, and
the operation is performed in response to the determination.

3. The method of claim 2, wherein
the operation affects
one or more functionalities provided by the software application, or
the operation of the software application.

4. The method of claim 2, wherein
the application output is an image presented in a window of a graphical user interface of an endpoint computing system, and
the graphical user interface is displayed on a display of the endpoint computing system.

5. The method of claim 4, wherein
the first representational statement is a descriptive statement that describes the image,
the second representational statement is another descriptive statement that describes an administrative policy, and
the descriptive statement and the another descriptive statement are in a natural language.

6. The method of claim 2, further comprising:
generating the second representational statement.

7. The method of claim 6, wherein
the second representational statement is generated by the machine learning system.

8. The method of claim 7, wherein
the second representational statement is a security policy, and
the operation is an access control operation.

9. The method of claim 6, wherein
the second representational statement is generated by a conversational machine learning system, and
the conversational machine learning system generates the second representational statement, at least in part, by communicating with a security administrator, using the representational language.

10. The method of claim 9, wherein
the representational language is a natural language, and
the communicating is performed using the natural language.

11. The method of claim 2, wherein
the analysis of the first representational statement against the second representational statement is performed by the machine learning system, and
the operation affects execution of the software application by virtue of at least one of
the execution of the software application being permitted to continue, or
the execution of the software application being terminated.

12. The method of claim 1, further comprising:
producing a determination, wherein
the computing resource is a software application,
the resource output is output of the software application,
the producing the determination comprises
performing the analysis by analyzing the representation against the representational statement, and
producing the determination based, at least in part, on a result of the analyzing, and
the operation is performed in response to the determination.

13. A non-transitory computer-readable storage medium, comprising program instructions, which, when executed by one or more processors of a computing system, perform a method comprising:
acquiring a resource output, wherein
the resource output is an output produced by a computing resource;
generating a representation of the resource output, wherein
the representation is generated by a machine learning system, and
the machine learning system generates the representation based, at least in part, on the resource output; and
in response to an analysis of the representation against a representational statement, performing an operation, wherein
the representational statement is in a representational language.

14. The non-transitory computer-readable storage medium of claim 13, wherein the method further comprises:
producing a determination, wherein
the computing resource is a software application,
the resource output is an application output of the software application,
the representation of the resource output is a first representational statement in the representational language,
the representational statement is a second representational statement in the representational language,
the first representational statement is generated by the machine learning system,
the machine learning system generates the first representational statement based, at least in part, on the resource output,
the producing the determination comprises
the performing the analysis of the first representational statement against a second representational statement, and
producing the determination based, at least in part, on the analysis, and
the operation is performed in response to the determination.

15. The non-transitory computer-readable storage medium of claim 14, wherein
the application output is an image presented in a window of a graphical user interface of an endpoint computing system, and
the graphical user interface is displayed on a display of the endpoint computing system, wherein
the first representational statement is a descriptive statement that describes the image,
the second representational statement is another descriptive statement that describes an administrative policy, and
the descriptive statement and the another descriptive statement are in a natural language.

16. The non-transitory computer-readable storage medium of claim 14, wherein the method further comprises:
generating the second representational statement, wherein
the second representational statement is generated by the machine learning system,
the second representational statement is a security policy, and
the operation is an access control operation.

17. The non-transitory computer-readable storage medium of claim 14, wherein the method further comprises:
generating the second representational statement, wherein
the second representational statement is generated by a conversational machine learning system, and
the conversational machine learning system generates the second representational statement, at least in part, by communicating with a security administrator, using the representational language.

18. The non-transitory computer-readable storage medium of claim 14, wherein
the analysis of the first representational statement against the second representational statement is performed by the machine learning system, and
the operation affects execution of the software application by virtue of at least one of
the execution of the software application being permitted to continue,
the execution of the software application being terminated,
one or more functionalities provided by the software application, or
the operation of the software application.

19. The non-transitory computer-readable storage medium of claim 13, wherein the method further comprises:
producing a determination, wherein
the computing resource is a software application,
the resource output is output of the software application,
the producing the determination comprises
performing the analysis by analyzing the representation against the representational statement, and
producing the determination based, at least in part, on a result of the analyzing, and
the operation is performed in response to the determination.

20. A computing system comprising:
one or more processors; and
a computer-readable storage medium coupled to the one or more processors, comprising program instructions, which, when executed by the one or more processors, perform a method comprising
acquiring a resource output, wherein
the resource output is an output produced by a computing resource;
generating a representation of the resource output, wherein
the representation is generated by a machine learning system, and
the machine learning system generates the representation based, at least in part, on the resource output; and
in response to an analysis of the representation against a representational statement, performing an operation, wherein
the representational statement is in a representational language.
